(19) United States
(12) Patent Application Publication
(10) Pub. No.: US 2015/0149524 A1
(43) Pub. Date: May 28, 2015

(54) NETWORK SYSTEM, CONSTANT CONNECTION METHOD, ELECTRONIC DEVICE, SERVER, AND PROGRAM

(71) Applicant: SHARP KABUSHIKI KAISHA, Osaka (JP)

(72) Inventors: Hitoshi NISHIKAWA, Osaka (JP); Hirofumi FURUKAWA, Osaka (JP); Akira TOJIMA, Osaka (JP); Kayo MORINAGA, Osaka (JP); Masahiro CHIBA, Osaka (JP)

(21) Appl. No.: 14/555,653

(22) Filed: Nov. 27, 2014

(30) Foreign Application Priority Data
Nov. 27, 2013 (JP) 2013-244546
Nov. 27, 2013 (JP) 2013-244547
Jan. 15, 2014 (JP) 2014-005058

(51) Int. Cl. H04L 29/08

(52) U.S. Cl. CPC H04L 67/142; H04L 67/12; H04L 67/1027
USPC 709/201

(57) ABSTRACT

A network system is provided that includes a plurality of constant connection servers, and an electronic device capable of making a constant connection with at least one of the plurality of constant connection servers. The electronic device obtains from any of the plurality of constant connection servers information concerning at least one of the plurality of constant connection servers, and opens a constant connection with any of the plurality of constant connection servers on the basis of the information. Alternatively, a network system is provided that includes an electronic device, and a constant connection server capable of making a constant connection with the electronic device. The constant connection server sends information containing a reconnection interval concerning the constant connection server to the electronic device. The electronic device waits for a time period as determined from the reconnection interval, and repeats a process of making a constant connection until a constant connection with the constant connection server succeeds. Alternatively, a network system is provided that includes a plurality of constant connection servers, a client that uses a service via any of the plurality of constant connection servers, and a server capable of communicating with the client. The server in response to a request from the client sends a list concerning at least one of the plurality of constant connection servers to the client. The client on the basis of the list opens a constant connection with a constant connection server associated with the service.

### BACKGROUND OF THE INVENTION

1. Field of the Invention

The present invention relates to techniques for the constant connection of electronic devices, particularly to a network system for the constant connection of client and server, a constant connection method, an electronic device, a server, and a program. Alternatively, the present invention relates to constant connection techniques, particularly to a network system that involves services used by clients via a constant connection server, and to a constant connection method, an electronic device, a server, and a program.

2. Description of the Related Art

Various techniques for mutually sending data between communications devices are known. Specifically, various techniques are available that deliver information to terminals in realtime as it occurs on the server side. For example, JP-A-2010-277492 (Patent Literature 1) discloses an electronic conference server and computer programs. This disclosure is intended to provide real-time processing for an electronic conference system running on web applications, and to manage unsolved problems associated with the operation of an electronic conference system, among others. Specifically, an application server controls a Comet server so that the Comet server remains on hold even with an HTTP request sent from electronic devices. Upon receiving message data from any of the electronic devices, the application server retrieves the necessary data from a conference database, and sends the data to the electronic device of interest via the Comet server, together with the message data. After the data transmission, the application server puts the Comet server on hold again for any incoming HTTP request from electronic devices. Upon receiving message data from a different electronic device, the application server via the Comet server sends the message data, and any necessary data retrieved from the conference database to the electronic device that has sent the HTTP request, and wakes up the Comet server. After the data transmission, the application server puts the Comet server on hold again for any incoming HTTP request from electronic devices. This allows an electronic device to obtain data as soon as the data becomes ready on the application server side after sending an HTTP request.

However, because Comet requires a new HTTP session for each communication, the same data needs to be exchanged more than once between client and server. Comet also requires establishing a new HTTP connection for every response to a request. A newer method uses a constant connection, and performs multiple bidirectional communications while maintaining the connection. For example, the WebSocket technology, a protocol that runs on TCP (Transmission Control Protocol), has been developed. WebSocket was standardized by internet standards organizations W3C and IETF as a bidirectional communication protocol for web server and web browser. The specification of the WebSocket protocol is described in RFC (Request For Comment) 6455.

A network system is typically designed with redundant parts to improve availability. However, a redundant constant connection server involves problems not seen in common redundant servers.

In a system using a constant connection, all the constant connections between clients and servers are temporarily closed when the servers are shut down due to maintenance or accidental failure. In such a system, the servers are often overloaded, and fail to smoothly reestablish the connections when the clients rush to resume the constant connection with a server resuming operation or with an operating redundant server at the same time.

As a means to improve such a problem, JP-A-2013-051571 (Patent Literature 2) discloses a technique for client side whereby a reconnection is quickly established by balancing server loads with communication means that establishes a connection and communicates with a server; processing means that executes a predetermined process by using information obtained through communications from the server; disconnection detecting means that detects the closure of the connection; and reconnection means that in response to the detection of the disconnection repeatedly attempts to reestablish a connection with the server at a random first timing where the expected value of the reconnection trial period satisfies a predetermined certain value.

However, the technique disclosed in Patent Literature 2 uses a fixed reconnecting timing, and lacks any mechanism of varying the timing. A system based on this technique thus still involves the possibility of the reconnection process exceeding the processing capability of a server and overloading the server when the operating environment of the system changes after the start of system operation such as when the number of the clients connected to the server exceeds the expected limits, or when any addition of new functions lowers the reconnection processing capability of the server.

Another drawback is that the maintenance and operation of the whole system or some of the constant connection servers are complex, because more than one constant connection server is involved in a constant connection with a client concerning a single application service, or a single constant connection server is involved in a constant connection with a client concerning more than one application service.

### SUMMARY OF INVENTION

The present invention has been made to provide solutions to the foregoing problems, and it is an object of the present invention to solve the problems involved in redundant constant connection servers. Alternatively, an object of the present invention is to provide a network system that can smoothly return to a constant connection state without overloading a resuming server or an operating redundant server even when a constant connection server is shut down, or when changes occur in the operating environment of the system. The invention is also intended to provide a constant connection method, an electronic device, a server, and a program. Yet another object of the present invention is to provide ways of making the maintenance or operation of a system or a constant connection server easier than in related art.

According to some aspects of the invention, there is provided a network system that includes:

a plurality of constant connection servers; and

an electronic device capable of making a constant connection with at least one of the plurality of constant connection servers.

The electronic device obtains from any of the plurality of constant connection servers information concerning at least one of the plurality of constant connection servers, and opens a constant connection with any of the plurality of constant connection servers on the basis of the information.

Preferably, any one of the plurality of constant connection servers obtains a list of the plurality of constant connection servers.

Preferably, the any one of the plurality of constant connection servers sends the list as the information, and the electronic device selects one of the plurality of constant connection servers on the basis of the list.

Preferably, the any one of the plurality of constant connection servers selects one of the plurality of constant connection servers on the basis of the list, and sends information specifying the one of the plurality of constant connection servers to the electronic device as the information.

Preferably, the any one of the plurality of constant connection servers obtains the list in response to a request from the electronic device.

Preferably, the any one of the plurality of constant connection servers obtains the list on a regular basis.

Preferably, the list obtained by the any one of the plurality of constant connection servers is a list of operating constant connection servers.

Preferably, the any one of the plurality of constant connection servers obtains the list by creating a list in which the plurality of constant connection servers is sorted on the basis of the number of connected electronic devices.

Preferably, the any one of the plurality of constant connection servers obtains the list by creating a list in which the plurality of constant connection servers is sorted on the basis of loads.

According to another aspect of the invention, there is provided a constant connection method that includes:

sending, by any of a plurality of constant connection servers, information concerning the plurality of constant connection servers to an electronic device; and

opening, by the electronic device, a constant connection with any of the plurality of constant connection servers on the basis of the information.

According to another aspect of the invention, there is provided an electronic device that includes:

a communication interface provided to constantly connect to any of a plurality of constant connection servers; and

a processor that, by using the communication interface, obtains information concerning the plurality of constant connection servers from any of the plurality of constant connection servers, and opens a constant connection with any of the plurality of constant connection servers on the basis of the information.

According to another aspect of the invention, there is provided a server that includes:

a communication interface provided to communicate with an electronic device;

a memory that stores information concerning a plurality of constant connection servers; and

a processor that, by using the communication interface, pushes the information concerning the plurality of constant connection servers to the electronic device in response to a request from the electronic device.

According to another aspect of the invention, there is provided a program for use in an electronic device that includes a processor and a communication interface. The program causes the processor to perform:

obtaining information concerning a plurality of constant connection servers from any of the plurality of constant connection servers by using the communication interface; and

opening a constant connection with any of the plurality of constant connection server on the basis of the information by using the communication interface.

According to another aspect of the invention, there is provided a program for use in a server that includes a processor, a memory, and a communication interface. The program causes the processor to perform:

obtaining information concerning a plurality of constant connection servers by using the communication interface; and

sending the information concerning a plurality of constant connection servers to an electronic device by using the communication interface in response to a request from the electronic device.

According to another aspect of the invention, there is provided a network system that includes:

an electronic device;

a plurality of constant connection servers capable of making a constant connection with the electronic device;

an application server that sends and receives information to and from the electronic device via any of the plurality of constant connection servers; and

a load balancing server that allocates data from the application server to the plurality of constant connection servers.

The plurality of constant connection servers each forward the data to a different one of the plurality of constant connection servers that is in a constant connection with the electronic device designated as a recipient of the data.

Preferably, the network system further includes a database that stores associations of constant connections between the plurality of constant connection servers and a plurality of electronic devices.

The plurality of constant connection servers with the allocated data each refer to the database, and specifies a different one of the plurality of constant connection servers that is in a constant connection with the electronic device designated as a recipient of the data.

Preferably, the plurality of constant connection servers each store associations of constant connections between the plurality of constant connection servers and a plurality of electronic devices, and the plurality of constant connection servers with the allocated data each refer to the associations of constant connections, and specifies a different one of the plurality of constant connection servers that is in a constant connection with the electronic device designated as a recipient of the data.

According to another aspect of the invention, there is provided a constant connection method that includes:

sending data, by an application server, to a load balancing server;

allocating the data, by the load balancing server, to any of the plurality of constant connection servers; and

forwarding the data, by the any of the plurality of constant connection servers, to a different one of the plurality of constant connection servers that is in a constant connection with an electronic device designated as a recipient of the data.

According to another aspect of the invention, there is provided a server that includes:

a communication interface provided to constantly connect to an electronic device; and

a processor that, by using the communication interface, receives load balanced data, and forwards the data to a different one of the plurality of constant connection servers that is in a constant connection with an electronic device designated as a recipient of the data.

According to another aspect of the invention, there is provided a program for use in a constant connection server that includes: a communication interface provided to constantly connect to an electronic device; and a processor. The program causes the processor to perform:

receiving load balanced data by using the communication interface; and

forwarding the data to a different one of the plurality of constant connection servers that is in a constant connection with an electronic device designated as a recipient of the data, by using the communication interface.

In this way, the invention makes it possible to solve the problems involved in redundant constant connection servers.

According to another aspect of the invention, there is provided a network system that includes an electronic device, and a constant connection server capable of making a constant connection with the electronic device. The constant connection server sends information containing a reconnection interval concerning the constant connection server to the electronic device. The electronic device waits for a time period as determined from the reconnection interval, and repeats a process of making a constant connection until a constant connection with the constant connection server succeeds.

Preferably, the constant connection server creates a waiting time within the reconnection interval for the electronic device, and sends the waiting time to the electronic device, and the electronic device performs the process of making a constant connection after the waiting time upon being disconnected from the constant connection with the constant connection server.

Preferably, the electronic device creates a waiting time within the reconnection interval, and performs the process of making a constant connection after the waiting time upon being disconnected from the constant connection with the constant connection server.

Preferably, the waiting time is created on the basis of the frequency of data transmission and reception in the constant connection between the electronic device and the constant connection server.

Preferably, the constant connection server determines the reconnection interval on the basis of the number of electronic devices that are in constant connections with the constant connection server, and the number of electronic devices that are reconnectable to a single constant connection server per second.

Preferably, the constant connection server comprises a plurality of constant connection servers capable of making a constant connection with the electronic device, wherein at least one of the plurality of constant connection servers sends information concerning the plurality of constant connection servers to the electronic device, and wherein the electronic device attempts to make a constant connection with the plurality of constant connection servers in turn on the basis of the information until a constant connection with any of the plurality of constant connection servers succeeds.

Preferably, the at least one of the plurality of constant connection servers determines the reconnection interval on the basis of the number of electronic devices being connected to the plurality of constant connection servers, the number of electronic devices that are reconnectable to a single constant connection server per second, and the number of operating constant connection servers.

Preferably, the electronic device repeats the process of making a constant connection at the reconnection interval until a constant connection with the constant connection server succeeds.

Preferably, the constant connection server sends information containing the reconnection interval to the electronic device via a different server.

Preferably, the electronic device immediately starts the process of making a constant connection without waiting upon being determined as being disconnected from the constant connection for reasons related to the electronic device, and the electronic device starts the process of making a constant connection after waiting for a time period as determined from the reconnection interval upon being determined as being disconnected from the constant connection for reasons unrelated to the electronic device.

According to another aspect of the invention, there is provided a constant connection method for a network system that includes an electronic device, and a constant connection server capable of making a constant connection with the electronic device.

The method includes:

sending, by the constant connection server, information containing a reconnection interval to the electronic device;

terminating a constant connection between the electronic device and the constant connection server; and

repeating, by the electronic device, a process of making a constant connection by using the information, after waiting for a time period as determined from the reconnection interval, until a constant connection with the constant connection server succeeds.

According to another aspect of the invention, there is provided an electronic device that includes:

a communication interface capable of making constant connections with constant connection servers; and

a processor that repeats a process of making a constant connection until a constant connection with any of the constant connection servers succeeds, the processor repeating the process by using information concerning the constant connection servers after waiting for a time period as determined from a reconnection interval provided by any of the constant connection servers.

Preferably, the processor immediately starts the process of making a constant connection without waiting upon being determined as being disconnected from the constant connection for reasons related to the electronic device, and the processor starts the process of making a constant connection after waiting for a time period as determined from the reconnection interval upon being determined as being disconnected from the constant connection for reasons unrelated to the electronic device.

According to another aspect of the invention, there is provided a constant connection server that includes:

a communication interface capable of making a constant connection with an electronic device; and

a processor that sends information containing a reconnection interval concerning the constant connection server to the electronic device via the communication interface.

According to another aspect of the invention, there is provided a program for use in an electronic device that includes a processor and a communication interface. The program causes the processor to perform:

receiving information containing a reconnection interval from a constant connection server via the communication interface; and

repeating a process of making a constant connection with the constant connection server until a constant connection with the constant connection server succeeds, the process being repeated by using the information after a waiting time as determined from the reconnection interval.

According to another aspect of the invention, there is provided a program for use in a server that includes a processor and a communication interface. The program causes the processor to perform:

receiving a request from an electronic device via the communication interface; and

sending information containing a reconnection interval concerning a constant connection server to the electronic device via the communication interface in response to the request.

In this way, the invention can provide a network system that can smoothly return to a constant connection state without overloading a resuming server or an operating redundant server even when a constant connection server is shut down due to maintenance or accidental failure. The invention also can provide a constant connection method, an electronic device, a server, and a program.

According to another aspect of the invention, there is provided a network system that includes:

a plurality of constant connection servers;

a client that uses a service via any of the plurality of constant connection servers; and

a server capable of communicating with the client.

The server sends a list concerning at least one of the plurality of constant connection servers to the client in response to a request from the client.

The client on the basis of the list opens a constant connection with any of the plurality of constant connection servers associated with the service.

Preferably, the request contains service information for specifying the service, and the list sent by the server is a list concerning at least one constant connection server associated with the service, the list being created by the server on the basis of the service information.

Preferably, the request contains client information for specifying the client, and the server specifies the service associated with the client information, and creates as the list a list concerning at least one constant connection server associated with the service.

Preferably, the server or any of the other servers changes the service to be allocated to the plurality of constant connection servers, the service being changed on the basis of the number of clients being in constant connections with each of the plurality of constant connection servers.

Preferably, the server or any of the other servers changes the service to be allocated to the plurality of constant connection servers, the service being changed on the basis of the frequency of a data push from each of the plurality of constant connection servers.

Preferably, the server or any of the other servers changes the service to be allocated to the plurality of constant connection servers, the service being changed on the basis of a data volume from each of the plurality of constant connection servers.

Preferably, the server or any of the other servers changes the service to be allocated to the plurality of constant connection servers, the service being changed on the basis of a load on each of the plurality of constant connection servers.

Preferably, the plurality of constant connection servers includes an operating constant connection server and a non-operating constant connection server, and the server or any of the other servers switches an operating state and a non-operating state of the plurality of constant connection servers on the basis of a predetermined condition.

Preferably, the server is any of the plurality of constant connection servers.

According to another aspect of the invention, there is provided a constant connection method that includes:

sending, by a client, a request for using a service to a server;

sending, by the server, a list concerning at least one of a plurality of constant connection servers to the client in response to the request from the client; and

opening, by the client, a constant connection with any of the plurality of constant connection servers associated with the service on the basis of the list.

According to another aspect of the invention, there is provided a server that includes:

a communication interface provided to communicate with a client; and

a processor that via the communication interface receives a request from the client, and sends the client a list concerning at least one constant connection server associated with a service to be used by the client.

According to another aspect of the invention, there is provided a program for use in a server that includes a processor and a communication interface. The program causes the processor to perform:

receiving a request from a client via the communication interface; and

sending the client a list concerning at least one constant connection server associated with a service to be used by the client, the list being sent to the client via the communication interface.

According to another aspect of the invention, there is provided an electronic device that includes:

a communication interface provided to communicate with a server; and

a processor that via the communication interface receives from the server a list concerning at least one constant connection server, and opens a constant connection with a constant connection server associated with a service, the processor opening the constant connection on the basis of the list.

According to another aspect of the invention, there is provided a program for use in an electronic device that includes a processor and a communication interface. The program causes the processor to perform:

receiving a list concerning at least one constant connection server from a server via the communication interface; and

opening a constant connection with a constant connection server associated with a service, the constant connection being opened via the communication interface on the basis of the list.

In this way, the invention can solve the problems involved in redundant constant connection servers. For example, the invention can provide ways of making the maintenance or operation of a system or some of the constant connection servers easier than in related art.

Additional features and advantages of the present disclosure will be set forth in the following detailed description. Alternatively, additional features and advantages will be readily apparent to those skilled in the art from the content of the detailed description or recognized by practicing the subject matter as described herein, including the detailed description, the claims, and the appended drawings. It is to be understood that the foregoing general description concerning the related art and the following detailed description are provided solely for illustrative purposes, and are intended to provide an overview or framework for understanding the nature and character of the inventions as claimed.

### BRIEF DESCRIPTION OF THE DRAWINGS

FIG. 1 is a schematic diagram representing the overall configuration of the network system 1 according to an embodiment.

FIG. 2 is a block diagram representing the hardware configuration of client 100 according to the embodiment.

FIG. 3 is a block diagram representing the hardware configuration of constant connection server 200 according to the embodiment.

FIG. 4 is a block diagram representing the hardware configuration of application server 300 according to the embodiment.

FIG. 5 is a block diagram representing the hardware configuration of load balancing server 400 according to the embodiment.

FIG. 6 is a block diagram representing the overall functional configuration of the network system 1 according to the embodiment.

FIG. 7 is a sequence diagram representing the procedures of the data exchange between devices concerning a constant connection in the network system 1 according to the embodiment.

FIG. 8 is a first schematic diagram representing the overall configuration and operation of the network system 1B according to an embodiment.

FIG. 9 is a second schematic diagram representing the overall configuration and operation of the network system 1B according to an embodiment.

FIG. 10 is a third schematic diagram representing the overall configuration and operation of the network system 1B according to an embodiment.

FIG. 11 is a block diagram representing the hardware configuration of load balancing server 600 according to the embodiment.

FIG. 12 is a block diagram representing the overall functional configuration of the network system 1B according to the embodiment.

FIG. 13 is a schematic diagram representing the data structure of association DB 500 according to the embodiment.

FIG. 14 is a first schematic diagram representing the overall configuration and operation of the network system 1 according to an embodiment.

FIG. 15 is a second schematic diagram representing the overall configuration and operation of the network system 1 according to the embodiment.

FIG. 16 is a third schematic diagram representing the overall configuration and operation of the network system 1 according to the embodiment.

FIG. 17 is a schematic diagram representing the timings of client 100 accessing the load balancing server 600 according to the embodiment.

FIG. 18 is a block diagram representing the hardware configuration of client 100 according to the embodiment.

FIG. 19 is a block diagram representing the hardware configuration of constant connection server 200 according to the embodiment.

FIG. 20 is a block diagram representing the hardware configuration of application server 300 according to the embodiment.

FIG. 21 is a block diagram representing the hardware configuration of constant connection auxiliary server 400B according to the embodiment.

FIG. 22 is a block diagram representing the hardware configuration of load balancing server 600 according to the embodiment.

FIG. 23 is a sequence diagram representing the procedures of the data exchange between devices concerning a constant connection in the network system 1 according to the embodiment.

FIG. 24 is a flowchart representing the procedures of the reconnection process in client 100 according to the embodiment.

FIG. 25 is a flowchart representing the procedures of the standby subroutine in client 100 according to the embodiment.

FIG. 26 is a sequence diagram representing the procedures of the initial connection process according to the embodiment.

FIG. 27 is a sequence diagram representing the procedures of the reconnection process according to the embodiment.

FIG. 28 is a schematic diagram representing the overall configuration of the network system 1 according to an embodiment.

FIG. 29 is a block diagram representing the hardware configuration of first auxiliary server 600C according to the embodiment.

FIG. 30 is a schematic diagram representing a structure of the data contained in service/node association DB 510 according to the embodiment.

FIG. 31 is a block diagram representing the hardware configuration of second auxiliary server 400C according to the embodiment.

FIG. 32 is a schematic diagram representing a structure of the data contained in connection ID/node association DB 520 according to the embodiment.

FIG. 33 is a block diagram representing the hardware configuration of monitoring server 800 according to the embodiment.

FIG. 34 is a first block diagram representing the overall functional configuration of the network system 1 according to Eighteenth Embodiment.

FIG. 35 is a second block diagram representing the overall functional configuration of the network system 1 according to Eighteenth Embodiment.

FIG. 36 is a third block diagram representing the overall functional configuration of the network system 1 according to Eighteenth Embodiment.

FIG. 37 is a sequence diagram representing the procedures of the data exchange between devices concerning a constant connection in the network system 1 according to the embodiment.

FIG. 38 is a fourth block diagram representing the overall functional configuration of the network system 1 according to Eighteenth Embodiment.

FIG. 39 is a fifth block diagram representing the overall functional configuration of the network system 1 according to Eighteenth Embodiment.

FIG. 40 is a flowchart representing the node selection process by client 100 according to the embodiment.

FIG. 41 is a flowchart representing the node selection process by first auxiliary server 600C according to the embodiment.

FIG. 42 is a flowchart representing the association changing process by monitoring server 800 according to the embodiment.

FIG. 43 is a block diagram representing the overall functional configuration of the network system 1 according to Nineteenth Embodiment.

FIG. 44 is a block diagram representing the overall functional configuration of the network system 1 according to Twentieth Embodiment.

FIG. 45 is a block diagram representing the overall functional configuration of the network system 1 according to Twenty-First Embodiment.

FIG. 46 is a first block diagram representing the overall functional configuration of the network system 1 according to Twenty-Second Embodiment.

FIG. 47 is a second block diagram representing the overall functional configuration of the network system 1 according to Twenty-Second Embodiment.

FIG. 48 is a first block diagram representing the overall functional configuration of the network system 1 according to Twenty-Third Embodiment.

FIG. 49 is a second block diagram representing the overall functional configuration of the network system 1 according to Twenty-Third Embodiment.

FIG. 50 is a first block diagram representing the overall functional configuration of the network system 1 according to Twenty-Fourth Embodiment.

FIG. 51 is a second block diagram representing the overall functional configuration of the network system 1 according to Twenty-Fourth Embodiment.

FIG. 52 is a first block diagram representing the overall functional configuration of the network system 1 according to Twenty-Fifth Embodiment.

FIG. 53 is a second block diagram representing the overall functional configuration of the network system 1 according to Twenty-Fifth Embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

The following describes WebSocket protocol communications as an example of constant connection. WebSocket is a technical standard for performing bidirectional communications primarily between a web server and a web browser. The specification of the WebSocket protocol is described in RFC (Request For Comment) 6455. WebSocket is a protocol for constant connection, and enables multiple bidirectional communications over a maintained connection. However, the present invention is not limited to a constant connection that uses the WebSocket protocol, as long as an application server can push data to a client at any timing.

### First Embodiment

### Overall Configuration of Network System

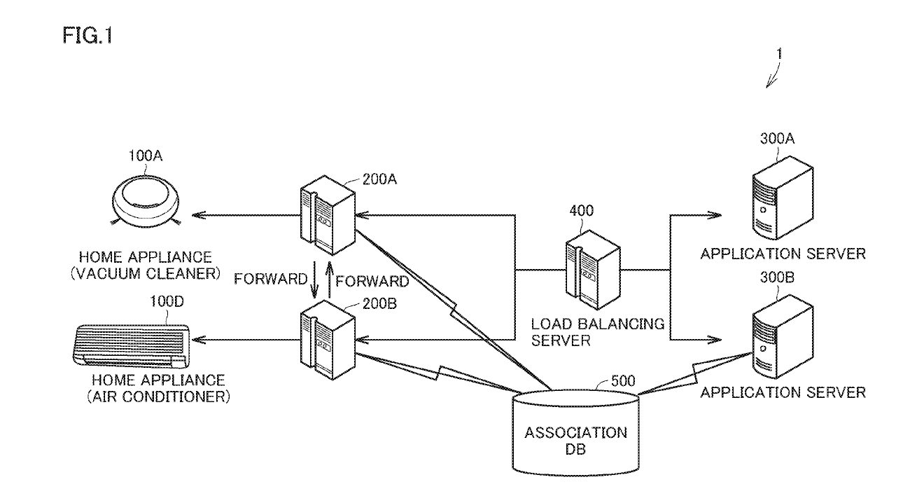

The overall configuration of the network system 1 according to the present embodiment is described below. FIG. 1 is a schematic diagram representing the overall configuration of the network system 1 according to the present embodiment.

Referring to FIG. 1, the network system 1 according to the present embodiment includes a plurality of home appliances 100A and 100D disposed in locations such as homes and offices, constant connection servers 200A and 200B connected to the home appliances 100A and 100D via a network, a plurality of application servers 300A and 300B that provide various services concerning the home appliances 100A and 100D, and a load balancing server 400 for balancing the load between the constant connection servers 200A and 200B.

In the following, descriptions will be given through the case where two constant connection servers 200A and 200B are provided. However, only one constant connection server, or three or more constant connection servers may be provided. Similarly, only one application server, or three or more application servers may be provided. Only one home appliance, or three or more home appliances may be provided. Two or more load balancers may be provided.

Examples of the home appliances include a vacuum cleaner 100A, an air conditioner 100D, a television, a washing machine, a refrigerator, a rice cooker, an air purifier, a floor heating system, and an IH (Induction Heating) cooking heater. The home appliances may be any communications devices for homes and offices, including, for example, personal computers, audio-video equipment other than television, and an intercom system. The constant connection servers 200A and 200B, the application servers 300A and 300B, and the load balancing server 400 may include servers that reside in the same home, office, building, company, or school where the home appliances are provided.

The home appliances and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, the vacuum cleaner 100A and the air conditioner 100D become constantly connected to the constant connection server 200A or 200B. This enables the application server 300A for vacuum cleaner, and the application server 300B for air conditioner to push data to the vacuum cleaner 100A and the air conditioner 100D at any timing via the constant connection servers 200A and 200B.

Specifically, in the network system 1 according to the present embodiment, it is not required to directly establish a constant connection between each home appliance and all the relevant application servers providing services to the home appliances. Conversely, there is no need for each application server to directly establish a constant connection with all the associated home appliances.

### <Brief Overview of Network System Operation>

The following is a brief overview of the operation of the network system 1 according to the present embodiment. In the following, the home appliances, including the vacuum cleaner 100A and the air conditioner 100D will also be collectively called clients 100 for simplicity. For the same purpose, the constant connection server 200A representing node 1, and the constant connection server 200B representing node 2 will also be collectively referred to as constant connection servers 200. Likewise, the term.“application server 300” will also be used as a collective term for application servers, including the application server 300A for vacuum cleaner, and the application server 300B for air conditioner, that provide various services to clients 100 and users.

Referring to FIG. 1, the vacuum cleaner 100A constantly connects to the constant connection server 200A (node 1) over the WebSocket protocol. This allows the vacuum cleaner 100A to send data to the application server 300A for vacuum cleaner via the constant connection server 200A. Conversely, the application server 300A for vacuum cleaner can push data to the vacuum cleaner 100A via the constant connection server 200A at any timing.

Similarly, the air conditioner 100D constantly connects to the constant connection server 200B (node 2) over the WebSocket protocol. Specifically, the air conditioner 100D can send data to the application server 300B for air conditioner via the constant connection server 200B. Conversely, the application server 300B for air conditioner can push data to the air conditioner 100D via the constant connection server 200B at any timing.

In the present embodiment, the load balancing server 400 is installed between the constant connection servers 200A and 200B and the application servers 300A and 300B. The load balancing server 400 is used to prevent overloading the constant connection server 200A or 200B when the other constant connection server 200A or 200B has fewer loads.

For example, upon receiving data from the application server 300A or 300B, the load balancing server 400 checks the loads on the constant connection servers 200A and 200B, and sends the data to the less loaded constant connection server 200.

In the present embodiment, the constant connection server 200A upon receiving data from the load balancing server 400 determines whether the data is intended for the home appliance 100A that is in a constant connection with the constant connection server 200A. When the data is intended for the home appliance 100A that is in a constant connection with the constant connection server 200A, the constant connection server 200A sends the data to the home appliance 100A over the WebSocket protocol.

On the other hand, when the data is not intended for the home appliance 100A that is in a constant connection with the constant connection server 200A, the constant connection server 200A specifies the constant connection server 200B that is in a constant connection with the home appliance 100D for which the data is intended. The constant connection server 200A then forwards the data to the constant connection server 200B that is in a constant connection with the home appliance 100D designated as a receiving device. Because the data is intended for the home appliance 100D that is in a constant connection with the constant connection server 200B, the constant connection server 200B sends the data to the home appliance 100D, using the WebSocket protocol.

In this manner, in the network system 1 according to the present embodiment, the load balancing server 400 can balance the load between the plurality of constant connection servers 200, despite that the system involves a constant connection between the client 100 and the constant connection server 200.

The following describes the specific configuration of the network system 1 for realizing the foregoing functions.

### <Hardware Configuration of Client 100>

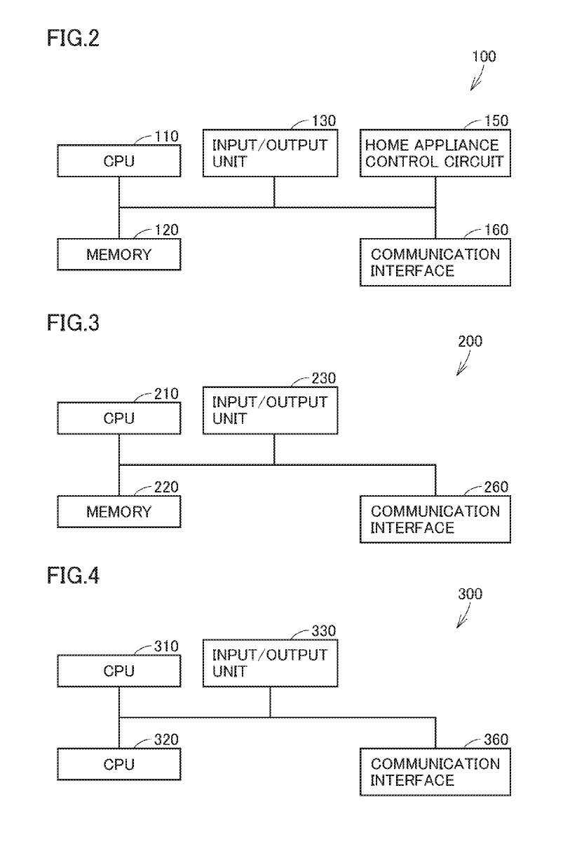

The following describes an aspect of the hardware configuration of the client 100. FIG. 2 is a block diagram representing the hardware configuration of the client 100 according to the present embodiment.

Referring to FIG. 2, the main constituting elements of the client 100 include a CPU 110, a memory 120, an input/output unit 130, a home appliance control circuit 150, and a communication interface 160.

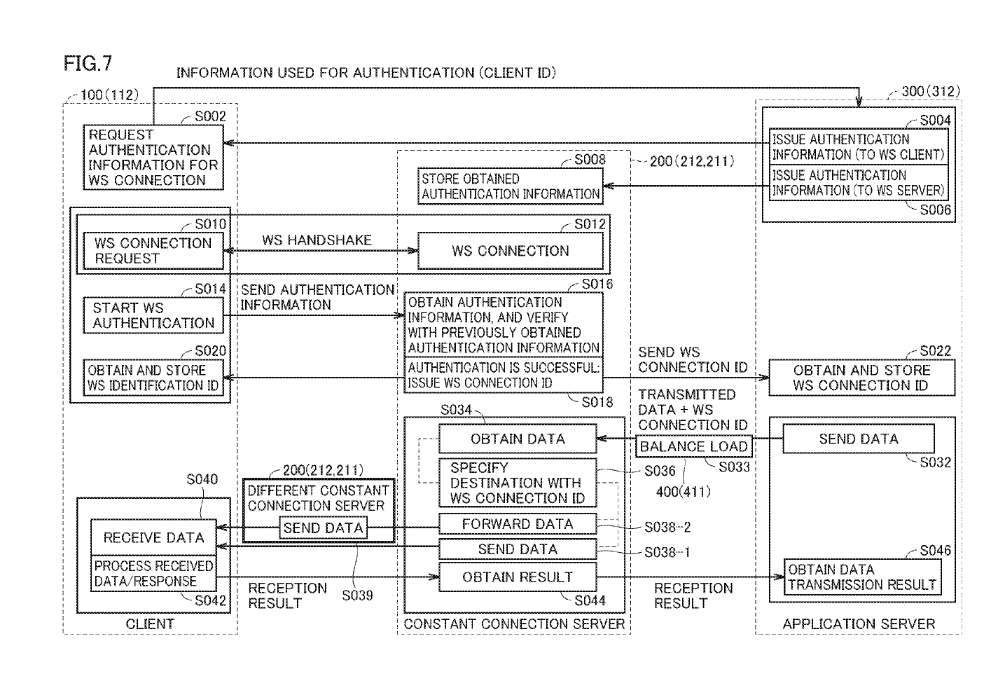

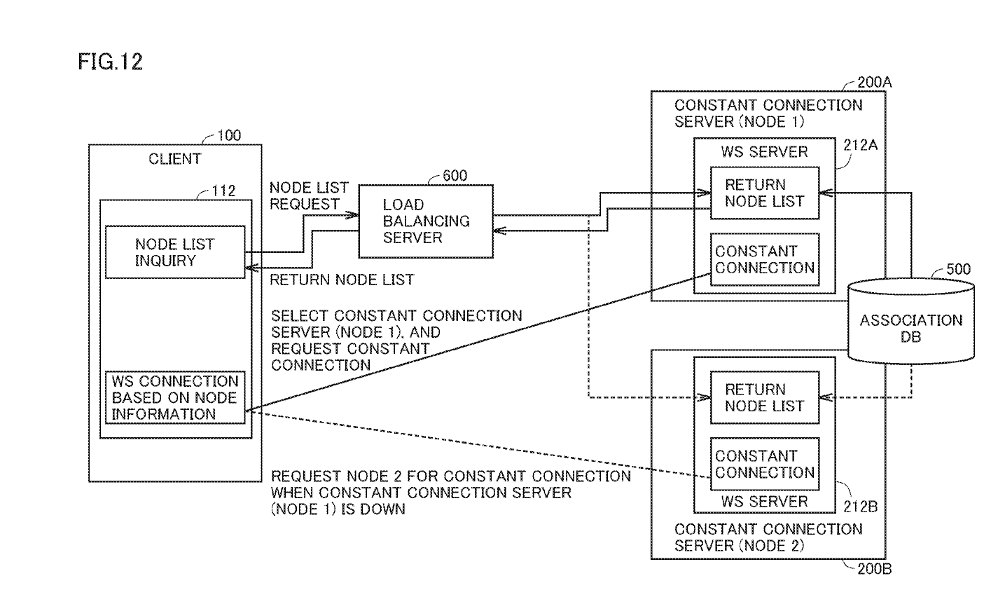

The CPU 110 controls each part of the client 100 by running programs stored in the memory 120 or in external storage media. More specifically, the CPU 110 executes the programs stored in the memory 120, and operates as a client APP (application software) and a client API (Application Programming Interface) 112 (see FIGS. 7 and 12). More specifically, the client APP controls each part of the client 100. The client API 112 communicates over the HTTP protocol, or over the WebSocket protocol on the HTTP protocol, via the communication interface.

The memory 120 is realized by various types of memory, including, for example, RAM (Random Access Memory), ROM (Read-Only Memory), and flash memory. The memory 120 may also be realized by, for example, storage media used with an interface, including, for example, USB (Universal Serial Bus®) memory, CD (Compact Disc), DVD (Digital Versatile Disk), memory card, hard disk, IC (Integrated Circuit) card, optical memory card, mask ROM, EPROM (Erasable Programmable Read Only Memory), and EEPROM (Electronically Erasable Programmable Read-Only Memory).

The memory 120 stores programs run by the CPU 110, data generated after the execution of a program by the CPU 110, input data via the input/output unit 130, APP data operating as a client such as a vacuum cleaner and an air conditioner, and API data for communicating with the constant connection server 200 while exchanging data with the client APP. The APP data includes service connection information for sending and receiving information to and from the application server 300. The API data includes WebSocket client API setting information, authentication information, connected device service setting information, and connection status information.

The input/output unit 130 receives a user instruction, and enters the instruction to the CPU 110. The input/output unit 130 outputs characters and images by using signals from the CPU 110.

The home appliance control circuit 150 controls each part (such as a motor) of the client (home appliance) by using signals from the CPU 110.

The communication interface 160 is realized by various communications modules, including, for example, wireless LAN communications (such as IEEE 802.11a/b/g/n/ac), ZigBee®, BlueTooth®, and wired LAN such as Ethernet®. The communication interface 160 is provided for data exchange with other devices over wired communications or wireless communications. The CPU 110 receives programs, control instructions, image data, text data, and other such information from other devices, and sends information such as text data and image data to other devices via the communication interface 160.

### <Hardware Configuration of Constant Connection Server 200>

The following describes an aspect of the hardware configuration of the constant connection server 200. FIG. 3 is a block diagram representing the hardware configuration of the constant connection server 200 according to the present embodiment.

Referring to FIG. 3, the main constituting elements of the constant connection server 200 include a CPU 210, a memory 220, an input/output unit 230, and a communication interface 260. The hardware configuration of the constant connection server 200 differs from that of the client 100 in that the home appliance control circuit 150 for controlling each part of the home appliances is not provided. Other differences are the operation of the CPU 210, and the data stored in the memory 220. Accordingly, the following describes the operation of the CPU 210, and the data stored in the memory 220, and does not describe other hardware configuration.

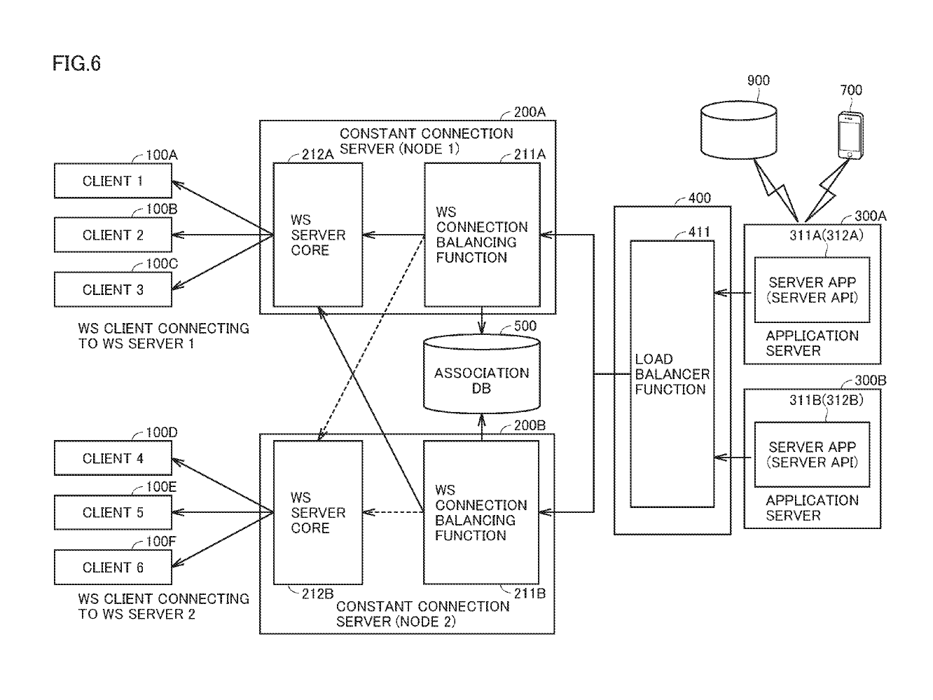

The CPU 210 controls each part of the constant connection server 200 by running programs stored in the memory 220 or in external storage media. Specifically, the CPU 210 executes the programs stored in the memory 220, and operates as WS server cores 212, 212A, and 212B (see FIGS. 6, 7, and 12; described later), and WS connection balancing functions 211, 211A, and 211B (see FIGS. 6, 7, and 12). The WS server core 212 refers to a constant connection server in the form of software, and controls the constant connection communications with the client 100 over the WebSocket protocol, or the communications with the load balancing server 400 or a plurality of application servers 300 over the HTTP protocol.

The memory 220 stores information such as programs run by the CPU 210, data generated after the execution of a program by the CPU 210, input data via the input/output unit 230, service master information, temporary authentication information, connection status administrative information, connection group information, and connection group participation information.

### <Hardware Configuration of Application Server 300>

The following describes an aspect of the hardware configuration of the application server 300. FIG. 4 is a block diagram representing the hardware configuration of the application server 300 according to the present embodiment.

Referring to FIG. 4, the main constituting elements of the application server 300 include a CPU 310, a memory 320, an input/output unit 330, and a communication interface 360. The hardware configuration of the application server 300 differs from that of the constant connection server 200 in the operation of the CPU 310, and the data stored in the memory 320. Accordingly, the following describes the operation of the CPU 310, and the data stored in the memory 320, and does not describe other hardware configuration.

The CPU 310 controls each part of the application server 300 by running programs stored in the memory 320 or in external storage media. Specifically, the CPU 310 executes the programs stored in the memory 320, and operates as server APPS 311A and 311B (see FIG. 6; described later), and server APIs 312, 312A, and 312B (see FIGS. 6 and 7; described later).

The server APPS 311A and 311B refer to application servers in the form of software, and provide services to devices such as the client 100 and a smartphone 500. The server APIs 312, 312A, and 312B control the communications with the load balancing server 400 or the constant connection server 200 over the HTTP protocol.

The memory 320 stores programs run by the CPU 310, data generated after the execution of a program by the CPU 310, input data via a keyboard (input/output unit) 330, APP data operating as the application server 300, and API data for communicating with the constant connection server 200 while exchanging data with the server APP. APP data includes client information that contains information concerning the client 100 of interest to the APP data, client connection information concerning the client 100 that is in a constant connection, and connection probability temporary information for opening a new constant connection. The API data includes WebSocket server API setting information, authentication administrative information, service setting information, and client connection status information.

### <Association DB>

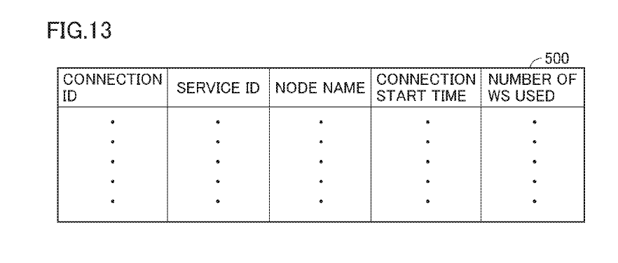

The following describes the association DB 500 used in the network system 1 according to the present embodiment. FIG. 13 is a schematic diagram representing the data structure of the association DB 500 according to the present embodiment.

Referring to FIG. 13, the association DB 500 contains the association between a connection ID for specifying a client 100, a service ID (also called application definition data) for specifying the service provided by the application server 300, a node name for specifying the constant connection server 200 (may be associated with the address of the constant connection server 200, or may be the address of the constant connection server 200 itself), the start time of a constant connection, and the number of times the constant connection was used. The association is stored for each combination of client 100 and an application service. The association DB 500 can be referred to from the plurality of applications servers 300 and the plurality of constant connection servers 200 in the network system 1 according to the present embodiment.

### <Hardware Configuration of Load Balancing Server 400>

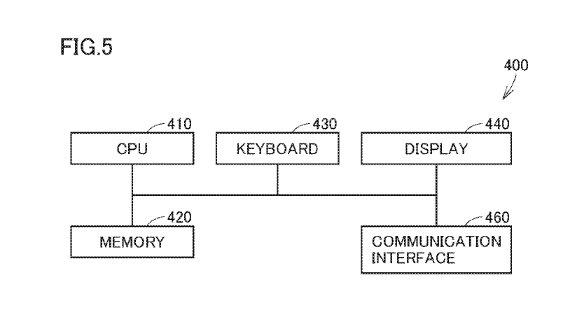

The following describes an aspect of the hardware configuration of the load balancing server 400. FIG. 5 is a block diagram representing the hardware configuration of the load balancing server 400 according to the present embodiment.

Referring to FIG. 5, the main constituting elements of the load balancing server 400 include a CPU 410, a memory 420, a keyboard 430, a display 440, and a communication interface 460. The hardware configuration of the load balancing server 400 differs from that of the constant connection server 200 in the operation of the CPU 410, and the data stored in the memory 420. Accordingly, the following describes the operation of the CPU 410, and the data stored in the memory 420, and does not describe other hardware configuration.

The CPU 410 controls each part of the load balancing server 400 by running programs stored in the memory 420 or in external storage media. Specifically, the CPU 410 executes the programs stored in the memory 420, and realizes a load balancer function 411 (see FIGS. 6 and 7; described later).

The memory 420 stores programs run by the CPU 410, data generated after the execution of a program by the CPU 410, input data via the keyboard 430, and a constant connection server list and a constant connection server load condition needed to operate as the load balancing server 400. The constant connection server list stores the address of each constant connection server 200 currently available for communications with the load balancing server 400. The constant connection server load condition stores the load of each constant connection server 200 currently available for communications with the load balancing server 400.

### <Functional Configuration of Network System 1>

The overall functional configuration of the network system 1 according to the present embodiment is described below.

FIG. 6 is a block diagram representing the overall functional configuration of the network system 1 according to the present embodiment. For convenience of explanation, clients 100A to 100F will be described as home appliances that are in constant connections.

Referring to FIG. 6, the clients 100A to 100C are in constant connections with the constant connection server 200A (node 1) over the WebSocket protocol. The clients 100D to 100F are in constant connections with the constant connection server 200B (node 2) over the WebSocket protocol. The clients 100A to 100F may communicate with the constant connection servers 200A and 200B and with the application servers 300A and 300B over the HTTP protocol.

Concerning the application servers 300A and 300B, the server APPS 311A and 311B are realized by the CPU 310, and request the server APIs 312A and 312B to exchange data with other devices. In the present embodiment, the network system 1 includes the server APP 311A for controlling the vacuum cleaner 100A, and the server APP 311B for controlling the air conditioner 100D.

The server APIs 312A and 312B are realized by the CPU 310, and sends and receives data to and from the load balancing server 400, the association DB 500, and other devices such as a database 900 and a smartphone 700 by using the communication interface 360. In the present embodiment, the application servers 300A and 300B can send data to the client 100A to 100F via the constant connection servers 200A and 200B at any timing.

Concerning the load balancing server 400, the load balancer function 411 is realized by the CPU 410, and selects whichever of the constant connection servers 200A and 200B has fewer loads. The load balancer function 411 sends the data from the application servers 300A and 300B to the selected one of the constant connection servers 200A and 200B.

Concerning the constant connection servers 200A and 200B, the WS server cores 212A and 212B are realized by the CPU 210, and constantly connect to the clients 100A to 100F via the communication interface 260 over the WebSocket protocol. The WS server cores 212A and 212B also perform data communications with other devices such as other constant connection servers 200, the load balancing server 400, and the application server 300 via the communication interface 260, using the HTTP protocol.

The WS connection balancing functions 211A and 211B are realized by the CPU 210. The following describes the function of the WS connection balancing function 211A of the constant connection server 200A. Upon receiving data from the load balancing server 400, the WS connection balancing function 211A determines whether the data is intended for the clients 100A to 100C that are in constant connections with the constant connection server 200A. Here, the determination is made by using the connection ID and the service ID contained in the data. The connection ID is a service specific ID, set for each combination of the clients 100A to 100F and the server APPs 311A and 311B.

When the data is intended for any of the clients 100A to 100C that are in constant connections with the constant connection server 200A, the WS connection balancing function 211A requests the WS server core 212A to send the data to the client 100. The WS server core 212A sends the data to the client 100 via the communication interface 260, using the WebSocket protocol.

On the other hand, when the data is not intended for the clients 100A to 100C that are in constant connections with the constant connection server 200A, the WS connection balancing function 211A specifies the constant connection server 200B that is in a constant connection with the client 100 for which the data is intended. Specifically, the WS connection balancing function 211A accesses the external association DB 500 via the WS server core 212A and the communication interface 260. The association DB 500 stores he connection statuses between numerous clients and multiple constant connection servers. The WS connection balancing function 211A obtains information for specifying the constant connection server 200B that is in constant connections with the clients 100D to 100F associated with connection IDs. The WS connection balancing function 211A forwards the data and the connection ID to the constant connection server 200B via the communication interface 260.

The WS server core 212B of the constant connection server 200B pushes the data forwarded from the constant connection server 200A to any of the clients 100D to 100F that are in constant connections with the constant connection server 200B, using the connection ID.

<Data Exchange between Devices Concerning Constant Connection>

The following is a brief overview of the data exchange between devices concerning the constant connection in the network system 1 according to the present embodiment. FIG. 7 is a sequence diagram representing the procedures of the data exchange between devices concerning the constant connection in the network system 1 according to the present embodiment.

Referring to FIG. 7, the client API 112 realized by the client 100 requests the application server 300 for authentication information over the HTTP protocol via the communication interface 160 (step S002). Here, the client API 112 sends the application server 300 a client ID used for authentication. The server API 312 of the application server 300 responds to the request by sending authentication information to the client 100 over the HTTP protocol via the communication interface 360 (step S004).

The server API 312 sends authentication information also to the constant connection server 200 via the communication interface 360 (step S006). The WS server core 212 of the constant connection server 200 stores the authentication information sent from the application server 300 (step S008).

The client 100 and the constant connection server 200 establish a WebSocket constant connection state, using the HTTP protocol (step S010, step S012). Specifically, the client API 112 sends a handshake request to the constant connection server 200 over the HTTP protocol via the communication interface 160. The WS server core 212 returns a handshake response via the communication interface 260. This establishes a valid WebSocket constant connection between the client 100 and the constant connection server 200.

The client API 112 sends the authentication information to the constant connection server 200 via the communication interface 160 (step S014). The WS server core 212 or the WS connection balancing function 211 authenticates the client 100 by using the authentication information from the client 100, and the stored authentication information (step S016). When authentication is successful, the WS server core 212 or the WS connection balancing function 211 issues a connection ID for the identification of the client 100 by the application server 300 (step S018).

Specifically, the association between the connection ID and the client 100 in the constant connection is stored as connection status administrative information in the WS server core 212 or the WS connection balancing function 211. The client 100 receives and stores the connection ID (step S020). The application server 300 also receives and stores the connection ID (step S022). Here, the WS server core 212 or the WS connection balancing function 211 associates the connection ID, the information for specifying the constant connection server 200A, and the information for specifying the application service, and registers the association in the association DB 500 via the communication interface 260.

In response to a request from the server APP 311, the server API 312 sends the main data, and the connection ID for specifying the receiving client 100 to the constant connection server 200 via the communication interface 360 (step S032).

In the present embodiment, the data from the application server 300 is received by the load balancing server 400 in step S033. The load balancer function 411 of the load balancing server 400 obtains the load of each constant connection server 200, and uses this load to select the constant connection server 200 to which the data should be sent. The load balancer function 411 sends the data to the selected constant connection server 200 via the communication interface 460.

For example, the load balancer function 411 preferentially sends data to whichever of the constant connection servers 200 has fewer loads. Alternatively, the load balancer function 411 may preferentially send data to the constant connection server 200 that is in constant connections with fewer clients 100. The load balancer function 411 may also randomly send data.

The constant connection server 200 receives the main data and the connection ID from the load balancing server 400 (step S034). The WS connection balancing function 211 refers to the connection status administrative information, and specifies the client 100 on the basis of the connection ID (step S036).

When the client 100 associated with the connection ID is in a constant connection with the constant connection server 200, the WS connection balancing function 211 requests the WS server core 212 to send the data to the client. Specifically, the WS server core 212 sends the main data to the specified client 100 via the communication interface 260, using the WebSocket protocol (step S038-1). The client 100 receives the main data (step S040).

The client 100 sends the reception result to the constant connection server 200 over the WebSocket protocol (step S042). Upon receiving the reception result, the constant connection server 200 sends the reception result to the application server 300 (step S044). The application server 300 receives the reception result (step S046).

On the other hand, when the client 100 associated with the connection ID is not in a constant connection with the constant connection server 200, the WS connection balancing function 211 requests the WS server core 212 to forward the data to a different constant connection server 200. Specifically, the WS connection balancing function 211 refers to the association database 500 via the communication interface 260, and specifies the constant connection server 200 that is in a constant connection with the client 100 associated with the connection ID.

The WS connection balancing function 211 requests the WS server core 212 to send the data to the different constant connection server 200. The WS server core 212 forwards the data to the specified constant connection server 200 via the communication interface 260, using the HTTP protocol (step S038-2). The WS server core 212 of the different constant connection server 200 sends the data to the client 100 associated with the connection ID via the communication interface 260, using the WebSocket protocol (step S039).

In this manner, in the network system 1 according to the present embodiment, the load balancing server 400 can balance the load between the constant connection servers 200 even when the clients 100 are in constant connections with the constant connection servers 200.

### Second Embodiment

### Overall Configuration of Network System

The following describes Second Embodiment. The network system 1B according to the present embodiment additionally includes a load balancing server 600 (described later) in the network system 1 of First Embodiment.

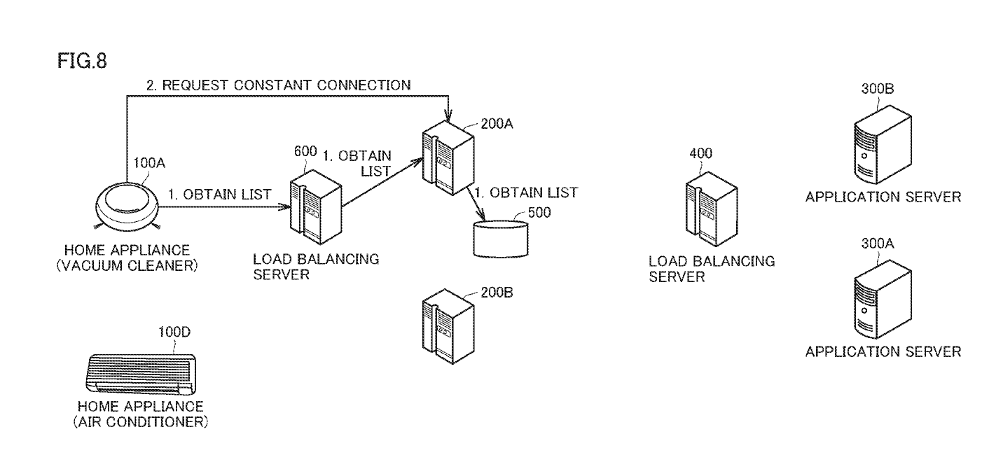

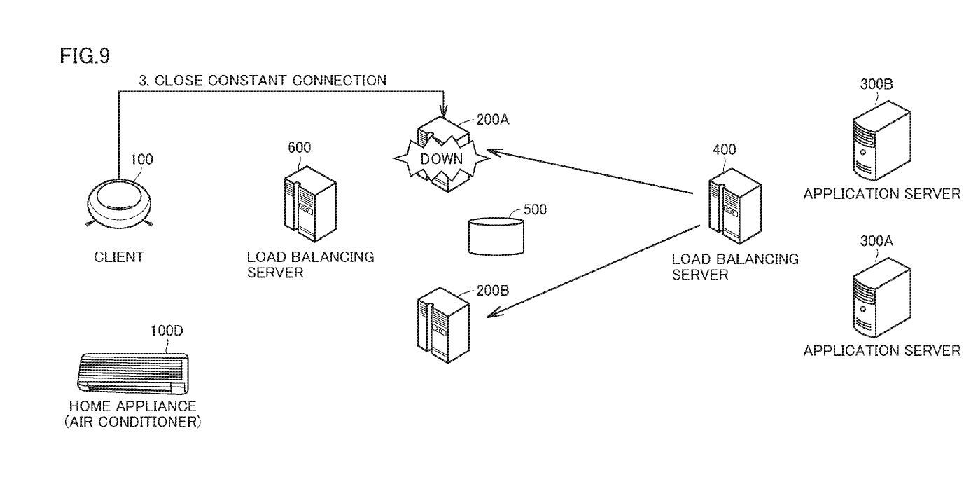

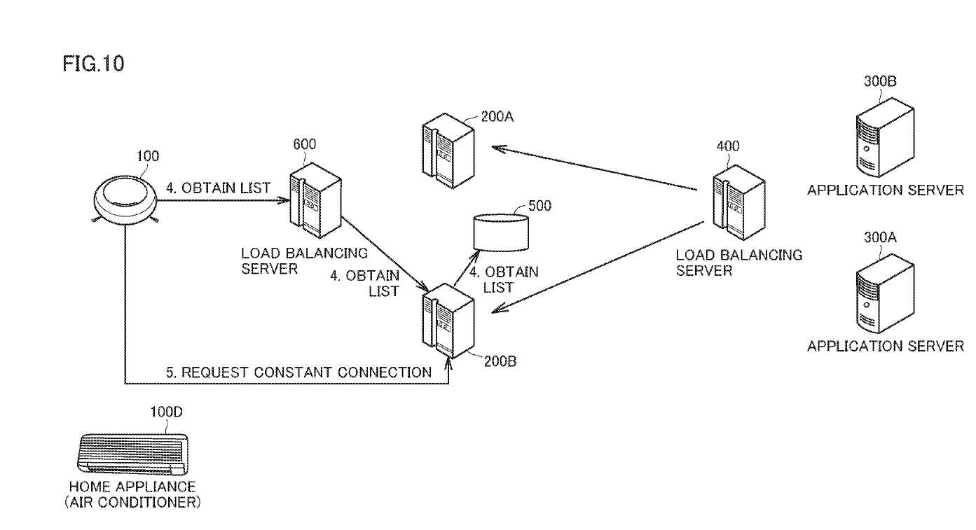

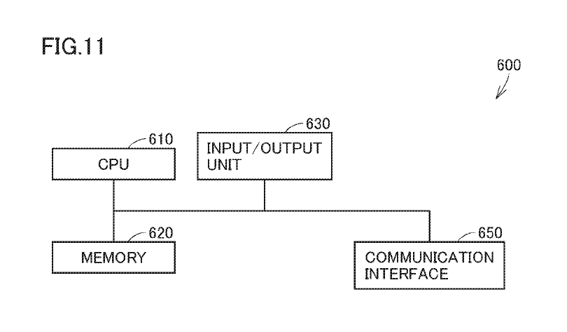

The overall configuration of the network system 1B according to the present embodiment is described first. FIG. 8 is a first schematic diagram representing the overall configuration and operation of the network system 1B according to the present embodiment. FIG. 9 is a second schematic diagram representing the overall configuration and operation of the network system 1B according to the present embodiment. FIG. 10 is a third schematic diagram representing the overall configuration and operation of the network system 1B according to the present embodiment.

Referring to FIG. 8, the network system 1B includes a plurality of home appliances 100A and 100D disposed in locations such as homes and offices, constant connection servers 200A and 200B connected to the home appliances 100A and 100D via a network, a plurality of application servers 300A and 300B that provide various services concerning the home appliances 100A and 100D, a load balancing server 400 for balancing the load between the constant connection servers 200A and 200B, and a load balancing server 600 for reconnecting the clients 100 to the constant connection servers 200A and 200B.

In the following, descriptions will be given through the case where two constant connection servers 200A and 200B are provided. However, only one constant connection server, or three or more constant connection servers may be provided. Similarly, only one application server, or three or more application servers may be provided. Only one home appliance, or three or more home appliances may be provided. Two or more load balancers, and two or more constant connection auxiliary servers may be provided.

The home appliances, the constant connection servers, the application servers, and the load balancing server are as defined in First Embodiment, and will not be described further.

In the present embodiment, the vacuum cleaner 100A and the air conditioner 100D constantly connect to the constant connection server 200A or 200B. This enables the application server 300A for vacuum cleaner, and the application server 300B for air conditioner to push data to the vacuum cleaner 100A and the air conditioner 100D via the constant connection servers 200A and 200B at any timing.

Specifically, in the network system 1B according to the present embodiment, it is not required to directly establish a constant connection between each home appliance and all the relevant application servers providing services to the home appliances. Conversely, there is no need for each application server to directly establish a constant connection with all the associated home appliances.

### <Brief Overview of Network System Operation>

The following is a brief overview of the operation of the network system 1B according to the present embodiment. In the following, the home appliances, including the vacuum cleaner 100A and the air conditioner 100D will also be collectively called clients 100 for simplicity. For the same purpose, the constant connection server 200A representing node 1, and the constant connection server 200B representing node 2 will also be collectively referred to as constant connection servers 200. Likewise, the term “application server 300” will also be used as a collective term for application servers, including the application server 300A for vacuum cleaner, and the application server 300B for air conditioner, that provide various services to clients 100 and users.

Referring to FIG. 8, in order to open a constant connection with the constant connection server 200A or 200B, the vacuum cleaner 100A request the constant connection server 200 for a node list storing the addresses of the operating constant connection servers. The request is sent via the load balancing server 600, using the HTTP protocol.

In response to the node list request from the load balancing server 600, the constant connection server 200 requests the association DB 500 for the node list. Alternatively, the constant connection server upon receiving the node list request sends connection check data (ping) to the constant connection servers 200A and 200B, and creates a node list according to the response. By using the node list received from the constant connection server 200 via the load balancing server 600, the vacuum cleaner 100A opens a constant connection with the constant connection server 200A (node 1) over the WebSocket protocol.

In this manner, the vacuum cleaner 100A can send data to the application server 300A for vacuum cleaner via the constant connection server 200A. Conversely, the application server 300A for vacuum cleaner can push data to the vacuum cleaner 100A via the constant connection server 200A.

Similarly, the air conditioner 100D constantly connects to the constant connection server 200B (node 2) over the WebSocket protocol. Specifically, the air conditioner 100D can send data to the application server 300B for air conditioner via the constant connection server 200B. Conversely, the application server 300B for air conditioner can push data to the air conditioner 100D via the constant connection server 200B.

As in First Embodiment, the load balancing server 400 is installed between the constant connection servers 200A and 200B and the application servers 300A and 300B. The load balancing server 400 is used to prevent overloading the constant connection server 200A or 200B when the other constant connection server 200A or 200B has fewer loads.

For example, upon receiving data from the application server 300A or 300B, the load balancing server 400 checks the loads on the constant connection servers 200A and 200B, and preferentially sends the data to the less loaded constant connection server 200.

Alternatively, the load balancing server 400 may preferentially send data to the constant connection server 200 that is in constant connections with fewer clients 100. The load balancing server 400 may also randomly send data. Alternatively, the load balancing server 400 may preferentially send data to the constant connection server 200 having a higher time priority in a priority list storing the priorities of the constant connection servers 200 based on different hours of the day.

As in First Embodiment, the constant connection server 200A upon receiving data from the load balancing server 400 determines whether the data is intended for the home appliance that is in a constant connection with the constant connection server 200A. When the data is intended for the home appliance (for example, vacuum cleaner 100A) that is in a constant connection with the constant connection server 200A, the constant connection server 200A sends the data to the vacuum cleaner 100A over the WebSocket protocol.

On the other hand, when the data is not intended for the home appliance that is in a constant connection with the constant connection server 200A, the constant connection server 200A specifies the constant connection server 200B that is in a constant connection with the home appliance (for example, air conditioner 100D) for which the data is intended. The constant connection server 200A preferentially forwards the data to the constant connection server 200B that is in a constant connection with the air conditioner 100B designated as a receiving device. Because the data is intended for the air conditioner 100B that is in a constant connection with the constant connection server 200B, the constant connection server 200B sends the data to the air conditioner 100B, using the WebSocket protocol.

Alternatively, the load balancing server 400 may refer to the association DB 500 to specify the constant connection server 200 that is in a constant connection with the home appliance for which the data is intended. In this case, the load balancing server 400 can send data to the constant connection server 200B that is in a constant connection with the home appliance (for example, air conditioner 100D) for which the data is intended, and the constant connection server 200A does not require the WS connection balancing function 211 described in First Embodiment.

Referring to FIG. 9, there are cases where a malfunction occurs in the constant connection server 200A that is in a constant connection with the vacuum cleaner 100A. Specifically, the vacuum cleaner 100A may fail to communicate with the constant connection server 200A over a constant connection.

In such cases, referring to FIG. 10, the vacuum cleaner 100A opens a constant connection with a different constant connection server, 200B, by requesting either of the constant connection servers 200 for a node list storing the addresses of the operating constant connection servers 200. Here, the request is sent via the load balancing server 600 over the HTTP protocol. By using the node list, the vacuum cleaner 10 OA opens a constant connection with the operating constant connection server 200B (node 2) over the WebSocket protocol.

In this way, the vacuum cleaner 100A can resend data to the application server 300A for vacuum cleaner via the constant connection server 200B. Conversely, the application server 300A for vacuum cleaner can repush data to the vacuum cleaner 100A via the constant connection server 200B.

In this manner, in the network system 1B according to the present embodiment, the application server can push data to the client via a different constant connection server even when the client fails to communicate with one of the constant connection servers. In the network system 1B according to the present embodiment, the load balancing server 400 can balance the load between the constant connection servers 200, even though the system involves constant connections between the clients 100 and the constant connection servers 200, as in First Embodiment.

The following describes the specific configuration of the network system 1B for realizing the foregoing functions.

### <Hardware Configuration of Client 100>

The hardware configuration of the client 100 is as described in First Embodiment, and will not be described.

### <Hardware Configuration of Constant Connection Server 200>

The hardware configuration of the constant connection server 200 is as described in First Embodiment, and will not be described.

### <Hardware Configuration of Application Server 300>

The hardware configuration of the application server 300 is as described in First Embodiment, and will not be described.

### <Association DB>

The hardware configuration of the association DB is as described in First Embodiment, and will not be described.

### <Hardware Configuration of Load Balancing Server 400>

The hardware configuration of the load balancing server 400 is as described in First Embodiment, and will not be described.

### <Hardware Configuration of Load Balancing Server 600>

The following describes an aspect of the hardware configuration of the load balancing server 600. FIG. 11 is a block diagram representing the hardware configuration of the load balancing server 600 according to the present embodiment.

Referring to FIG. 11, the main constituting elements of the load balancing server 600 include a CPU 610, a memory 620, an input/output unit 630, and a communication interface 660. The hardware configuration of the load balancing server 600 differs from that of the constant connection server 200 in the operation of the CPU 610, and the data stored in the memory 620. Accordingly, the following describes the operation of the CPU 610, and the data stored in the memory 620, and does not describe other hardware configuration.

The CPU 610 controls each part of the load balancing server 600 by running programs stored in the memory 620 or in external storage media. Specifically, the CPU 610 executes the programs stored in the memory 620, and allocates the received data from the client 100 and other devices to the constant connection servers 200 and the application servers 300 over the HTTP protocol.

The memory 620 stores programs run by the CPU 610, data generated after the execution of a program by the CPU 610, input data via the input/output unit 630, and a node list storing the information of operating constant connection servers 200 obtained from the association DB 500.

### <Functional Configuration of Network System 1B>

The overall functional configuration of the network system 1B according to the present embodiment is described below. FIG. 12 is a block diagram representing the overall functional configuration of the network system 1B according to the present embodiment. The client 100, the constant connection servers 200, the application servers 300, and the load balancing server 400 of the present embodiment have the same functions as those described in First Embodiment. Accordingly, the following deals with only the additional functions not provided in First Embodiment.

Referring to FIG. 12, the client API 112 opens a constant connection with the constant connection server 200A or 200B by requesting the constant connection server 200A or 200B for a node list via the load balancing server 600, using the communication interface 160.

The WS server cores 212A and 212B of the constant connection servers 200A and 200B obtain a list (node list) of the addresses of the constant connection servers 200 from the association DB 500, either beforehand or upon receiving the node list request. Upon receiving the node list request, the WS server cores 212A and 212B send the node list to the client 100.

Alternatively, the WS server cores 212A and 212B send the list of the addresses of the constant connection servers 200 stored in the memory 220 to the client 100 as a node list upon receiving the node list request.

Alternatively, the WS server cores 212A and 212B send connection check data (ping) to the constant connection servers 200A and 200B, and uses the response to create a node list containing the addresses of only the operating constant connection servers 200 from the response, either beforehand or upon receiving the node list request. Upon receiving the node list request, the WS server cores 212A and 212B send the node list to the client 100.

Alternatively, the WS server cores 212A and 212B send connection check data (ping) to the constant connection servers 200, and obtain as a response the current loads of the constant connection servers 200, and/or the number of clients 100 currently connected to the constant connection servers 200, either beforehand or upon receiving the node list request. For the operating constant connection servers 200, the WS server cores 212A and 212B create a list (node list) storing the current loads of the constant connection servers 200, and/or the number of clients 100 currently connected to the constant connection servers 200. Alternatively, for the preregistered constant connection servers 200, the WS server cores 212A and 212B create a list (node list) storing the current loads of the constant connection servers 200, and/or the number of clients 100 currently connected to the constant connection servers 200. The WS server cores 212A and 212B send the node list to the client 100 upon receiving the node list request.

Alternatively, the WS server cores 212A and 212B create a list (node list) based on the loads of constant connection servers 200, in which the constant connection servers 200 are sorted in order of increasing loads. The list is created either beforehand or upon receiving the node list request. Upon receiving the node list request, the WS server cores 212A and 212B send the node list to the client 100.

Alternatively, the WS server cores 212A and 212B create a list (node list) based on the number of clients 100 currently connected to the constant connection servers 200, in which the constant connection servers 200 are sorted in order of increasing numbers of connected clients. The list is created either beforehand or upon receiving the node list request. Upon receiving the node list request, the WS server cores 212A and 212B send the node list to the client 100.

When sending the node list to the client 100, the WS server cores 212A and 212B may store (update) the node list in the association DB 500 for future reference by other constant connection servers 200.

The client API 112 connects itself to any of the operating constant connection servers 200 stored in the node list.

When more than one constant connection server is reconnectable, the client API 112, for example, selects the first constant connection server 200 from the sorted constant connection servers 200 in the node list. Alternatively, the client API 112 selects the least loaded constant connection server 200. Alternatively, the client API 112 selects the constant connection server 200 connected to the least number of clients 100. Alternatively, the client API 112 randomly selects a constant connection server 200. The client API 112 opens a constant connection with the selected constant connection server 200.

<Data Exchange between Devices Concerning Constant Connection>

The following is a brief overview of the data exchange between devices concerning the constant connection in the network system 1B according to the present embodiment. The data exchange between devices concerning constant connection according to the present embodiment differs from that of First Embodiment only in the operation of reconnecting the client 100 to the constant connection server 200. Other operations are the same as in First Embodiment, and will not be described.

The client API 112 of the client 100 opens a constant connection by requesting either of the constant connection servers 200 for a node list via the load balancing server 600. The client API 112 refers to the node list, and selects a constant connection server 200 for a constant connection.

Referring to FIG. 7, the client API 112 requests the application server 300 for authentication information over the HTTP protocol via the communication interface 160 (step S002). Here, the client API 112 sends the application server 300 a client ID used for authentication, and information for specifying the selected constant connection server 200. The server API 312 of the application server 300 responds to the request by sending authentication information over the HTTP protocol via the communication interface 360 (step S004).

The server API 312 sends authentication information also to the selected constant connection server 200 via the communication interface 360 (step S006). The WS server core 212 of the constant connection server 200 stores the authentication information sent from the application server 300 (step S008). The subsequent operations (step S010 to step S046) are the same as in First Embodiment, and will not be described.

In the present embodiment, the client API 112 re-requests the constant connection server 200 for the current node list via the load balancing server 600 when the constant connection communications with the constant connection server 200 fail. The client API 112 refers to the current node list, and selects a constant connection server 200 for a constant connection. The client API 112 repeats the procedures from step S002.

In this manner, in the network system 1B according to the present embodiment, the application server can push information to the client even when the client fails to communicate with the constant connection server. The load balancing server 400 can balance the load between the constant connection servers 200, even though the system involves constant connections between the clients 100 and the constant connection servers 200.

### Third Embodiment

The foregoing Second Embodiment described the network system 1B that include two load balancing servers 400 and 600, and the WS connection balancing function 211.

The network system according to Third Embodiment may be configured to include only the load balancing server 600, without including the load balancing server 400 and the WS connection balancing function 211 (a part of First Embodiment). Specifically, the system may be configured so that the client 100 constantly connects to the constant connection server 200B when the client 100 fails to communicate with the constant connection server 200A.

### Fourth Embodiment

In the foregoing First and Second Embodiments, the load balancing server 400 checks the loads of the constant connection servers 200A and 200B, and/or the number of clients 100 currently connected to the constant connection servers 200A and 200B upon receiving data from either of the application servers 300A and 300B.

However, the load balancing server 400 of Fourth Embodiment may check the loads of the constant connection servers 200A and 200B on a regular basis. Alternatively, the load balancing server 400 may allocate data to the constant connection servers 200A and 200B in a round-robin format by allocating a process request in turn to a plurality of systems of similar configurations.

### Fifth Embodiment

In the foregoing First and Second Embodiments, the association between the connection ID, the information for specifying the constant connection server 200, and the information for specifying the application service is stored in the association DB 500 external to the constant connection server 200. The constant connection server 200 refers to the association DB 500, and selects a different constant connection server 200 when forwarding data to a different constant connection server 200.

In Fifth Embodiment, the association between the connection ID, the information for specifying the constant connection server 200, and the information for specifying the application service may be stored in the memory 220 of the constant connection server 200 itself. The association may then be exchanged between the constant connection servers 200.

### Sixth Embodiment

In the foregoing Second Embodiment, either of the constant connection servers 200 sends a node list storing the addresses of the operating constant connection servers 200 to the client 100. The client 100 then selects a constant connection server 200 for a constant connection, using the node list.

However, in Sixth Embodiment, either of the constant connection servers 200 may select a constant connection server 200 (for example, a constant connection server 200 currently under a small load) for a constant connection with the client 100, using a node list storing the addresses of constant connection servers 200. In this case, either of the constant connection servers 200 sends information for specifying the selected constant connection server 200 to the client 100. The client 100 then opens a constant connection with the constant connection server 200 designated by either constant connection server 200.

### Seventh Embodiment

In the foregoing Second Embodiment, the constant connection server 200 sends connection check data (ping) to the constant connection servers 200, and updates the node list according to the response, either beforehand or upon receiving a node list request.

However, the computer of the association DB 500 may send connection check data (ping) to the constant connection servers 200, and update the node list according to the response, either beforehand or upon receiving a node list request. In this case, the node list may be sorted by the constant connection server 200, or by the computer of the association DB 500.

### Eighth Embodiment

### Overall Configuration of Network System

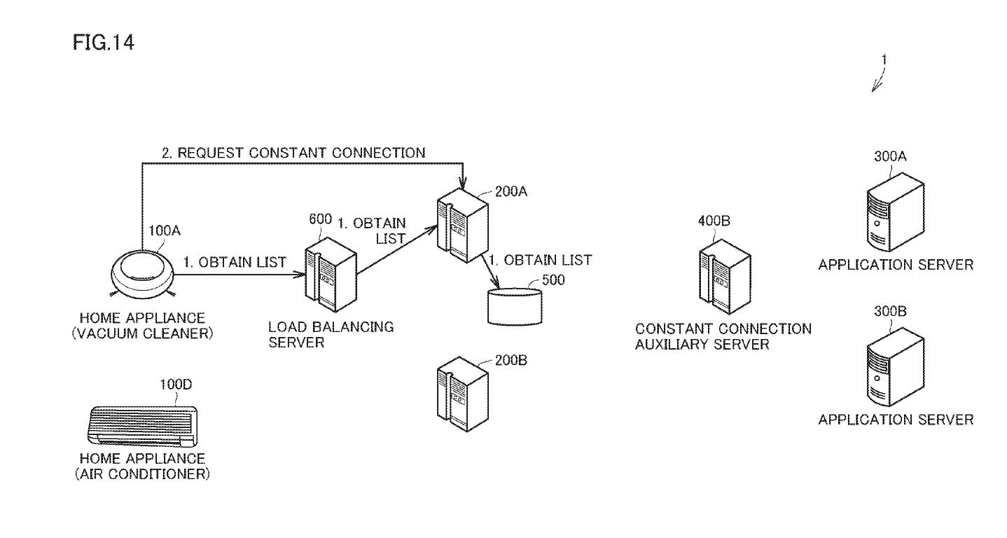

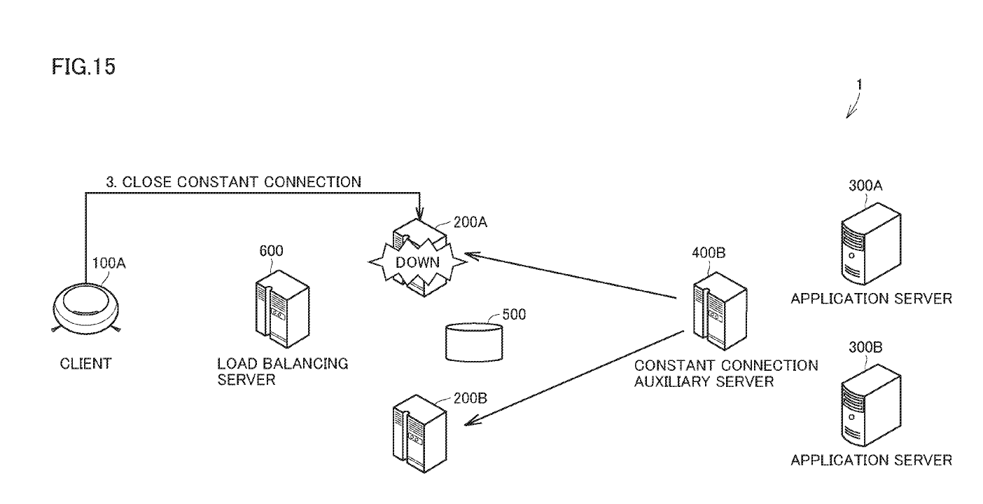

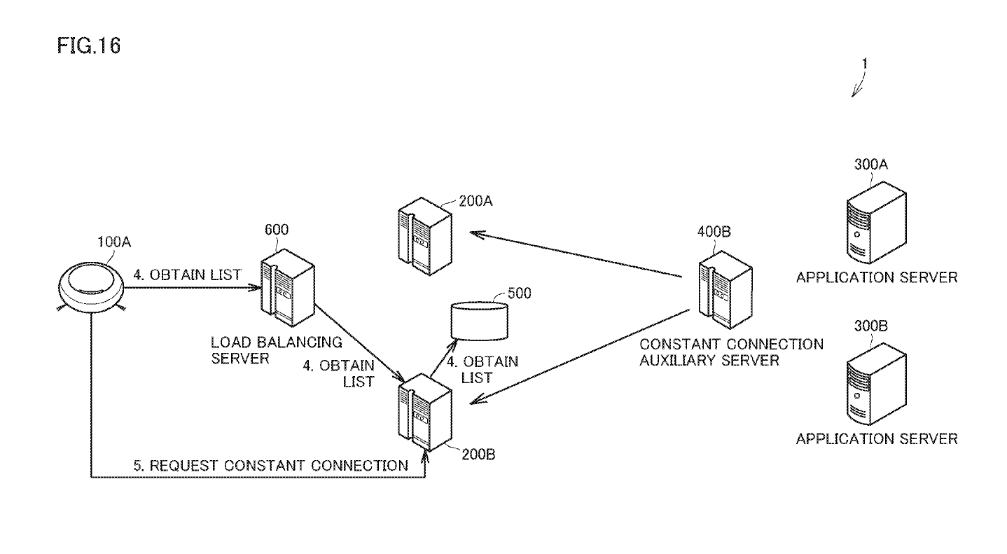

The overall configuration of the network system 1 according to the present embodiment is described first. FIG. 14 is a first schematic diagram representing the overall configuration and operation of the network system 1 according to the present embodiment. FIG. 15 is a second schematic diagram representing the overall configuration and operation of the network system 1 according to the present embodiment. FIG. 16 is a third schematic diagram representing the overall configuration and operation of the network system 1 according to the present embodiment.

Referring to FIG. 14, the network system 1 assumes a system that operates home appliances from a remote location, and includes a plurality of home appliances 100A and 100D disposed in locations such as homes and offices, constant connection servers 200A and 200B connected to the home appliances 100A and 100D via a network, a plurality of application servers 300A and 300B that provide various services concerning the home appliances 100A and 100D, a constant connection auxiliary server 400B for sending data from the application servers 300A and 300B to whichever of the constant connection servers 200A and 200B is more appropriate, and a load balancing server 600 for balancing the load between the constant connection servers 200A and 200B.

In the following, descriptions will be given through the case where two constant connection servers 200A and 200B are provided. However, only one constant connection server, or three or more constant connection servers may be provided. Similarly, only one application server, or three or more application servers may be provided. Only one home appliance, or three or more home appliances may be provided. Two or more load balancers, and two or more constant connection auxiliary servers may be provided.

Examples of the home appliances include a vacuum cleaner 100A, an air conditioner 100D, a television, a washing machine, a refrigerator, a rice cooker, an air purifier, a floor heating system, and an IH (Induction Heating) cooking heater. The home appliances may be any communications devices for homes and offices, including, for example, personal computers, audio-video equipment other than television, and an intercom system. The constant connection servers 200A and 200B, the application servers 300A and 300B, the constant connection auxiliary server 400B, and the load balancing server 600 may include servers that reside in the same home, office, building, company, or school where the home appliances are provided, or virtual servers that reside in these physical servers.

The home appliances and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, the vacuum cleaner 100A and the air conditioner 100D become constantly connected to the constant connection server 200A or 200B. This enables the application server 300A for vacuum cleaner, and the application server 300B for air conditioner to push data to the vacuum cleaner 100A and the air conditioner 100D at any timing via the constant connection servers 200A and 200B.

Specifically, in the network system 1 according to the present embodiment, it is not required to directly establish a constant connection between each home appliance and all the relevant application servers providing services to the home appliances. Conversely, there is no need for each application server to directly establish a constant connection with all the associated home appliances.

### <Brief Overview of Network System Operation>

The following is a brief overview of the operation of the network system 1 according to the present embodiment. In the following, the home appliances, including the vacuum cleaner 100A and the air conditioner 100D will also be collectively called clients 100 for simplicity. For the same purpose, the constant connection server 200A representing node 1, and the constant connection server 200B representing node 2 will also be collectively referred to as constant connection servers 200. Likewise, the term “application server 300” will also be used as a collective term for application servers, including the application server 300A for vacuum cleaner, and the application server 300B for air conditioner, that provide various services to clients 100 and users.

Referring to FIG. 14, the vacuum cleaner 100A opens a constant connection with either of the constant connection servers 200A and 200B by requesting either of the operating constant connection servers 200 for a node list storing the addresses of the constant connection servers 200. The request is sent via the load balancing server 600 over the HTTP protocol. Examples of the node list will be described later.

By using the node list, the vacuum cleaner 100A opens a constant connection with the constant connection server 200A (node 1) over the WebSocket protocol.

In the present embodiment, the load balancing server 600 requests the constant connection server 200A for a node list upon receiving a node list request from the vacuum cleaner 100A. When there is no response from the constant connection server 200A, the load balancing server 600 requests the other constant connection server 200B for a node list.

More specifically, in the present embodiment, the constant connection servers 200A and 200B upon receiving a node list request from the client 100 obtains a node list from the association DB 500. Upon receiving a request from the load balancing server 600, the association DB 500 forwards the request to either of the constant connection servers 200A and 200B.

For example, the constant connection server 200A upon receiving a request from the client 100 sends connection check data (for example, ICMP ping) to the other constant connection server 200B. When there is a response from the constant connection server 200B, the constant connection server 200A assumes that the constant connection server 200B is operating, and requests the association DB 500 to update the node list by adding the constant connection server 200B to the list. When there is no response from the constant connection server 200B, the constant connection server 200A assumes that the constant connection server 200B is not operating, and requests the association DB 500 to update the node list by deleting the constant connection server 200B from the list. The constant connection server 200A then obtains the whole new node list from the association DB 500, and sends it to the client 100.

In this manner, the application server 300A for vacuum cleaner can push data to the vacuum cleaner 100A via the constant connection server 200A.

In the same manner, the air conditioner 100D constantly connects to the constant connection server 200A or 200B over the WebSocket protocol. Specifically, the application server 300B for air conditioner also can push data to the air conditioner 100D via the constant connection server 200A or 200B.

In the present embodiment, the constant connection auxiliary server 400B is installed between the constant connection servers 200A and 200B and the application servers 300A and 300B. upon receiving data destined to a client 100 from the application servers 300A and 300B, the constant connection auxiliary server 400B specifies whether the client 100 is connected to which of the constant connection servers 200A and 200B.

For example, the constant connection auxiliary server 400B determines whether the vacuum cleaner 100A is connected to which of the constant connection servers 200A and 200B upon receiving data destined to the vacuum cleaner 100A from either of the application servers 300A and 300B. The constant connection auxiliary server 400B then sends the data to the constant connection server 200A connected to the vacuum cleaner 100A.

In other words, in the present embodiment, the connection auxiliary server 400B upon receiving data from either of the application servers 300A and 300B determines whether the data is intended for the home appliance that is in a constant connection with the constant connection server 200A. When the data is intended for the home appliance (for example, vacuum cleaner 100A) that is in a constant connection with the constant connection server 200A, the constant connection auxiliary server 400B sends the data to the constant connection server 200A. The constant connection server 200A sends the data to the vacuum cleaner 100A over the WebSocket protocol.

On the other hand, when the data is not intended for the home appliance that is in a constant connection with the constant connection server 200A, the constant connection auxiliary server 400B specifies the constant connection server 200B that is in a constant connection with the home appliance (for example, air conditioner 100D) for which the data is intended. The constant connection auxiliary server 400B forwards the data to the constant connection server 200B that is in a constant connection with the air conditioner 100B designated as a receiving device. The constant connection server 200B sends the data to the air conditioner 100B over the WebSocket protocol.

Referring to FIG. 15, there are cases where a malfunction occurs in the constant connection server 200A that is in a constant connection with the vacuum cleaner 100A. Specifically, the vacuum cleaner 100A may fail to communicate with the constant connection server 200A over a constant connection when the operation of the constant connection server 200A is suspended for maintenance, or when the constant connection server 200A is shut down due to accidental errors.

In such cases, referring to FIG. 16, the vacuum cleaner 100A opens a constant connection with a different constant connection server 200 by requesting either of the constant connection servers 200 for a node list storing the addresses of operating constant connection servers 200. Here, the request is sent via the load balancing server 600 over the HTTP protocol. For example, by using the node list, the vacuum cleaner 100A performs the process of opening a constant connection with the operating constant connection server 200B (node 2) over the WebSocket protocol.

The vacuum cleaner 100A is not the only device that may experience a connection failure, and other clients 100 that lost the constant connections with the constant connection server 200A upon server failure may rush to have access to the load balancing server 600 or the constant connection server 200B at the same time. In order to avoid such situations, the network system 1 according to the present embodiment is configured so that the clients 100 that lost the constant connections with the constant connection server 200A upon server failure are unlikely to access the load balancing server 600 or the other constant connection servers 200 at the same time upon experiencing a connection failure.

Specifically, in the present embodiment, the clients 100 that lost the constant connections with the constant connection server 200A upon server failure request either of the constant connection servers 200A and 200B for a node list via the load balancing server 600 at different timings, and perform the process of making a constant connection with the constant connection server 200 at different timings. FIG. 17 is a schematic diagram representing the timings of the client accessing the load balancing server 600.

Referring to FIG. 17, the constant connection server 200 in the present embodiment provides the client 100 with a reconnection interval T (seconds) when delivering a node list. The client 100 randomly determines a waiting time within the reconnection interval T (seconds) that ranges from 1 to T seconds. The waiting time may be determined by the constant connection server 200 as in Tenth Embodiment to be described later. The constant connection server 200 may send a waiting time to the client 100.

The client 100 waits for the waiting time based on the reconnection interval provided by the constant connection server 200, and requests the constant connection server 200 for a node list via the load balancing server 600. When the node list was not obtained properly, the client 100 waits for the reconnection interval provided by the constant connection server 200, and re-requests the constant connection server 200 for a node list via the load balancing server 600. The client 100 repeats the waiting and list requesting procedure until the node list is properly obtained.

The client 100 selects the constant connection server 200A from the node list obtained. The client 100 then executes the process of opening a constant connection with the selected constant connection server 200A. When failed to connect to the constant connection server 200A, the client 100 waits for the reconnection interval provided by either of the constant connection servers 200, and executes the process of opening a constant connection with the other constant connection server 200B contained in the node list. The client 100 repeats the waiting and constant connection opening procedure until it successfully connects to either constant connection server 200.

In this manner, in the network system 1 according to the present embodiment, the clients 100 disconnected from the constant connection with the constant connection server 200 starts the reconnection process after waiting for the waiting time. This makes it possible to prevent the clients 100 from rushing to have access to the load balancing server 600 or the constant connection servers 200 at the same time. The reconnection process between the client 100 and the constant connection server 200 thus smoothly proceeds, and the constant connection state quickly recovers.

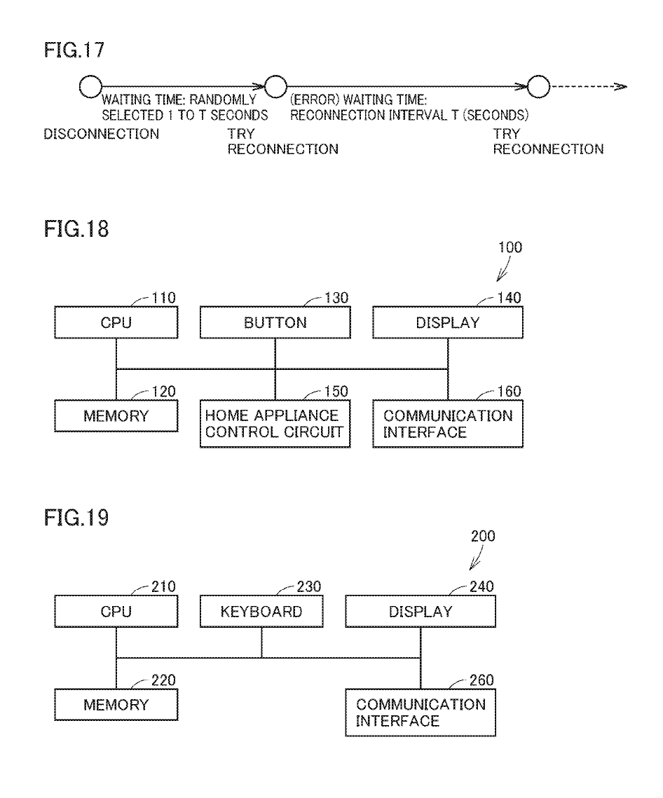

The following describes the specific configuration of the network system 1 for realizing the foregoing functions.

<Hardware Configuration of Client 100>The following describes an aspect of the hardware configuration of the client 100. FIG. 18 is a block diagram representing the hardware configuration of the client 100 according to the present embodiment.

Referring to FIG. 18, the main constituting elements of the client 100 include a CPU 110, a memory 120, a button 130, a display 140, a home appliance control circuit 150, and a communication interface 160.

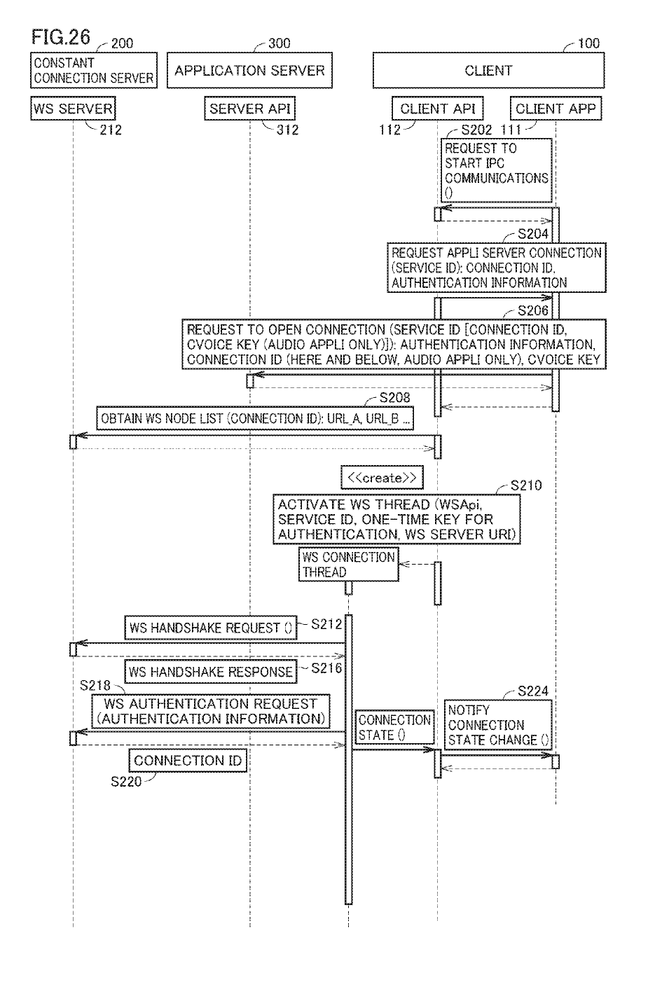

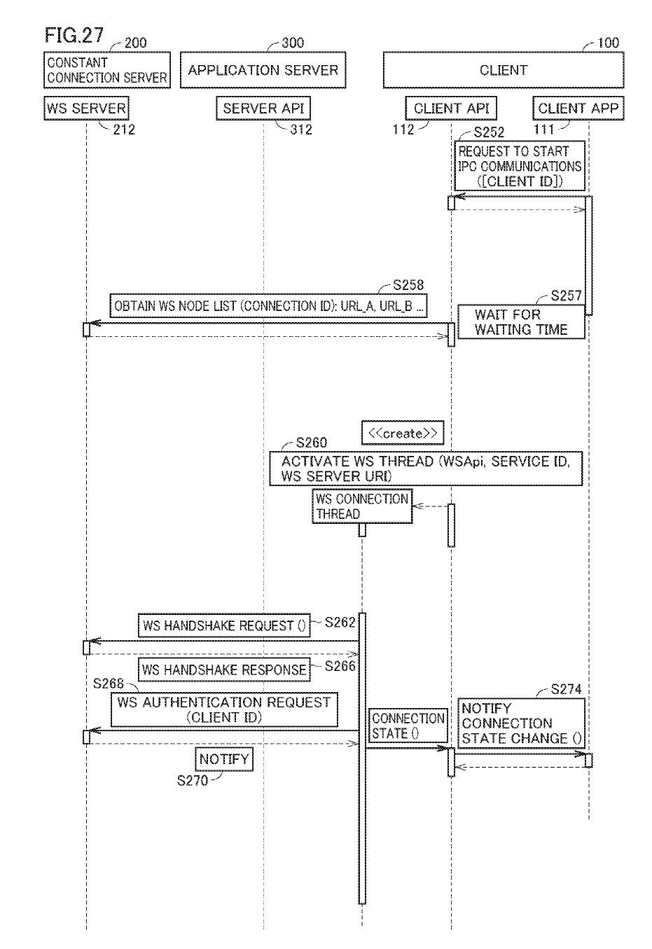

The CPU 110 controls each part of the client 100 by running programs stored in the memory 120 or in external storage media (not shown). Specifically, the CPU 110 executes the programs stored in the memory 120, and operates as a client APP 111 (see FIGS. 26 and 27; described later) and a client API 112 (see FIGS. 12, 23, 26, and 27; described later). More specifically, the client APP 111 is a program that controls each part of the client 100, or a terminal application program as it is also called. The client API 112 communicates over the HTTP protocol, or over the WebSocket protocol on the HTTP protocol, via the communication interface (described later).

Examples of the memory 120 are as described in First Embodiment, and will not be described.

The memory 120 stores programs run by the CPU 110, data generated after the execution of a program by the CPU 110, input data via the button 130, APP data operating as a client such as a vacuum cleaner and an air conditioner, and API data for communicating with the constant connection server 200 while exchanging data with the server APP. Specifically, the memory 120 stores information such as the connected device of the constant connection server, the connected device of the application server, service identification code, service authentication token, connection ID, and client identification ID.

The button 130 receives a user instruction, and enters the instruction to the CPU 110.

The display 140 is realized by, for example, a liquid crystal panel, and outputs characters and images by using signals from the CPU 110.

The home appliance control circuit 150 controls each part (such as a motor) of the client (home appliance) by using signals from the CPU 110.

Examples of the communication interface 160 are as described in First Embodiment, and will not be described. The CPU 110 receives programs, control instructions, image data, text data, and other such information from other devices, and sends information such as text data and image data to other devices via the communication interface 160.

### <Hardware Configuration of Constant Connection Server 200>

The following describes an aspect of the hardware configuration of the constant connection server 200. FIG. 19 is a block diagram representing the hardware configuration of the constant connection server 200 according to the present embodiment. The constant connection server 200 can normally use apache, tomcat, mysql, and other such functions available to common server modules.

Referring to FIG. 19, the main constituting elements of the constant connection server 200 include a CPU 210, a memory 220, a keyboard 230, a display 240, and a communication interface 260. The hardware configuration of the constant connection server 200 differs from that of the client 100 in that the button 130 is replaced by the keyboard 230, and that the home appliance control circuit 150 for controlling each part of the home appliances is not provided. Other differences are the operation of the CPU 210, and the data stored in the memory 220. Accordingly, the following describes the operation of the CPU 210, and the data stored in the memory 220, and does not describe other hardware configuration.

The CPU 210 controls each part of the constant connection server 200 by running programs stored in the memory 220 or in external storage media. Specifically, the CPU 210 runs the programs stored in the memory 220, and operates as WS servers 212, 212A, and 212B (see FIGS. 12, 23, 26, and 27; described later). The WS server 212 refers to a constant connection server in the form of software, and controls the constant connection communications with the client 100 over the WebSocket protocol, or the communications with the constant connection auxiliary server 400B or a plurality of application servers 300 over the HTTP protocol.

The memory 220 stores information such as programs run by the CPU 210, data generated after the execution of a program by the CPU 210, input data via the keyboard 230, service ID, service name, the URL of the connected device of the application server 300, service authentication token generating information, authentication information (one-time key), and connection ID.

### <Hardware Configuration of Application Server 300>

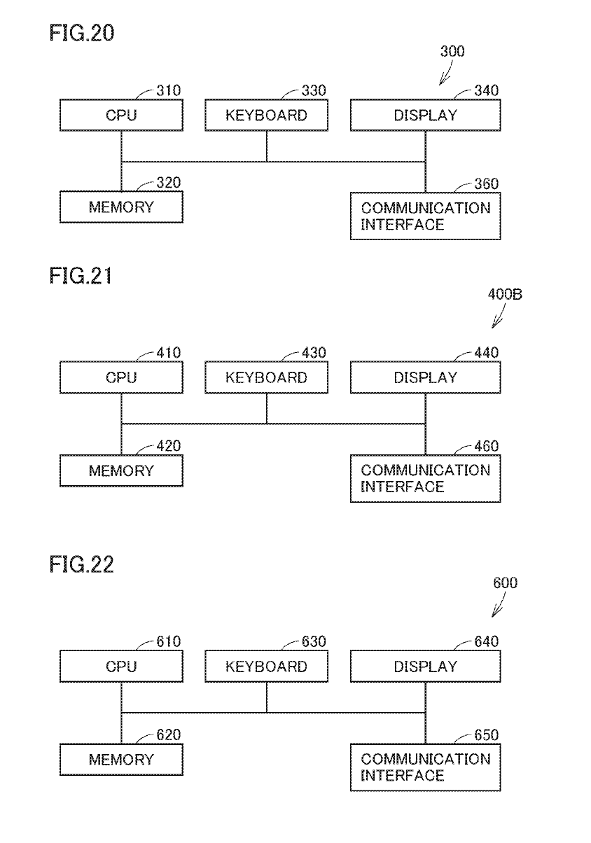

The following describes an aspect of the hardware configuration of the application server 300. FIG. 20 is a block diagram representing the hardware configuration of the application server 300 according to the present embodiment. The application server 300 can normally use apache, tomcat, mysql, and other such functions available to common server modules.

Referring to FIG. 20, the main constituting elements of the application server 300 include a CPU 310, a memory 320, a keyboard 330, a display 340, and a communication interface 360. The hardware configuration of the application server 300 differs from that of the constant connection server 200 in the operation of the CPU 310, and the data stored in the memory 320. Accordingly, the following describes the operation of the CPU 310, and the data stored in the memory 320, and does not describe other hardware configuration.

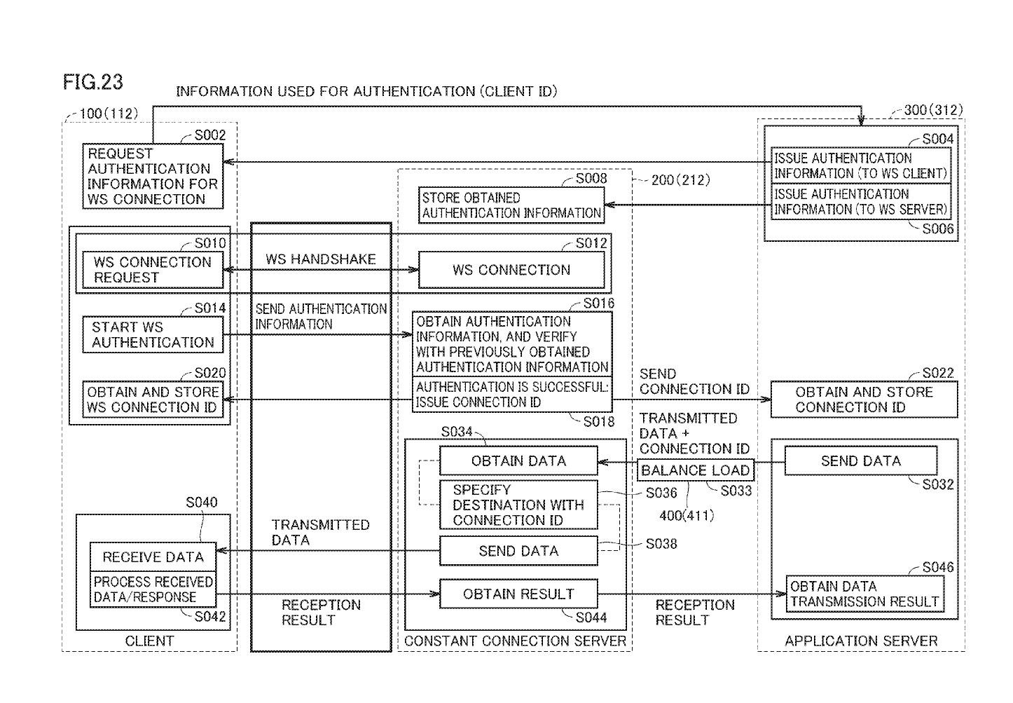

The CPU 310 controls each part of the application server 300 by running programs stored in the memory 320 or in external storage media. Specifically, the CPU 310 runs the programs stored in the memory 320, and operates as a server APP and a server API 312 (see FIGS. 23, 26, and 27; described later).

The server APP refers to an application server in the form of software, and provides services to devices such as the clients 100 and smartphones. The server API 312 controls the communications with the constant connection auxiliary server 400B or the constant connection server 200 over the HTTP protocol.

The memory 320 stores programs run by the CPU 310, data generated after the execution of a program by the CPU 310, input data via the keyboard 330, APP data operating as the application server 300, and API data for communicating with the constant connection server 200 while exchanging data with the server APP. Specifically, the memory 320 stores information such as the URL of the constant connection server, service ID, service authentication token, authentication information (one-time key) generating information, connection ID, and temporary flag information indicative of the execution of a standby subroutine (described later).

### <Association DB>

The association DB 500 used in the network system 1 according to the present embodiment is described below. The association DB 500 is the same as the association DB 500 of First Embodiment, and will not be described further. The association DB 500 can be referred to by the application servers 300, the constant connection auxiliary server 400B, and the constant connection servers 200 provided in the network system 1 according to the present embodiment.

### <Hardware Configuration of Constant Connection Auxiliary Server 400B>

The following describes an aspect of the hardware configuration of the constant connection auxiliary server 400B. FIG. 21 is a block diagram representing the hardware configuration of the constant connection auxiliary server 400B according to the present embodiment.

Referring to FIG. 21, the main constituting elements of the constant connection auxiliary server 400B include a CPU 410, a memory 420, a keyboard 430, a display 440, and a communication interface 460. The hardware configuration of the constant connection auxiliary server 400B differs from that of the constant connection server 200 in the operation of the CPU 410, and the data stored in the memory 420. Accordingly, the following describes the operation of the CPU 410, and the data stored in the memory 420, and does not describe other hardware configuration.

The CPU 410 controls each part of the constant connection auxiliary server 400B by running programs stored in the memory 420 or in external storage media. Specifically, the CPU 410 runs the programs stored in the memory 420, and operates as a constant connection auxiliary function 411 (see FIG. 12). The constant connection auxiliary function 411 refers to the association DB 500, and specifies that the client 100 to which the data from the application server 300 is destined is in a constant connection with which of the constant connection servers 200. The constant connection auxiliary function 411 forwards the data from the application server 300 to the specified constant connection server 200 via the communication interface 460.

The memory 320 stores programs run by the CPU 410, data generated after the execution of a program by the CPU 410, and input data via the keyboard 430.

### <Hardware Configuration of Load Balancing Server 600>

The following describes an aspect of the hardware configuration of the load balancing server 600. FIG. 22 is a block diagram representing the hardware configuration of the load balancing server 600 according to the present embodiment.

Referring to FIG. 22, the main constituting elements of the load balancing server 600 include a CPU 610, a memory 620, a keyboard 630, a display 640, and a communication interface 660. The hardware configuration of the load balancing server 600 differs from that of the constant connection server 200 in the operation of the CPU 610, and the data stored in the memory 620. Accordingly, the following describes the operation of the CPU 610, and the data stored in the memory 620, and does not describe other hardware configuration.

The CPU 610 controls each part of the load balancing server 600 by running programs stored in the memory 620 or in external storage media. Specifically, the CPU 610 executes the programs stored in the memory 620, and allocates the received data from the client 100 and other devices to the constant connection servers 200 over the HTTP protocol.

The memory 620 stores programs run by the CPU 610, data generated after the execution of a program by the CPU 610, and input data via the keyboard 630. The data stored in the memory 620 include the load conditions collected from the constant connection servers 200.

### <Functional Configuration of Network System 1>

The overall functional configuration of the network system 1 according to the present embodiment is described below.

Referring to FIG. 12, the client 100 is in a constant connection with the constant connection server 200A (node 1) over the WebSocket protocol. Other clients 100 are also in constant connections with the constant connection server 200A (node 1) over the WebSocket protocol. Other clients 100 are in constant connections with the constant connection server 200B (node 2) over the WebSocket protocol. The clients 100 may communicate with the constant connection servers 200A and 200B via the application servers 300A and 300B and the load balancing server 600 over the HTTP protocol.

More specifically, the client API 112 opens a constant connection with either of the constant connection servers 200 by requesting the load balancing server 600 for a node list via the communication interface 160 over the HTTP protocol. In the present embodiment, the client API 112 requests the constant connection server 200 for a node list via the load balancing server 600 over the HTTP protocol.

Specifically, in response to the request from the client 100, the load balancing server 600 forwards the request for the current node list to the constant connection server 200A or 200B.

The client API 112 selects the first constant connection server 200 listed in the received node list. Alternatively, the client API 112 randomly selects a constant connection server 200 from the node list. Alternatively, the client API 112 selects a constant connection server 200 that has fewer loads or that is connected to fewer clients, when the node list contains the load of each constant connection server 200, or the number of connected clients.

The client API 112 opens a constant connection with the selected constant connection server 200 via the communication interface 160.

The WS servers 212A and 212B of the constant connection servers 200A and 200B are realized by the CPU 210, and serve as WebSocket servers that constantly connect to the clients 100 via the communication interface 260 over the WebSocket protocol. The WS servers 212A and 212B also serve as HTTP servers that perform data communications with other devices such as other constant connection servers 200, the application servers 300, and the load balancing server 600 via the communication interface 260 over the HTTP protocol.

In response to the request from the load balancing server 600, the WS servers 212A and 212B of the constant connection servers 200A and 200B request the association DB 500 for the current node list, using the communication interface 260. In response to the request from the constant connection server 200A or 200B, the association DB 500 updates the node list by checking the constant connection servers 200A and 200B for connections.

In the present embodiment, for example, the data sent from the constant connection server 200 to the client 100 contain the following information, including a node list.

{″status″: 0, ″reConInterval″: 600,
″handshakeUr1″: [″ws: / /example01.com: 18080/cpush-server/echo″,
″ws: / /example02.com: 18080/cpush-server/echo″]}

Here, “reConInterval”:600 means that the reconnection interval is 600 seconds. The line “handshakeUr1”:[“ws://example01.com:18080/cpush-server/ech o”,“ws://example02.com:18080/cpush-server/echo”] indicates a node list that contains the addresses of a plurality of constant connection servers.

In the constant connection server 200 according to the present embodiment, the WS server 212 regularly obtains the following information from the data stored in the association DB 500, specifically the total number of clients 100 connected to the constant connection servers 200, the number of allowable reconnections per second for a single constant connection server 200, and the number of operating constant connection servers 200. The WS server 212 then calculates the reconnection interval T (seconds) according to the following equation (1).

(Reconnection interval)=(Number of connected clients+α)÷(Number of allowable reconnections per second)÷(Number of operating constant connection servers) Equation (1)

The WS server 212 delivers the reconnection interval to the client 100 constantly connected to the constant connection server 200. The reconnection interval is delivered via the communication interface 260 in response to a node list request from the client 100.

In the present embodiment, the constant connection server 200 sends the reconnection interval with the node list. However, the constant connection server 200 is not necessarily required to send the node list and the reconnection interval at the same time. For example, the constant connection server 200 may send only the reconnection interval to the client 100 in advance.

<Data Exchange between Devices Concerning Constant Connection>

The following is a brief overview of the data exchange between devices concerning the constant connection in the network system 1 according to the present embodiment. FIG. 23 is a sequence diagram representing the procedures of the data exchange between devices concerning the constant connection in the network system 1 according to the present embodiment.

The client API 112 opens a constant connection by requesting the constant connection server 200 for a node list via the load balancing server 600, using the communication interface 160. The client API 112 refers to the node list, and selects a constant connection server 200 for a constant connection.

Referring to FIG. 23, the client API 112 requests the application server 300 for authentication information over the HTTP protocol via the communication interface 160 (step S002). Here, the client API 112 sends the application server 300 a client ID used for authentication. The server API 312 of the application server 300 responds to the request by sending authentication information over the HTTP protocol via the communication interface 360 (step S004).

The server API 312 sends authentication information also to the selected constant connection server 200 via the communication interface 360 (step S006). The WS server 212 of the constant connection server 200 stores the authentication information sent from the application server 300 (step S008).

The client 100 and the constant connection server 200 establish a WebSocket constant connection state using the WebSocket protocol (step S010, step S012). Specifically, the client API 112 sends a handshake request to the constant connection server 200 via the communication interface 160. The WS server 212 returns a handshake response via the communication interface 260. This establishes a valid WebSocket constant connection between the client 100 and the constant connection server 200.

The client API 112 sends the authentication information to the constant connection server 200 via the communication interface 160 (step S014). The WS server 212 authenticates the client 100 by using the authentication information from the client 100, and the stored authentication information (step S016). When authentication is successful, the WS server 212 issues a connection ID for the identification of the client 100 by the application server 300, and deletes the stored authentication information. As shown in FIG. 13, the WS server 212 associates the connection ID, the information for specifying the constant connection server 200A, and the information for specifying the application service, and registers the association in the association DB 500 via the communication interface 260 (step S018).

The client 100 receives and stores the connection ID (step S020). The application server 300 receives the connection ID, and stores the connection ID after associating it with the client ID (step S022).

In response to a request from the server APP, the server API 312 sends the main data, and the connection ID associated with the client ID of the receiving client 100 and stored in step S022 to the constant connection server 200 via the communication interface 360 (step S032).

In the present embodiment, the data from the application server 300 is received by the constant connection auxiliary server 400B in step S033. By using the association between connection ID and constant connection server registered in the association DB 500, the client connection node forward function 411 realized by the CPU 410 of the constant connection auxiliary server 400B selects a constant connection server 200 to which the data should be sent. The client connection node forward function 411 sends the data to the selected constant connection server 200 via the communication interface 460.

The constant connection server 200 receives the main data and the connection ID from the constant connection auxiliary server 400B (step S034). The WS server 212 specifies the client 100 by using the connection ID (step S036).

The WS server 212 sends the main data to the specified client 100 via the communication interface 260 over the WebSocket protocol (step S038). The client 100 receives the main data (step S040).

The client 100 sends the reception result to the constant connection server 200 over the WebSocket protocol (step S042). The constant connection server 200 upon receiving the reception result sends the reception result to the application server 300 (step S044). The application server 300 receives the reception result (step S046).

In the present embodiment, when the constant connection communications with the constant connection server 200 fails, the client API 112 waits for a waiting time, and requests the constant connection server 200 for the current node list via the load balancing server 600 over the communication interface 160. When failed to obtain the node list from the constant connection server 200, or when failed to make a WebSocket connection after successfully obtaining the node list, the client API 112 waits for a reconnection interval, and re-requests the load balancing server 600 for the current node list via the communication interface 160. The client API 112 repeats the waiting and list requesting procedure with the constant connection server 200 via the load balancing server 600 until the node list is obtained and a WebSocket connection is successfully made.

Specifically, when the constant connection communications with the constant connection server 200 fails, the client API 112 repeats the procedures from step S002 after a waiting time. The authentication process may be simplified with the use of the previously obtained connection ID, as will be described later in Ninth Embodiment.

### <Reconnection Process in Client 100>

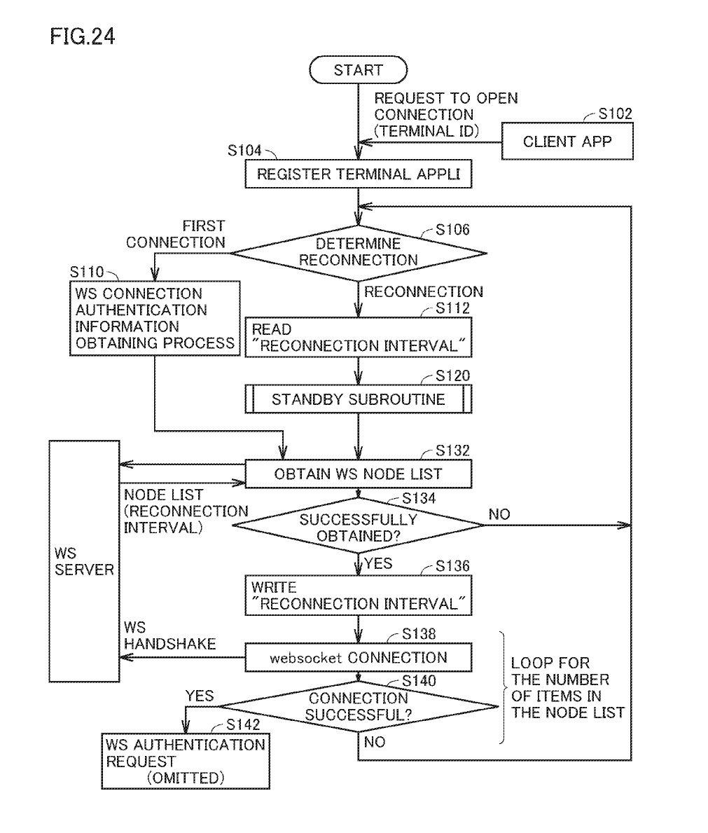

The following describes the procedures of the reconnection process in the client 100 according to the present embodiment. FIG. 24 is a flowchart representing the procedures of the reconnection process in the client 100 according to the present embodiment. Specifically, the following describes the reconnection process with a primary focus on the operation of the client API 112 realized by the execution of programs by the CPU 110 of the client 100.

Referring to FIG. 24, the client API 112 receives a connection opening request from the client APP 111 (step S102). In response to the request, the client API 112 stores the client ID in the memory 120 when the client ID needs to be set to specify the client APP 111 (step S104). The client API 112 determines whether the constant connection process to be performed is a routine new constant connection process (also referred to as “initial connection process”) or a reconnection process necessitated by accidental disconnection (step S106).

For example, the client API 112 distinguishes between an initial connection process and a reconnection process on the basis of whether the data transferred from the client APP 111 has been set as a client ID.

In the present embodiment, an initial connection process is performed when the client API 112 determines that the connection is an initial connection (in other words, not a reconnection; YES in step S106). Specifically, the client API 112 performs a WS connection authentication information obtaining process to obtain authentication information from the application server 300, and performs the process of step S132 and the subsequent processes (5110).

On the other hand, when it is determined by the client API 112 that the connection is a reconnection (in other words, not an initial connection; NO in step S106), the client API 112 performs a reconnection process by reading out a reconnection interval from the memory 120 (step S112).

In this manner, the client 100 in the present embodiment obtains a reconnection interval with a node list when obtaining a node list from the constant connection server 200. However, the client API 112 uses its built-in default value (for example, 600 seconds) as the reconnection interval when the reconnection interval is not obtained.

The client API 112 performs the standby subroutine (step S120; described later). The client API 112 then requests the constant connection server 200 for the node list containing the information of the constant connection servers 200, and the current reconnection interval via the load balancing server 600, using the communication interface 160 (step S132).

When failed to obtain the node list from the constant connection server 200 (NO in step S134), the client API 112 repeats the procedures from step S106. On the other hand, when the node list and the reconnection interval are successfully obtained from the constant connection server 200 (YES in step S134), the client API 112 stores the current reconnection interval in the memory 120 (step S136). Here, the client API 112 turns off the flag indicative of the execution of the standby subroutine (described later).

By using the node list obtained, the client API 112 selects a constant connection server 200 for constant connection. The client API 112 performs the process of opening a constant connection with the selected constant connection server 200 via the communication interface 160 (see step S138, and the process of step S010 and the subsequent processes in FIG. 23).

The client API 112 repeats the foregoing processes for at most the number of the constant connection servers 200 contained in the node list. In the present embodiment, the client API 112 in step S138 attempts a constant connection to a constant connection server 200 for which a constant connection has not been attempted in the node list.

The client API 112 repeats the procedures from step S106 when it fails to constantly connect to all the selected constant connection servers 200 (NO in step S140).

The client API 112 performs the authentication process (see step S142, and the process of step S014 and the subsequent processes in FIG. 23) when a constant connection to the selected constant connection server 200 is successfully made (YES in step S140).

### <Standby Subroutine in Client 100>

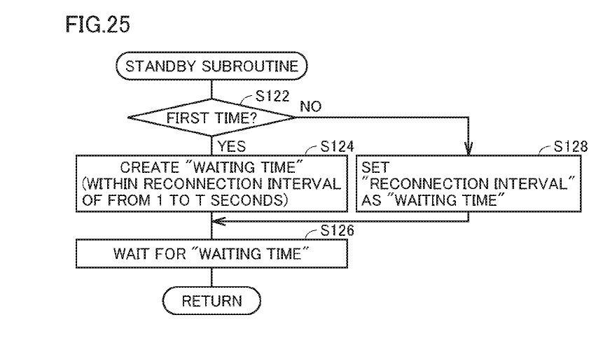

The following describes the procedures of the standby subroutine in the client 100 according to the present embodiment. FIG. 25 is a flowchart representing the procedures of the standby subroutine in the client 100 according to the present embodiment. The following description of the standby subroutine will be given with a primary focus on the operation of the client API 112 realized by the execution of programs by the CPU 110 of the client 100.

Referring to FIG. 25, the client API 112 determines whether the standby subroutine is to be performed for the first time (step S122). For example, the client API 112 checks whether the flag indicative of the execution of the standby subroutine is ON. The standby subroutine is determined as being the first time when the flag is OFF, and having been performed for at least once when the flag is ON.

When the standby subroutine is to be performed for the first time (YES in step S122), the client API 112 turns on the flag indicative of the execution of the standby subroutine. The client API 112 generates a waiting time (step S124). More specifically, the client API 112 randomly sets a waiting time within the reconnection interval of 1 to T seconds. After a waiting time (step S126), the client API 112 returns to the reconnection process from the standby subroutine.

When the standby subroutine has been performed at least once (NO in step S122), the client API 112 sets the reconnection interval as a waiting time (step S128). After a waiting time (step S126), the client API 112 returns to the reconnection process from the standby subroutine.

In this manner, in the network system 1 according to the present embodiment, the clients 100 disconnected from the constant connections with the constant connection servers 200 individually start the reconnection process after a waiting time. Specifically, the clients 100 can be prevented from rushing to have access to the load balancing server 600 or the constant connection servers 200 at the same time. The reconnection process between the client 100 and the constant connection server 200 thus smoothly proceeds, and the constant connection state quickly recovers.

### Ninth Embodiment

The following describes Ninth Embodiment. The network system 1 according to Eighth Embodiment requires reperforming the authentication process for the reconnection process. The present embodiment uses a connection ID to simplify the authentication process.

The overall configuration, and the hardware configuration of each component of the network system 1 according to the present embodiment are the same as those of Eighth Embodiment, and will not be described. The following describes the network system 1 according to the present embodiment with regard to the procedures of the initial connection process and the reconnection process.

### <Procedures of Initial Connection Process>

The procedures of the initial connection process according to the present embodiment are described below. FIG. 26 is a sequence diagram representing the procedures of the initial connection process according to the present embodiment.

Referring to FIG. 26, the client APP 111 transfers to the client API 112 a request for opening a constant connection with the application server 300 (step S202). Here, the client APP 111 transfers the client ID to the client API 112. The client API 112 performs the initial connection process when it does not receive the client ID, as follows.

The client API 112 requests the client APP 111 to connect to the application server 300 (step S204). The client APP 111 requests the application server 300 to open a connection, using the communication interface 160 over the HTTP protocol (step S206). The client APP 111 receives authentication information from the application server 300, and transfers the authentication information to the client API 112.

The client API 112 requests either of the constant connection servers 200 for a node list via the load balancing server 600, using the communication interface 160 (step S208). By using the node list, the client API 112 selects a constant connection server 200 for which a constant connection should be attempted. The client API 112 activates a WS connection thread to perform the process of opening a constant connection with the constant connection server 200 (step S210).

The client API 112 sends a WebSocket handshake request to the constant connection server 200 over the WebSocket protocol, using the communication interface 160 (step S212). The WS server 212 returns a handshake response to the client 100 via the communication interface 260 (step S216). This opens a WebSocket constant connection between the client 100 and the constant connection server 200.

When the handshake with the constant connection server 200 fails, the client API 112 reselects a different constant connection server 200 from the node list, and repeats the procedures from step S212.

The client API 112 sends the authentication information to the constant connection server 200 over the WebSocket protocol, using the communication interface 160 (step S218). The WS server 212 authenticates the client 100 on the basis of the authentication information from the application server 300, and the authentication information from the client 100.

When the authentication is successful, the WS server 212 issues a connection ID. The WS server 212 sends the connection ID of the client 100 (connection establishment status) to the application server 300 and the client 100 via the communication interface 260 (step S220).

The client API 112 notifies the client APP 111 that the constant connection is open (step S224). The client API 112 repeats the procedures from step S204 when the authentication by the constant connection server 200 fails.

### <Procedures of Reconnection Process>

The following describes the procedures of the reconnection process according to the present embodiment. FIG. 27 is a sequence diagram representing the procedures of the reconnection process according to the present embodiment.

Referring to FIG. 27, the client APP 111 transfers to the client API 112 a request for opening a constant connection with the application server 300 (step S252). Here, the client APP 111 transfers the client ID to the client API 112. The client APP 111 performs the reconnection process when it receives the client ID, as follows.

The client API 112 performs the standby subroutine, and waits for a waiting time (step S257). After a waiting time, the client API 112 requests either constant connection server 200 for a node list via the load balancing server 600, using the communication interface 160 (step S258).

When failed to obtain a node list, the client API 112 waits for a reconnection interval, and re-requests either constant connection server 200 for a node list via the load balancing server 600, using the communication interface 160.

The client API 112 upon obtaining a node list stores the reconnection interval contained in the node list, and selects a constant connection server 200 for which a constant connection should be attempted, using a list of nodes contained in the node list. The client API 112 activates a WS connection thread to perform the process of opening a constant connection with the constant connection server 200 (step S260).

The client API 112 sends a handshake request to the constant connection server 200 over the WebSocket protocol, using the communication interface 160 (step S262). The WS server 212 returns a handshake response to the client 100 via the communication interface 260 (step S266). This opens a WebSocket constant connection between the client 100 and the constant connection server 200.

When the handshake with the constant connection server 200 fails, the client API 112 selects a different constant connection server 200 from the node list. The client API 112 then repeats the procedures from step S260.

The client API 112 sends the client ID to the constant connection server 200 over the WebSocket protocol via the communication interface 160 (step S268). The WS server 212 authenticates the client 100 by sending a connection ID to the application server 300.

When the authentication is successful, the WS server 212 notifies the client 100 and the application server 300 that the authentication is successfully made (step S270). The client API 112 notifies the client APP 111 that the constant connection is open (step S274).

When the authentication by the constant connection server 200 fails, the client API 112 repeats the procedures of the initial connection process from step S204 (see FIG. 26).

In this manner, in the network system 1 according to the present embodiment, the clients 100 disconnected from the constant connections with the constant connection servers 200 individually start the reconnection process after a waiting time. Specifically, the clients 100 can be prevented from rushing to have access to the load balancing server 600 or the constant connection servers 200 at the same time. The reconnection process between the client 100 and the constant connection server 200 thus smoothly proceeds, and the constant connection state quickly recovers.

### Tenth Embodiment

In the foregoing Eighth and Ninth Embodiments, the constant connection server 200 calculates the reconnection interval, and the client 100 calculates the waiting time based on the reconnection interval. Specifically, the constant connection server 200 delivers the reconnection interval to the client 100.

In the network system according to Tenth Embodiment, the constant connection server 200 may calculate both the reconnection interval, and the waiting time based on the reconnection interval. Specifically, the constant connection server 200 may deliver the reconnection interval and the waiting time to the client 100.

### Eleventh Embodiment

In the foregoing Eighth to Tenth Embodiments, the client 100 randomly determines the waiting time within the reconnection interval of 1 to T seconds.

In the network system according to Eleventh Embodiment, the waiting time may be determined by either the CPU 210 of the constant connection server 200 or the application server 300 on the basis of the frequency of the data transmission and reception over a constant connection. More specifically, the CPU stores in the association DB 500 the number of data transmissions and receptions (frequency) over the WebSocket protocol per unit time for each combination of client 100 and constant connection server 200 (or server APP). The CPU sets the waiting time in such a manner that the waiting time is shorter for combinations involving higher WebSocket transmission and reception frequencies. For example, the CPU determines the waiting time by calculating the transmission and reception frequency of a client of interest relative to all the clients in the system, and multiplying the relative frequency by the reconnection interval T (seconds).

In this way, the constant connection recovers earlier in combinations of clients 100 and constant connection servers 200 involving more frequent data transmissions and receptions over the constant connection. This reduces the possibility of the application server 300 failing to push information to the client 100, and causing errors when the constant connection is disconnected.

### Twelfth Embodiment

In the foregoing Eighth and Ninth Embodiments, the load balancing server 600 sends the client 100 a node list storing the addresses of operating constant connection servers 200. The client 100 then selects a constant connection server 200 for a constant connection by using the node list.

In Twelfth Embodiment, the constant connection server 200 may select a constant connection server 200 (currently under a small load) for a constant connection with the client 100, by using a node list storing the addresses of operating constant connection servers 200. In this case, the constant connection server 200 sends the client 100 a node list that contains only the selected constant connection server 200. The client 100 then opens a constant connection with the constant connection server 200 designated in the node list.

### Thirteenth Embodiment

In the foregoing Eighth and Ninth Embodiments, the load balancing server 600 requests the constant connection server 200 for a node list upon receiving a node list request from the client 100. The constant connection server 200 sends connection check data (ping) to other constant connection servers 200, and updates the node list in the association DB 500 according to the response. The constant connection server 200 obtains the node list from the association DB 500 in response to the request forwarded from the load balancing server 600.

In Thirteenth Embodiment, the constant connection server 200 regularly sends connection check data (ping) to other constant connection servers 200, and updates the node list in the association DB 500 according to the response. The constant connection server 200 may then obtain a node list from the association DB 500 in response to a request from the load balancing server 600.

### Fourteenth Embodiment

In Fourteenth Embodiment, the constant connection server 200 may alternatively send connection check data (ping) to other constant connection servers 200 on a regular basis, update the node list according to the response, and send the updated current node list to other constant connection servers 200. The constant connection server 200 may then send the previously received node list to the client 100 in response to a request from the client 100.

### Fifteenth Embodiment

In the foregoing embodiments, the client 100 obtains the reconnection interval and the node list from the constant connection server 200 via the load balancing server 600. In Fifteenth Embodiment, the client 100 may obtain the reconnection interval and the node list from the constant connection server 200 via the application server 300 providing services.

Specifically, the client 100 sends a node list request and/or a reconnection interval request to the application server 300 over the HTTP protocol when the constant connection with the constant connection server 200 is disconnected. The application server 300 requests any of the constant connection servers 200 or the association DB 500 for a node list and/or a reconnection interval. The constant connection server 200 or the association DB 500 returns a node list and/or a reconnection interval to the application server 300. The application server 300 sends the node list and/or the reconnection interval to the client 100 over the HTTP protocol.

### Sixteenth Embodiment

In the foregoing embodiments, the client 100 starts the process of reconnecting to the constant connection server 200 after a waiting time when the constant connection with the constant connection server 200 is disconnected. In Sixteenth Embodiment, the client 100 upon being disconnected from the constant connection with the constant connection server 200 may start the process of reconnecting to the constant connection server 200 after a waiting time only when predetermined conditions are satisfied, and may immediately start the process of reconnecting to the constant connection server 200 without waiting when predetermined conditions are not satisfied.

For example, the client 100 waits for a reconnection interval only when the constant connection is disconnected for reasons related to the constant connection server 200. On the other hand, the client 100 immediately starts the reconnection process when the disconnection is caused by the client 100.

As a specific example, the client 100 stores flag information in a temporary region (turns on the flag) when the constant connection is disconnected for reasons other than the constant connection server 200 (such as in reactivation of the client API). For reconnection, the client 100 determines whether the flag information is ON. When the flag information is ON, the client 100 immediately starts the reconnection process. The client 100 turns off the flag upon successfully making a reconnection. On the other hand, when the flag information is OFF, the client 100 starts the reconnection process after waiting for a reconnection interval.

In other words, the client 100 stores flag information in a temporary region (turns on the flag) when the disconnection is caused by the client 100 (such as in reactivation of the client API).

This makes it possible to reduce the waiting time, or the time period in which the functions using the constant connection are unavailable, when balancing of reconnections is not required.

### Seventeenth Embodiment

In the foregoing embodiments, the network system 1 includes a plurality of constant connection servers 200. The network system 1 may, however, include only a single constant connection server 200.

In this case, the client 100 does not need to request the constant connection server 200 for a node list. The client 100, however, requires receiving the reconnection interval from the constant connection server 200. Specifically, when disconnected from the constant connection, the client 100 waits for a waiting time within the reconnection interval of 1 to T seconds, or for the reconnection interval T, and starts the handshake process with the constant connection server 200 that has had a constant connection with the client 100, without requesting a node list.

In the constant connection server 200 according to the present embodiment, the WS server 212 regularly obtains the following information from the data stored in the association DB 500 or the constant connection server 200, specifically the number of clients 100 connected to the constant connection servers 200, and the number of allowable reconnections per second for the constant connection server 200. The WS server 212 calculates the reconnection interval T (seconds) according to the following equation (2).

(Reconnection interval)=(Number of connected clients+α)÷(Number of allowable reconnections per second) Equation (2)

### Eighteenth Embodiment

### Overall Configuration of Network System

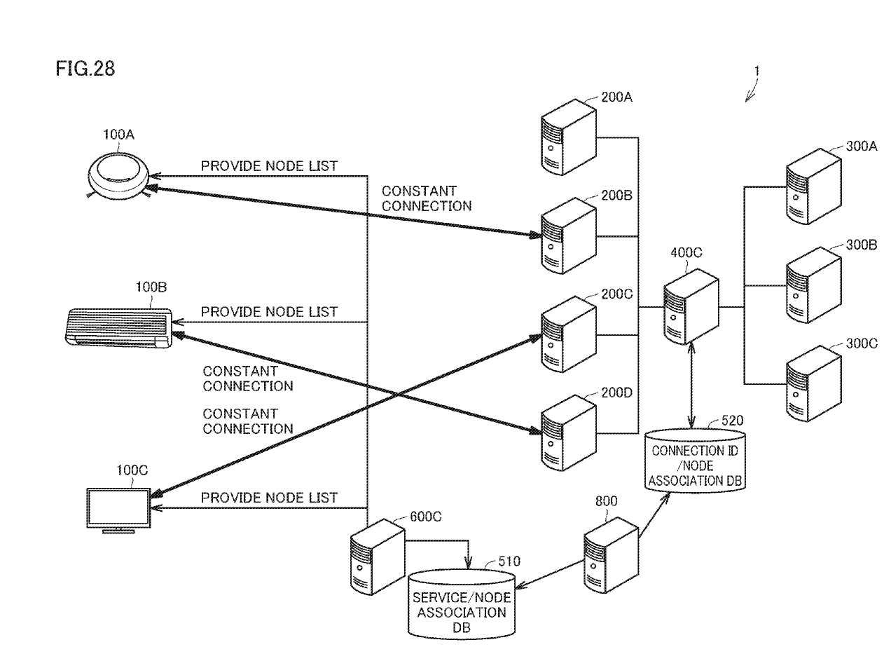

The overall configuration of the network system 1 according to the present embodiment is described below. FIG. 28 is a schematic diagram representing the overall configuration of the network system 1 according to the present embodiment.

Referring to FIG. 28, the network system 1 includes a plurality of home appliances 100A, 100B, and 100C disposed in locations such as homes and offices, a plurality of constant connection servers 200A, 200B, 200C, and 200D connected to the home appliances 100A, 100B, and 100C via a network, a plurality of application servers 300A, 300B, and 300C that provide various services concerning the home appliances 100A, 100B, and 100C, a first auxiliary server 600C that provides the home appliances 100A, 100B, and 100C with a list concerning the constant connection servers 200A, 200B, 200C, and 200D, and a second auxiliary server 400C that allocates the data from the application servers 300A, 300B, and 300C to the constant connection servers 200A, 200B, 200C, and 200D.

In the following, the home appliances 100A, 100B, and 100C will also be collectively called clients 100. The constant connection server 200A, 200B, 200C, and 200D will also be collectively referred to as constant connection servers 200. Likewise, the term “application server 300” will also be used as a collective term for application servers 300A, 300B, and 300C.

Examples of the clients 100 include a vacuum cleaner 100A, an air conditioner 100B, a television 100C, a washing machine, a refrigerator, a rice cooker, an air purifier, a floor heating system, and an IH (Induction Heating) cooking heater. The clients 100 may be any communications devices for homes and offices, including, for example, personal computers, audio-video equipment other than television, and an intercom system. The constant connection servers 200, the application servers 300, the first auxiliary server 600C, and the second auxiliary server 400C may include servers that reside in the same home, office, building, company, or school where the clients 100 are provided.

The clients 100 and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, one or more constant connection servers 200 are associated with one application server 300 or one service. One or more application servers 300 or one or more services are associated with one constant connection server 200. Specifically, the service to constant connection server relationship may be an N-to-N relationship in the network system 1 according to the present embodiment.

Note, however, that more than one constant connection server 200 may be associated with one application server 300 or one service, and only one application server 300 or only one service may be associated with one constant connection server 200. Specifically, the system may allow a 1-to-N relationship for service and constant connection server, but may not allow an N-to-N relationship for service and constant connection server.

Conversely, only one constant connection server 200 may be associated with one application server 300 or one service, and more than one application server 300 or more than one service may be associated with one constant connection server 200. Specifically, the system may allow an N-to-1 relationship for service and constant connection server, but may not allow an N-to-N relationship for service and constant connection server.

In the present embodiment, the association between a service and the information concerning the node realized by the constant connection server 200 is stored in a service/node association DB 510. The clients 100, by using data from the service/node association DB 510, each makes a constant connection with any constant connection server 200 associated with the service it wishes to use.

In the following, it is assumed for convenience of explanation that a single application server 300 provides a single service, and that a single service is provided by a single application server 300. Specifically, the application server 300 and the service have a 1-to-1 relationship in the present embodiment.

The information concerning nodes may be the addresses of the constant connection servers 200, or IDs specifying the constant connection servers 200. When the information concerning nodes are IDs specifying the constant connection servers 200, the service/node association DB 510 stores the association between the IDs specifying the constant connection servers 200, and the addresses of the constant connection servers 200.

For example, assume here that the first application server 300A provides the vacuum cleaner 100A with a service for vacuum cleaner, the second application server 300B provides the air conditioner 100B with a service for air conditioner, and the third application server 300C provides the television 100C with a service for television. It is also assumed that, at any given time point, the first application server 300A is associated with the first constant connection server 200A and the second constant connection server 200B, the second application server 300B is associated with the third constant connection server 200C and the fourth constant connection server 200D, and the third application server 300C is associated with the third constant connection server 200C and the fourth constant connection server 200D.

In these situations, the vacuum cleaner 100A obtains from the first auxiliary server 600C a list of constant connection servers 200 associated with the service for vacuum cleaner when attempting to use the service for vacuum cleaner, specifically when attempting to open a constant connection. The vacuum cleaner 100A, by referring to the list, makes a constant connection with the first constant connection server 200A or the second constant connection server 200B associated with the service for vacuum cleaner. This enables the first application server 300A to push various data to the vacuum cleaner 100A via the first constant connection server 200A or the second constant connection server 200B. Specifically, the client 100 wishing to use the service for vacuum cleaner receives the data pushed by the first application server 300A via the first constant connection server 200A or the second constant connection server 200B.

Likewise, the air conditioner 100B obtains from the first auxiliary server 600C a list of constant connection servers 200 associated with the service for air conditioner when attempting to use service for air conditioner, specifically when attempting to open a constant connection. The air conditioner 100B, by referring to the list, makes a constant connection with the third constant connection server 200C or the fourth constant connection server 200D associated with the service for air conditioner. This enables the second application server 300B to push various data to the air conditioner 100B via the third constant connection server 200C or the fourth constant connection server 200D. Specifically, the client 100 wishing to use the service for air conditioner receives the data pushed by the second application server 300B via the third constant connection server 200C or the fourth constant connection server 200D.

Likewise, the television 100C obtains from the first auxiliary server 600C a list of constant connection servers 200 associated with the service for television when attempting to use the service for television, specifically when attempting to open a constant connection. The television 100C, by referring to the list, makes a constant connection with the third constant connection server 200C or the fourth constant connection server 200D associated with the service for television. This enables the third application server 300C to push various data to the television 100C via the third constant connection server 200C or the fourth constant connection server 200D. Specifically, the client 100 wishing to use of the service for television receives the data pushed by the third application server 300C via the third constant connection server 200C or the fourth constant connection server 200D.

In this manner, the client 100 exchanges data between the application server 300 via the constant connection server 200 associated with the service it wished to use. In the present embodiment, a connection ID is set for each combination of clients 100 and application servers 300. The association between the connection ID and the constant connection server 200 are stored in the connection ID/node association DB 520.

In the present embodiment, a monitoring server 800 refers to the connection ID/node association DB 520, and monitors whether loads are concentrated on only certain constant connection servers 200. In other words, the monitoring server 800 determines whether the load for a certain service is too high for the number of the constant connection servers 200 allocated to this service.

The monitoring server 800 allocates more constant connection servers 200 to the service (for example, a first service) associated with the constant connection servers 200 that are under high loads, and fewer constant connection servers 200 to the service (a second service) associated with the constant connection servers 200 with fewer loads. In the present embodiment, the monitoring server 800 changes the association in the service/node association DB 510 so that the constant connection server 200 allocated to the second service becomes associated with the first service.

Specifically, the application servers 300 or services are associated with the constant connection servers 200 in the network system 1 according to the present embodiment, and the system allows only the constant connection servers 200 associated with certain services to be placed in sleep or maintenance, or only the constant connection servers 200 associated with certain services to have higher or lower specifications. The system also can increase or decrease the number of only the constant connection servers 200 associated with certain services.

By dynamically changing the relationships between the application servers 300 or services and the constant connection servers 200, it is possible to reduce the possibility of the clients 100 failing to use services that have heavy access due to popular demands, or data failing to be smoothly sent and received over a constant connection. Specifically, the network system 1 according to the present embodiment can reduce the possibility of loads concentrating on only certain constant connection servers 200 while enabling maintenance of constant connection servers 200 in a service-specific manner.

The following describes the specific configuration of the network system 1 for realizing the foregoing functions.

### <Hardware Configuration of Client 100>

The following describes an aspect of the hardware configuration of the client 100.

Referring to FIG. 2, the main constituting elements of the client 100 include a CPU 110, a memory 120, an input/output unit 130, a home appliance control circuit 150, and a communication interface 160.

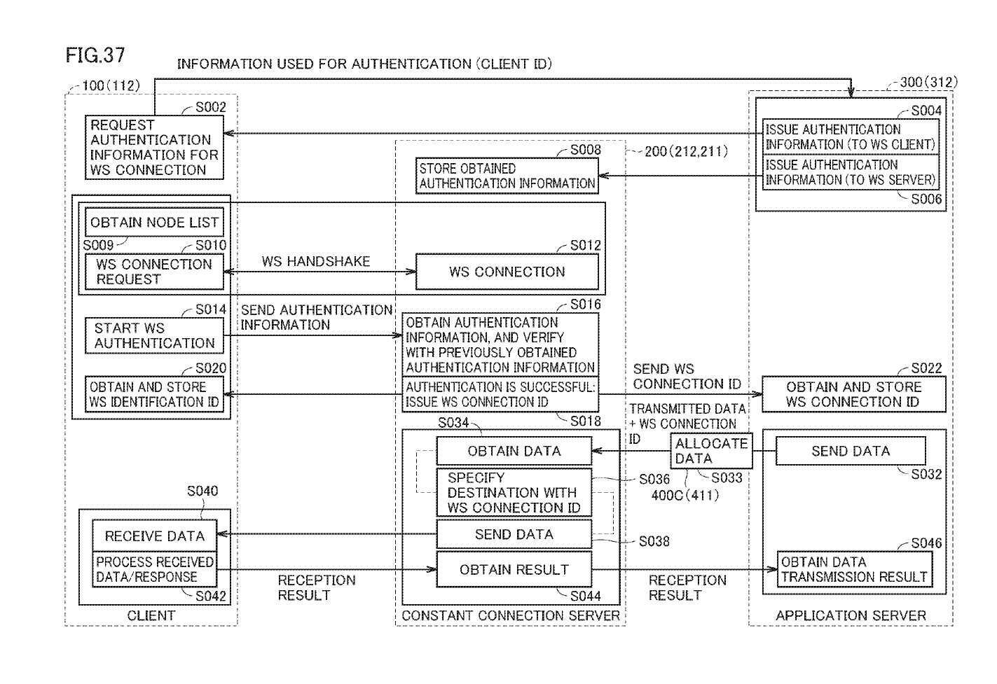

The CPU 110 controls each part of the client 100 by running programs stored in the memory 120 or in external storage media. More specifically, the CPU 110 executes the programs stored in the memory 120, and operates as a client APP and a client API 112 (see FIG. 37; described later). More specifically, the client APP controls each part of the client 100 via the home appliance control circuit 150. The client API 112 communicates over the HTTP protocol, or over the WebSocket protocol on the HTTP protocol, via the communication interface (described later).

The memory 120 is realized by various types of memory, including, for example, RAM (Random Access Memory), ROM (Read-Only Memory), and flash memory. The memory 120 may also be realized by, for example, storage media used with an interface, including, for example, USB (Universal Serial Bus®) memory, CD (Compact Disc), DVD (Digital Versatile Disk), memory card, hard disk, IC (Integrated Circuit) card, optical memory card, mask ROM, EPROM (Erasable Programmable Read Only Memory), and EEPROM (Electronically Erasable Programmable Read-Only Memory).

The memory 120 stores programs run by the CPU 110, data generated after the execution of a program by the CPU 110, input data via the input/output unit 130, APP data operating as a home appliance such as a vacuum cleaner, an air conditioner, and a television, and API data for communicating with the constant connection server 200 while exchanging data with the client APP. The APP data includes service connection information for sending and receiving information to and from the application server 300. The API data includes WebSocket client API setting information, authentication information, connected device service setting information, and connection status information.

The input/output unit 130 receives a user instruction, and enters the instruction to the CPU 110. The input/output unit 130 outputs characters, images, and sound by using signals from the CPU 110.

The home appliance control circuit 150 controls each part (such as a motor) of clients 100 (home appliances) such as the vacuum cleaner 100A, the air conditioner 100B, and the television 100C by using signals from the CPU 110.

The communication interface 160 is realized by various communications modules, including, for example, wireless LAN communications (such as IEEE 802.11a/b/g/n/ac), ZigBee®, BlueTooth®, and wired LAN such as Ethernet®. The communication interface 160 is provided for data exchange with other devices over wired communications or wireless communications. The CPU 110 receives programs, control instructions, image data, text data, sound data, and other such information from other devices, and sends information such as text data, image data, and sound data to other devices via the communication interface 160.

### <Hardware Configuration of Constant Connection Server 200>

The following describes an aspect of the hardware configuration of the constant connection server 200.

Referring to FIG. 3, the main constituting elements of the constant connection server 200 include a CPU 210, a memory 220, an input/output unit 230, and a communication interface 260. The hardware configuration of the constant connection server 200 differs from that of the client 100 in that the home appliance control circuit 150 for controlling each part of the home appliances is not provided. Other differences are the operation of the CPU 210, and the data stored in the memory 220. Accordingly, the following describes the operation of the CPU 210, and the data stored in the memory 220, and does not describe other hardware configuration.

The CPU 210 controls each part of the constant connection server 200 by running programs stored in the memory 220 or in external storage media. Specifically, the CPU 210 executes the programs stored in the memory 220, and operates as a WS server core 212 (see FIG. 37; described later). The WS server core 212 refers to a constant connection server in the form of software, and controls the constant connection communications with the client 100 over the WebSocket protocol, or the communications with the first auxiliary server 600C, the second auxiliary server 400C, and a plurality of application servers 300 over the HTTP protocol.

The memory 220 stores information such as programs run by the CPU 210, data generated after the execution of a program by the CPU 210, input data via the input/output unit 230, service master information, temporary authentication information, connection status administrative information, connection group information, and connection group participation information.

### <Hardware Configuration of Application Server 300>

The following describes an aspect of the hardware configuration of the application server 300.

Referring to FIG. 4, the main constituting elements of the application server 300 include a CPU 310, a memory 320, an input/output unit 330, and a communication interface 360. The hardware configuration of the application server 300 differs from that of the constant connection server 200 in the operation of the CPU 310, and the data stored in the memory 320. Accordingly, the following mainly describes the operation of the CPU 310, and the data stored in the memory 320, and does not describe other hardware configuration.

The CPU 310 controls each part of the application server 300 by running programs stored in the memory 320 or in external storage media. Specifically, the CPU 310 executes the programs stored in the memory 320, and operates as a server APP 311A and a server API 312 (see FIG. 37; described later).

The server APP refers to application servers in the form of software, and provides services to devices such as clients 100 and smartphones. The server API 312 controls the communications with the second auxiliary server 400C or the constant connection server 200 over the HTTP protocol.

The memory 320 stores programs run by the CPU 310, data generated after the execution of a program by the CPU 310, input data via the input/output unit 330, APP data operating as the application server 300, and API data for communicating with the constant connection server 200 while exchanging data with the server APP. APP data includes client information that contains information concerning the client 100 of interest to the APP data, client connection information concerning the client 100 that is in a constant connection, and connection probability temporary information for opening a new constant connection. The API data includes WebSocket server API setting information, authentication administrative information, service setting information, and client connection status information.

### <Hardware Configuration of First Auxiliary Server 600C>

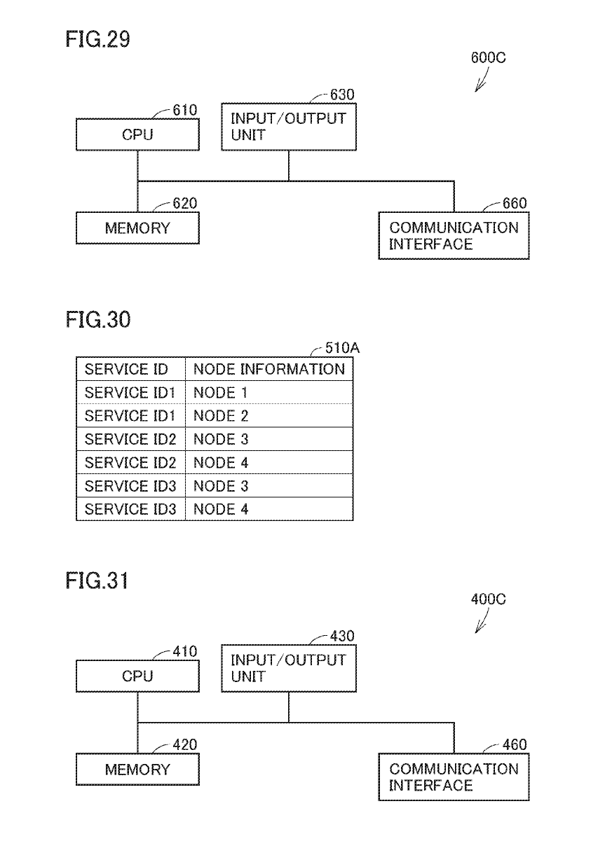

The following describes an aspect of the hardware configuration of the first auxiliary server 600C. FIG. 29 is a block diagram representing the hardware configuration of the first auxiliary server 600C.

Referring to FIG. 29, the main constituting elements of the first auxiliary server 600C include a CPU 610, a memory 620, an input/output unit 630, and a communication interface 660. The hardware configuration of the first auxiliary server 600C differs from that of the constant connection server 200 in the operation of the CPU 610, and the data stored in the memory 620. Accordingly, the following mainly describes the operation of the CPU 610, and the data stored in the memory 620, and does not describe other hardware configuration.

The CPU 610 controls each part of the first auxiliary server 600C by running programs stored in the memory 620 or in external storage media. Specifically, the CPU 610 executes the programs stored in the memory 620, and realizes a node list providing function. For example, the CPU 610 refers to the service/node association DB 510, and creates a node list. The CPU 610 sends the node list it creates to the client 100 via the communication interface 660.

The memory 620 stores information such as programs run by the CPU 610, data generated after the execution of a program by the CPU 610, and input data via the input/output unit 630.

### <Service/Node Association DB>

The following describes the service/node association DB 510 used in the network system 1 according to the present embodiment. FIG. 30 is a schematic diagram representing a structure of the data contained in the service/node association DB 510 according to the present embodiment.

Referring to FIG. 30, the service/node association DB 510 includes an association 510A between the services provided by the application servers 300, and node information of the constant connection servers 200.

The node information may be the addresses of the constant connection servers 200, or IDs specifying the constant connection servers 200. When the node information is IDs specifying the constant connection servers 200, the service/node association DB 510 also stores the association between the IDs specifying the constant connection servers 200, and the addresses of the constant connection servers 200.

This enables the first auxiliary server 600C to refer to the service/node association DB 510, and, upon receiving a request from the client 100, create a list of the nodes associated with the service to be used by the client 100. In the present embodiment, the first auxiliary server 600C creates a node list by extracting from the service/node association DB 510 the addresses of the constant connection servers 200 associated with the service designated by the client 100.

For example, the first auxiliary server 600C sends the following data to the client 100 as the node list.

″handshakeUr1″: [″ws: / /example01.com: 18080/cpush-server/echo″,
″ws: / /example02.com: 18080/cpush-server/echo″]

### <Hardware Configuration of Second Auxiliary Server 400C>

The following describes an aspect of the hardware configuration of the second auxiliary server 400C. FIG. 31 is a block diagram representing the hardware configuration of the second auxiliary server 400C.

Referring to FIG. 31, the main constituting elements of the second auxiliary server 400C include a CPU 410, a memory 420, an input/output unit 430, and a communication interface 460. The hardware configuration of the second auxiliary server 400C differs from that of the constant connection server 200 in the operation of the CPU 410, and the data stored in the memory 420. Accordingly, the following mainly describes the operation of the CPU 410, and the data stored in the memory 420, and does not describe other hardware configuration.

The CPU 410 controls each part of the second auxiliary server 400C by running programs stored in the memory 420 or in external storage media. Specifically, the CPU 410 executes the programs stored in the memory 420, and realizes the data allocating function 411(see FIG. 37; described later).

The memory 420 stores information such as programs run by the CPU 410, data generated after the execution of a program by the CPU 410, and input data via the input/output unit 430.

### <Connection ID/Node Association DB>

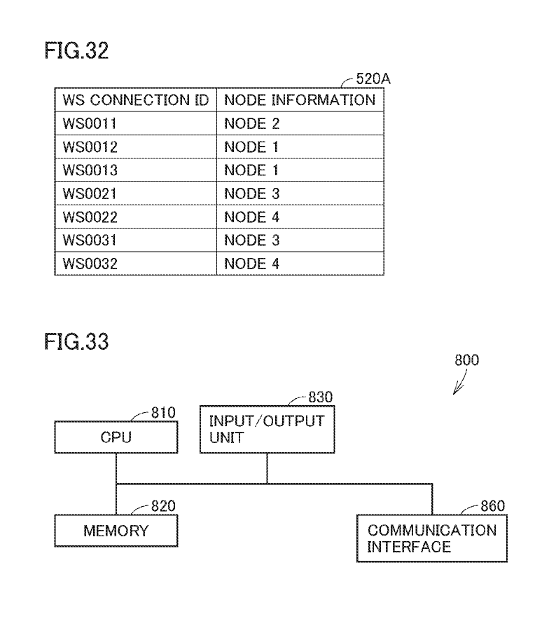

The following describes the connection ID/node association DB 520 used in the network system 1 according to the present embodiment. FIG. 32 is a schematic diagram representing a structure of the data contained in the connection ID/node association DB 520 according to the present embodiment.

Referring to FIG. 32, the connection ID/node association DB 520 includes an association 520A between connection IDs for specifying clients 100 in constant connections, and the nodes realized by the constant connection servers 200. This enables the second auxiliary server 400C to recognize which of the clients 100 is connected to which constant connection server 200 over a constant connection. Specifically, by referring to the connection ID/node association DB 520, the second auxiliary server 400C can specify the constant connection server 200 to which the data pushed from the application server 300 to the client 100 should be allocated.

### <Hardware Configuration of Monitoring Server 800>

The following describes an aspect of the hardware configuration of the monitoring server 800. FIG. 33 is a block diagram representing the hardware configuration of the monitoring server 800 (800B, 800C, 800D, and 800E) according to the present embodiment.

Referring to FIG. 33, the main constituting elements of the monitoring server 800 include a CPU 810, a memory 820, an input/output unit 830, and a communication interface 860. The hardware configuration of the monitoring server 800 differs from that of the constant connection server 200 in the operation of the CPU 810, and the data stored in the memory 820. Accordingly, the following mainly describes the operation of the CPU 810, and the data stored in the memory 820, and does not describe other hardware configuration.

The CPU 810 controls each part of the monitoring server 800 by running programs stored in the memory 820 or in external storage media. Specifically, the CPU 810 executes the programs stored in the memory 820, and measures or obtains information such as the number of clients connected to each constant connection server 200, the PUSH frequency, the transmitted data volume, and loads. The CPU 810 determines whether information such as the number of clients connected to each constant connection server 200, the PUSH frequency, the transmitted data volume, and loads exceeds the predetermined value. When information such as the number of clients connected to each constant connection server 200, the PUSH frequency, the transmitted data volume, and loads exceeds the predetermined value, the CPU 810 changes the service-node combination in the service/node association DB 510.

The memory 820 stores information such as programs run by the CPU 810, data generated after the execution of a program by the CPU 810, and input data via the input/output unit 830.

### <Functional Configuration of Network System 1 Concerning Constant Connection>

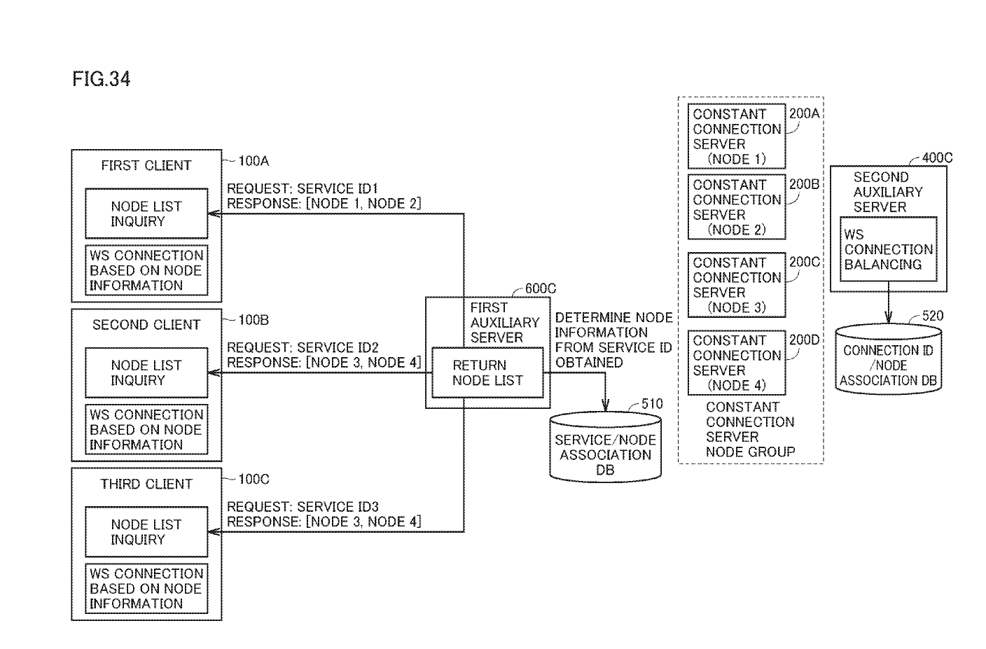

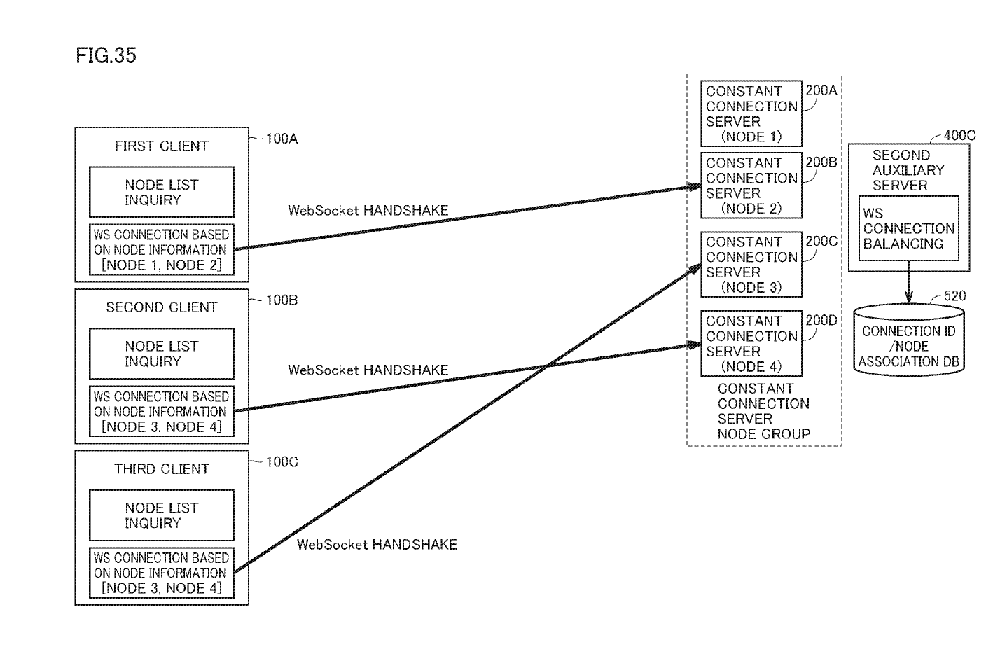

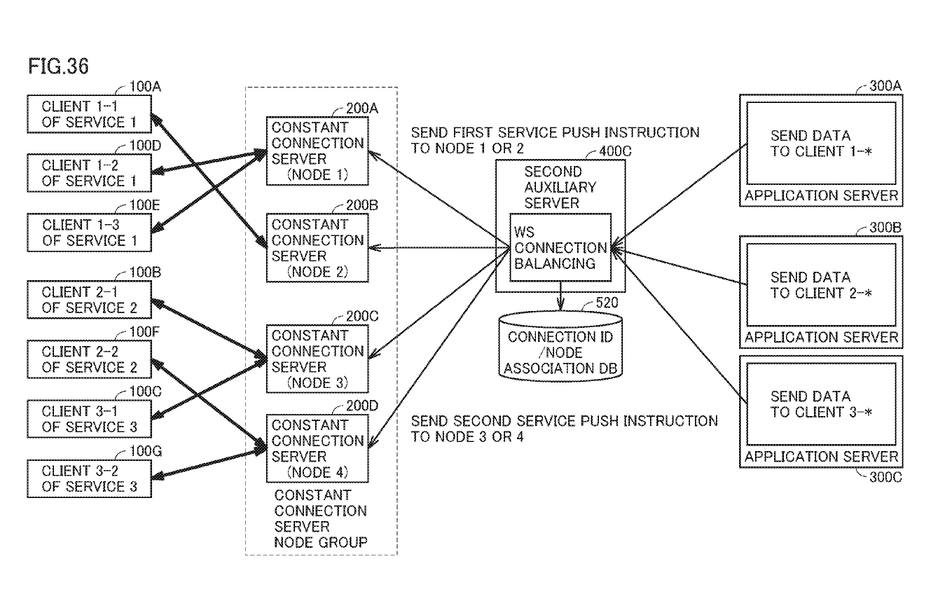

The following describes the overall functional configuration of the network system 1 concerning opening of a constant connection according to the present embodiment. FIG. 34 is a first block diagram representing the overall functional configuration of the network system 1 according to Eighteenth Embodiment. FIG. 35 is a second block diagram representing the overall functional configuration of the network system 1 according to Eighteenth Embodiment. FIG. 36 is a third block diagram representing the overall functional configuration of the network system 1 according to Eighteenth Embodiment.

Referring to FIG. 34, the clients 100A to 100C each open a constant connection by requesting the first auxiliary server 600C for a node list over the HTTP protocol. Specifically, the client 100A wishing to use a first service sends the first auxiliary server 600C a service ID for specifying the first service.

The first auxiliary server 600C refers to the service/node association DB 510, and creates a node list concerning the first service. The node list contains the addresses of the constant connection servers 200 associated with the first service. The first auxiliary server 600C sends the node list to the client 100A. For example, the first auxiliary server sends the following data to the client 100 as the node list.

″handshakeUr1″: [″ws: / /example01.com: 18080/cpush-server/echo″,
″ws: / /example02.com: 18080/cpush-server/echo″]

As represented in FIG. 35, the client 100A refers to the node list, and attempts to connect to the constant connection server 200A associated with the first service. The process for opening a constant connection will be described later.

In the same manner, referring to FIG. 34, the client 100B wishing to use a second service sends the first auxiliary server 600C a service ID for specifying the second service. The first auxiliary server 600C creates a node list concerning the second service by referring to the service/node association DB 510. The node list contains the addresses of the constant connection servers 200 associated with the second service. For example, the first auxiliary server 600C sends the following data to the client 100B as the node list.

″handshakeUr1″: [″ws:/ /example03.com: 18080/cpush-server/echo″]

As represented in FIG. 35, the client 100B refers to the node list, and attempts to connect to the constant connection server 200D associated with the second service. The process for opening a constant connection will be described later.

In the same manner, referring to FIG. 34, the client 100C wishing to use a third service sends the first auxiliary server 600C a service ID for specifying the third service. The first auxiliary server 600C creates a node list concerning the third service by referring to the service/node association DB 510. The node list contains the addresses of the constant connection servers 200 associated with the third service. For example, the first auxiliary server 600C sends the following data to the client 100C as the node list.

″handshakeUr1″: [″ws:/ /example04.com: 18080/cpush-server/echo″]

As represented in FIG. 35, the client 100C refers to the node list, and attempts to connect to the constant connection server 200C associated with the third service. The process for opening a constant connection will be described later.

In this manner, the clients 100 each establish a constant connection with the constant connection server 200 associated with the service it wishes to use. For example, as shown in FIG. 36, the clients 100A to 100G each establish a constant connection with the constant connection server 200 associated with the service it wishes to use from among the plurality of constant connection servers 200.

Here, the first constant connection server 200A and the second constant connection server 200B are associated with the first service. The clients 100A, 100D, and 100E wishing to use the first service make constant connections with either the first constant connection server 200A or the second constant connection server 200B. This enables the application server 300A providing the first service to push data to the clients 100A, 100D, and 100E via the first constant connection server 200A or the second constant connection server 200B.

In the same fashion, the third constant connection server 200C and the fourth constant connection server 200D are associated with the second service. The clients 100B and 100F wishing to use the second service make constant connections with either the third constant connection server 200C or the fourth constant connection server 200D. This enables the application server 300B providing the second service to push data to the clients 100B and 100F via the third constant connection server 200C or the fourth constant connection server 200D.

In the same fashion, the third constant connection server 200C and the fourth constant connection server 200D are associated with the third service. The clients 100C and 1000 wishing to use the third service make constant connections with either the third constant connection server 200C or the fourth constant connection server 200D. This enables the application server 300C providing the third service to push data to the clients 100C and 1000 via the third constant connection server 200C or the fourth constant connection server 200D.

<Data Exchange between Devices Concerning Constant Connection>

The following specifically describes the data exchange between devices concerning the constant connection in the network system 1 according to the present embodiment. FIG. 37 is a sequence diagram representing the procedures of the data exchange between devices concerning a constant connection in the network system 1 according to the present embodiment.

Referring to FIG. 37, the client API 112 realized by the client 100 requests the application server 300 for authentication information over the HTTP protocol via the communication interface 160 (step S002). Here, the client API 112 sends the application server 300 the client ID used for authentication. The server API 312 of the application server 300 responds to the request by sending authentication information to the client 100 over the HTTP protocol via the communication interface 360 (step S004).

The server API 312 sends authentication information also to the constant connection server 200 via the communication interface 360 (step S006). The WS server core 212 of the constant connection server 200 stores the authentication information sent from the application server 300 (step S008).

The client 100 obtains a node list from the first auxiliary server 600C (step S009). Specifically, the client 100 sends a service ID to the first auxiliary server 600C over the HTTP protocol. The first auxiliary server 600C creates a node list associated with the service by referring to the service/node association DB, and sends the node list to the client 100. The client 100 selects one of the constant connection servers 200 from the node list.

The client 100, and the constant connection server 200 selected by the client 100 establish a WebSocket constant connection state using the HTTP protocol (step S010, step S012). Specifically, the client API 112 sends a handshake request to the constant connection server 200 via the communication interface 160 over the HTTP protocol. The WS server core 212 returns a handshake response via the communication interface 260. This establishes a valid WebSocket constant connection between the client 100 and the constant connection server 200.

The client API 112 sends the authentication information to the constant connection server 200 via the communication interface 160 (step S014). The WS server core 212 authenticates the client 100 by using the authentication information from the client 100, and the stored authentication information (step S016). When authentication is successful, the WS server core 212 issues a connection ID for the identification of the client 100 by the application server 300 (step S018).

Specifically, the WS server core 212 stores the association between the constantly connected client 100 and the connection ID as connection status administrative information. The client 100 receives and stores the connection ID (step S020). The application server 300 also receives and stores the connection ID (step S022). Here, the WS server core 212 registers the association between the connection ID, the information (node information) for specifying the constant connection server 200, and the information for specifying the application service in the connection ID/node association DB 520 via the communication interface 260.

In response to a request from the server APP 311, the server API 312 sends the connection ID for specifying the receiving client 100 to the constant connection server 200 via the communication interface 360, together with the main data (step S032).

In the present embodiment, the data from the application server 300 is received by the second auxiliary server 400C in step S033. The allocating function 411 of the second auxiliary server 400C refers to the connection ID/node association DB 520, and specifies the constant connection server 200 associated with the receiving client 100. The CPU 410 of the second auxiliary server 400C sends the data to the specified constant connection server 200 via the communication interface 460.

The constant connection server 200 receives the main data and the connection ID from the first auxiliary server 600C (step S034). The WS server core 212 refers to the connection status administrative information, and specifies the client 100 by using the connection ID (step S036). The WS server core 212 pushes the main data to the client 100 via the communication interface 260 (step S038).

The client 100 receives the main data (step S040). The client 100 sends the reception result to the constant connection server 200 over the WebSocket protocol (step S042). Upon receiving the reception result, the constant connection server 200 sends the reception result to the application server 300 (step S044). The application server 300 receives the reception result (step S046).

### <Functional Configuration of Network System 1 Concerning Service/Node Association Changes>

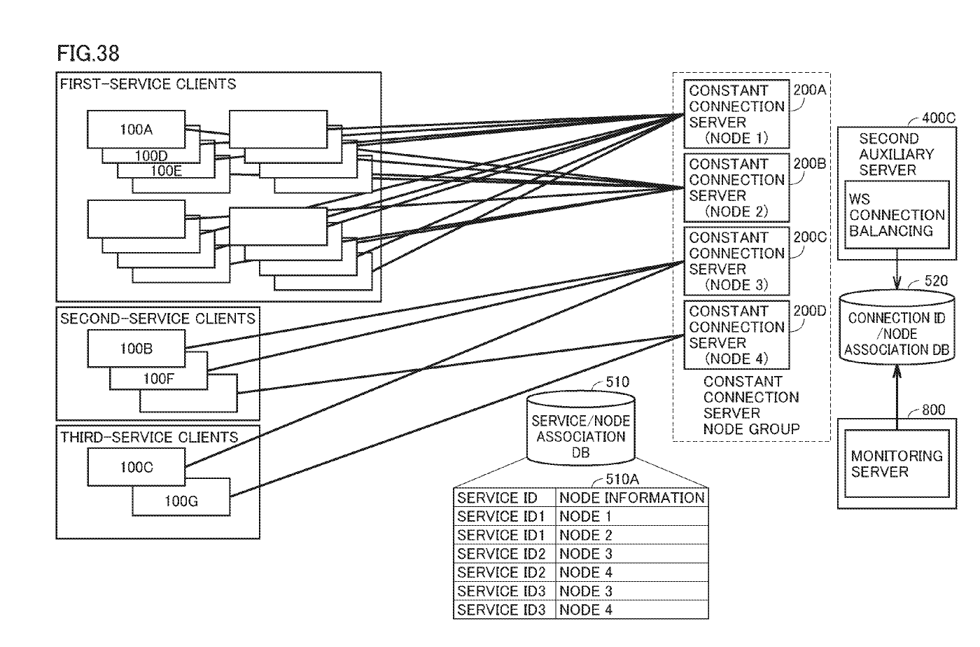

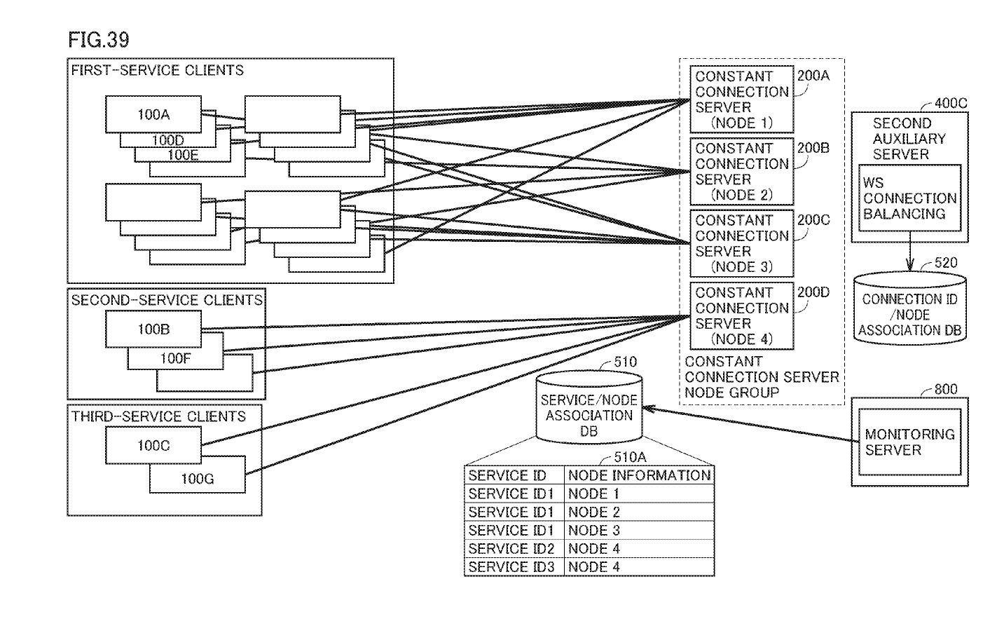

The following describes the overall functional configuration of the network system 1 concerning service/node changes according to the present embodiment. FIG. 38 is a fourth block diagram representing the overall functional configuration of the network system 1 according to Eighteenth Embodiment. FIG. 39 is a fifth block diagram representing the overall functional configuration of the network system 1 according to Eighteenth Embodiment.

Referring to FIG. 38, there are cases where the first constant connection server 200A and the second constant connection server 200B associated with the first service are in constant connections with large numbers of clients 100, and fewer numbers of clients 100 are in constant connections with the third constant connection server 200C and the fourth constant connection server 200D associated with the second service. In other words, the number of constantly connected clients 100 per constant connection server 200 associated with the first service may greatly differ from the number of constantly connected clients 100 per constant connection server 200 associated with the second service.

The monitoring server 800 according to the present embodiment refers to the connection ID/node association DB 520, and determines whether the number of connected clients 100 greatly differs across the constant connection servers 200. From the result of determination, the monitoring server 800 changes the service/node association in such a manner that the number of the connected clients does not become greatly different between the constant connection servers 200.

For example, the monitoring server 800 may determine whether the number of the connected clients 100 per constant connection server 200 exceeds the predetermined value. When the number of the clients connected to any of the constant connection servers 200 exceeds the predetermined value, the monitoring server 800 changes the server/node association D600 so that more constant connection servers 200 become associated with the service that is associated with the first constant connection server 200A for which the number of the connected clients 100 exceeds the predetermined value. Specifically, the service associated with the third constant connection server 200C with fewer numbers of connected clients 100 is changed to the service that is associated with the first constant connection server 200A for which the number of the connected clients exceeds the predetermined value.

Alternatively, the monitoring server 800 activates an inactive constant connection server 200, and changes the setting so that the activated constant connection server 200 becomes associated with the service that is associated with the first constant connection server 200A for which the number of the connected clients exceeds the predetermined value.

Alternatively, the monitoring server 800 may determine whether the number of the clients connected to the first constant connection server 200A with larger numbers of connected client 100 is two times or greater than the number of the clients connected to the third constant connection server 200C with fewer numbers of connected clients 100. When the number of the clients connected to the first constant connection server 200A is two times or greater than the number of the clients 100 connected to the third constant connection server 200C, the monitoring server 800 may change the server/node association D600 so that fewer constant connection servers 200 become associated with the service that is associated with the third constant connection server 200C, and more constant connection servers 200 become associated with the service that is associated with the first constant connection server 200A.

In this way, as shown in FIG. 39, the clients 100 using the first service are channeled to the third constant connection server 200C, whereas the clients 100 using the second and third services collect to the fourth constant connection server 200D. Specifically, it is possible to prevent overcrowding of particular constant connection servers 200 (for example, first constant connection server 200A and second constant connection server 200B) with clients 100 wishing to connect to these servers associated with a popular service (for example, a first service).

### <Node Selection Process by Client>

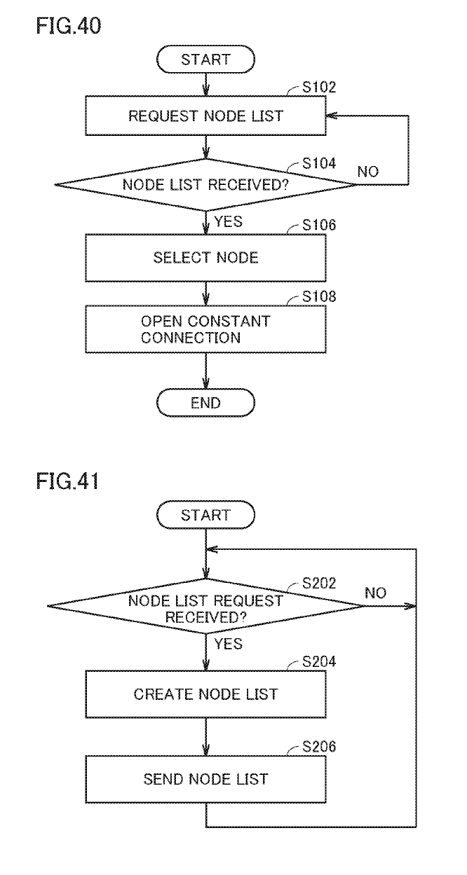

The following describes the node selection process by the client 100 according to the present embodiment. FIG. 40 is a flowchart representing the node selection process by the client 100 according to the present embodiment.

Referring to FIG. 40, the CPU 110 performs the processes below according to the instructions contained in the programs stored in the memory 120. For opening a constant connection to use a service, the CPU 110 sends a node list request containing information for specifying the service, for example, such as a service ID, to the first auxiliary server 600C via the communication interface 160 (step S102). The CPU 110 determines whether the node list is received from the first auxiliary server 600C via the communication interface 160 (step S104). When the node list is not received from the first auxiliary server 600C (NO in step S104), the CPU 110 repeats the procedures from step S102.

Upon receiving a node list from the first auxiliary server 600C (YES in step S104), the CPU 110 selects one of the constant connection servers 200 from the node list (step S106). The CPU 110 then opens a constant connection with the selected constant connection server 200 via the communication interface 160 over the WebSocket protocol (step S108). Specifically, the CPU 110 performs the process of step S010 and the subsequent processes in FIG. 37.

### <Node List Providing Process by First Auxiliary Server 600C>

The following describes the node list providing process by the first auxiliary server 600C according to the present embodiment. FIG. 41 is a flowchart representing the node list providing process by the first auxiliary server 600C according to the present embodiment.

Referring to FIG. 41, the CPU 610 performs the processes below according to the instructions contained in the programs stored in the memory 620. The CPU 610 determines whether a node list request from the client 100 is received via the communication interface 660 (step S202). The CPU 610 repeats the process of step S202 until the node list request from the client 100 is received (NO in step S202).

Upon receiving a node list request (YES in step S202) from the client 100, the CPU 610 refers to the service/node association DB 510, and creates a node list by tabulating the addresses of the constant connection servers 200 associated with the service ID contained in the node list request (step S204). The CPU 610 sends the node list to the client 100 via the communication interface 660 (step S206).

### <Service/Node Association Changing Process by Monitoring Server 800>

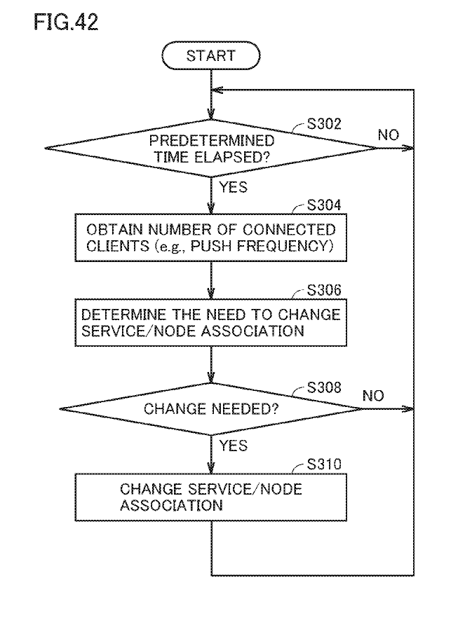

The following describes the service/node association changing process by the monitoring server 800 according to the present embodiment. FIG. 42 is a flowchart representing the association changing process by the monitoring server 800 according to the present embodiment.

Referring to FIG. 42, the CPU 810 performs the processes below according to the instructions contained in the programs stored in the memory 820. The CPU 810 refers to a clock (not shown), and determines whether a predetermined time period has elapsed from the last time the need for association change was determined (step S302). The CPU 810 repeats the process of step S302 until the predetermined time period elapses (NO in step S302).

When the predetermined time period has elapsed (YES in step S302), the CPU 810 obtains data from the connection ID/node association DB 520 (step S304). The CPU 810 determines the need to change the association between the service and the constant connection servers 200 (step S306). Here, the CPU 810 determines the presence of any constant connection server 200 connected to excessive numbers of clients 100. The CPU 810 may determine the need to change the association according to such factors as the PUSH frequency per constant connection server 200, the transmitted data volume per constant connection server 200, and the load per constant connection server 200, as will be described later.

The CPU 810 repeats the procedures from step S302 when it is determined that there is no need to change the association between the service and the constant connection servers (NO in step S308).

When it is determined that the association between the service and the constant connection servers needs to be changed (YES in step S308), the CPU 810 changes the association between the service ID and the constant connection servers 200 in the service/node association DB 510 via the communication interface 160 (step S310). The CPU 810 repeats the procedures from step S302.

As described above, the application servers 300 or services are associated with the constant connection servers 200 in the network system 1 according to the present embodiment, and the system allows only the constant connection servers 200 relating to certain application servers 300 or services to be maintained, or only the constant connection servers 200 of certain application servers 300 or services to have higher specifications. The system also can increase or decrease the number of only the constant connection servers 200 associated with certain application servers 300 or services.

By dynamically changing the relationships between the application servers 300 or services and the constant connection servers 200, it is possible to reduce the possibility of the clients 100 failing to use services that have heavy access due to popular demands, or data failing to be smoothly sent and received over a constant connection. Specifically, the network system 1 according to the present embodiment can reduce the possibility of loads concentrating on only certain constant connection servers 200 while enabling the constant connection servers 200 to be maintained in a service-specific manner.

### Nineteenth Embodiment

The following describes Nineteenth Embodiment. The network system 1 according to Eighteenth Embodiment simply uses the service/node association. In the network system 1 according to the present embodiment, the constant connection servers 200 are changed according to the service, and the presence or absence of charging.

The present embodiment does not differ from Eighteenth

Embodiment with regard to the overall configuration of the network system, the hardware configuration of the client 100, the hardware configuration of the constant connection server 200, the hardware configuration of the application server 300, the hardware configuration of the first auxiliary server 600C, the hardware configuration of the second auxiliary server 400C, the connection ID/node association DB 520, the hardware configuration of the monitoring server 800, and the data exchange between devices concerning a constant connection. Accordingly, these will not be described in the present embodiment.

### <Service/Node Association DB>

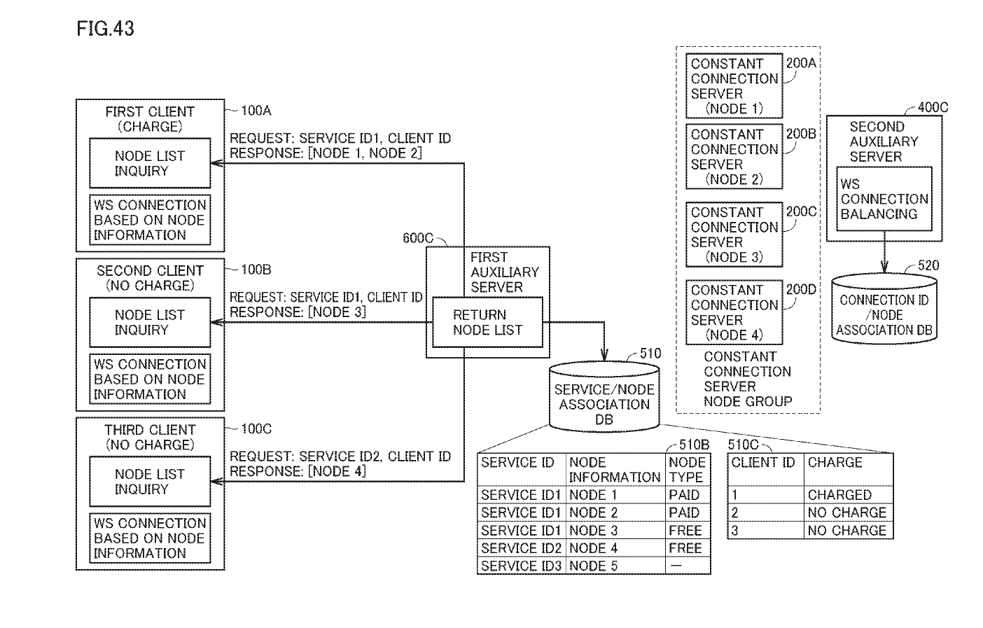

The following describes the service/node association DB 510 used in the network system 1 according to the present embodiment. FIG. 43 is a block diagram representing the overall functional configuration of the network system 1 according to Nineteenth Embodiment.

Referring to FIG. 43, the service/node association DB 510 contains the association 510B between the services provided by the application servers 300, information concerning and the nodes realized by the constant connection servers 200, and information indicative of the presence or absence of a service fee. The service/node association DB 510 also contains information for specifying clients, specifically the association 510C between client IDs and information indicative of the presence or absence of charging.

The information concerning nodes may be the addresses of the constant connection servers 200, or IDs specifying the constant connection servers 200. When the information concerning nodes is IDs specifying the constant connection servers 200, the service/node association DB 510 stores the association between the IDs specifying the constant connection servers 200, and the addresses of the constant connection servers 200.

In this way, the first auxiliary server 600C, in response to a request from the client 100, can create a list of nodes associated with the service to be used by the client 100. In the present embodiment, the first auxiliary server 600C extracts from the service/node association DB 510 a list of the addresses of the constant connection servers 200 associated with the service designated by the client 100.

### <Functional Configuration of Network System 1 Concerning Opening of Constant Connection>

The following describes the overall functional configuration of the network system 1 concerning opening of a constant connection according to the present embodiment.

Referring to FIG. 43, the clients 100A to 100C each request the first auxiliary server 600C for a node list over the HTTP protocol. Specifically, the client 100 wishing to use a paid first service sends the service ID specifying the first service to the first auxiliary server 600C, together with the client ID.

The first auxiliary server 600C refers to the association 510C in the service/node association DB 510, and determines whether the service is a paid service by using the client ID. The first auxiliary server 600C refers the association 510B in the service/node association DB 510, and creates a node list of paid services for the first service by using the service ID, and the presence or absence of charging. For example, the first auxiliary server 600C sends the following data to the client 100A as the node list.

″handshakeUr1″: [″ws: / /example01.com: 18080/cpush-server/echo″,
″ws: / /example02.com: 18080/cpush-server/echo″]

The client 100A refers to the node list, and attempts to connect to the constant connection server 200A associated with the paid first service. The process of opening a constant connection is as described in Eighteenth Embodiment, and will not be described.

In the same fashion, the client 100B wishing to use a free first service sends the service ID specifying the first service to the first auxiliary server 600C, together with the client ID. The first auxiliary server 600C refers to the association 510C in the service/node association DB 510, and determines whether the service is a paid service by using the client ID. The first auxiliary server 600C refers to the association 510B in the service/node association DB 510, and creates a node list of free services for the first service by using the service ID, and the presence or absence of charging.

The first auxiliary server 600C sends the node list to the client 100B. For example, the first auxiliary server 600C sends the following data to the client 100 as the node list.

″handshakeUr1″: [″ws:/ /example03.com: 18080/cpush-server/echo″]

The client 100B refers to the node list, and attempts to connect to the constant connection server 200D associated with the free first service. The process of opening a constant connection is as described in Eighteenth Embodiment, and will not be described.

In the same fashion, the client 100C wishing to use a free second service sends the service ID specifying the second service to the first auxiliary server 600C, together with the client ID. The first auxiliary server 600C refers to the association 510C in the service/node association DB 510, and determines whether the service is a paid service by using the client ID. The first auxiliary server 600C refers the association 510B in the service/node association DB 510, and creates a node list of free services for the second service by using the service ID, and the presence or absence of charging. The first auxiliary server 600C sends the node list to the client 100C. For example, the first auxiliary server 600C sends the following data to the client 100 as the node list.

″handshakeUr1″: [″ws:/ /example04.com: 18080/cpush-server/echo″]

The client 100C refers to the node list, and attempts to connect to the constant connection server 200D associated with the free second service. The process of opening a constant connection is as described in Eighteenth Embodiment, and will not be described.

In this manner, the clients 100 each establish a constant connection with the constant connection server 200 associated with the service it wishes to use. The functions and the processes after the opening of the constant connection are as described in Eighteenth Embodiment, and will not be described.

In other words, the first service, the second service, and the third service of Eighteenth Embodiment correspond to the paid first service, the free first service, and the free second service, respectively, of the present embodiment.

### Twentieth Embodiment

The following describes Twentieth Embodiment. In the network system 1 according to Eighteenth Embodiment, the client 100 sends a service ID to the first auxiliary server 600C, and the first auxiliary server 600C creates a node list associated with the service ID. In the present embodiment, however, the client 100 sends the client ID, without sending a service ID. Specifically, the first auxiliary server 600C specifies the service associated with the client ID, and creates a node list associated with the service.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the hardware configuration of the second auxiliary server 400C, the connection ID/node association DB 520, the hardware configuration of the monitoring server 800, and the data exchange between devices concerning a constant connection. Accordingly, these will not be described in the present embodiment.

### <Service/Node Association DB>

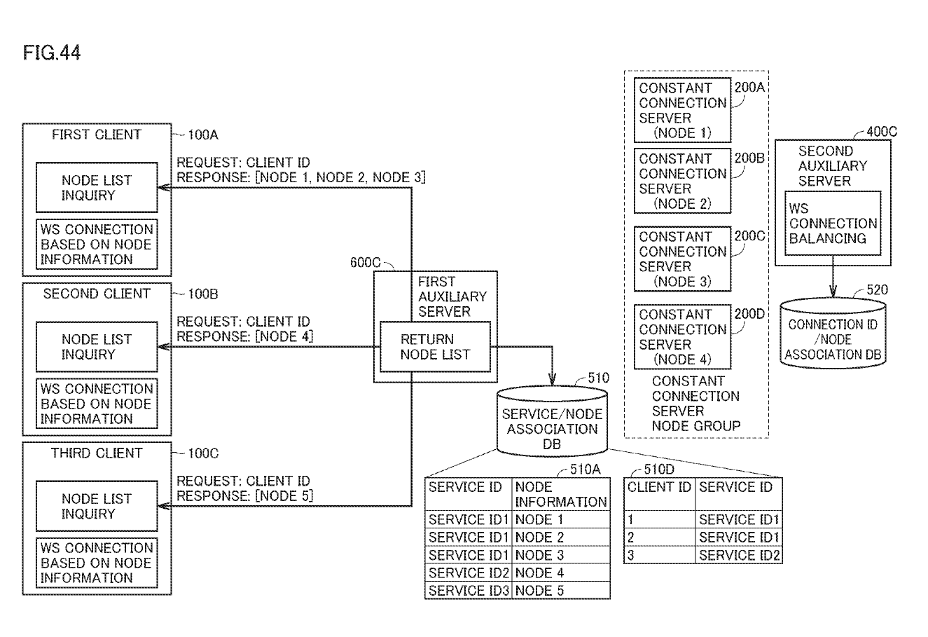

The following describes the service/node association DB 510 used in the network system 1 according to the present embodiment. FIG. 44 is a block diagram representing the overall functional configuration of the network system 1 according to Twentieth Embodiment.

Referring to FIG. 44, the service/node association DB 510 contains the association 510A between the services provided by the application servers 300, and information concerning the nodes realized by the constant connection servers 200. The service/node association DB 510 also contains information for specifying clients, specifically the association 510D between client IDs and the services provided by the application servers 300.

The information concerning nodes may be the addresses of the constant connection servers 200, or IDs specifying the constant connection servers 200. When the information concerning nodes is IDs specifying the constant connection servers 200, the service/node association DB 510 stores the association between the IDs specifying the constant connection servers 200, and the addresses of the constant connection servers 200.

In this way, the first auxiliary server 600C, in response to a request from the client 100, can create a list of nodes associated with the service to be used by the client 100. In the present embodiment, the first auxiliary server 600C extracts from the service/node association DB 510 a list of the addresses of the constant connection servers 200 associated with the service designated by the client 100.

### <Functional Configuration of Network System 1 Concerning Opening of Constant Connection>

The following describes the overall functional configuration of the network system 1 concerning opening of a constant connection according to the present embodiment.

Referring to FIG. 44, the clients 100A to 100C each request the first auxiliary server 600C for a node list over the HTTP protocol. Specifically, the client 100A wishing to use a first service sends the client ID specifying the client to the first auxiliary server 600C.

The first auxiliary server 600C refers to the association 510D in the service/node association DB 510, and specifies the service ID associated with the client ID. The first auxiliary server 600C refers to the association 510A in the service/node association DB 510, and creates a node list associated with the service ID. The first auxiliary server 600C sends the node list to the client 100A. For example, the first auxiliary server 600C sends the following data to the client 100A as the node list.

″handshakeUr1″: [″ws: / /example01.com: 18080/cpush-server/echo″,
″ws: / /example02.com: 18080/cpush-server/echo″,
″ws: / /example03.com: 18080/cpush-server/echo″]

The client 100A refers to the node list, and attempts to connect to the constant connection server 200A associated with the first service. The process of opening a constant connection is as described in Eighteenth Embodiment, and will not be described.

In the same fashion, the client 100B wishing to use a second service sends the client ID to the first auxiliary server 600C. The first auxiliary server 600C refers to the association 510D in the service/node association DB 510, and specifies the service ID associated with the client ID. The first auxiliary server 600C refers to the association 510A in the service/node association DB 510, and creates a node list associated with the service ID. The first auxiliary server 600C sends the node list to the client 100B. For example, the first auxiliary server 600C sends the following data to the client 100B as the node list.

″handshakeUr1″: [″ws:/ /example04.com: 18080/cpush-server/echo″]

The client 100B refers to the node list, and attempts to connect to the constant connection server 200D associated with the second service. The process of opening a constant connection is as described in Eighteenth Embodiment, and will not be described.

In the same fashion, the client 100C wishing to use a third service sends the client ID to the first auxiliary server 600C. The first auxiliary server 600C refers to the association 510D in the service/node association DB 510, and specifies the service ID associated with the client ID. The first auxiliary server 600C refers to the association 510A in the service/node association DB 510, and creates a node list associated with the service ID. The node list contains the address of the fifth constant connection server (not shown) associated with the third service. The first auxiliary server 600C sends the node list to the client 100C. For example, the first auxiliary server 600C sends the following data to the client 100C as the node list.

″handshakeUr1″: [″ws:/ /example05.com: 18080/cpush-server/echo″]

The client 100C refers to the node list, and attempts to connect to the fifth constant connection server associated with the third service. The process of opening a constant connection is as described in Eighteenth Embodiment, and will not be described.

In this manner, the clients 100 each establish a constant connection with the constant connection server 200 associated with the service it wishes to use. The functions and the processes after the opening of the constant connection are as described in Eighteenth Embodiment, and will not be described.

### Twenty-First Embodiment

The following describes Twenty-First Embodiment. In the network system 1 according to Nineteenth Embodiment, the client 100 sends the service ID and the client ID to the first auxiliary server 600C, and the first auxiliary server 600C creates a node list associated with the service ID and the client ID. In the present embodiment, however, the client 100 sends the client ID without sending the service ID. Specifically, the first auxiliary server 600C specifies the service associated with the client ID, and creates a node list associated with the service.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the hardware configuration of the second auxiliary server 400C, the connection ID/node association DB 520, the hardware configuration of the monitoring server 800, and the data exchange between devices concerning a constant connection. Accordingly, these will not be described in the present embodiment.

### <Service/Node Association DB>

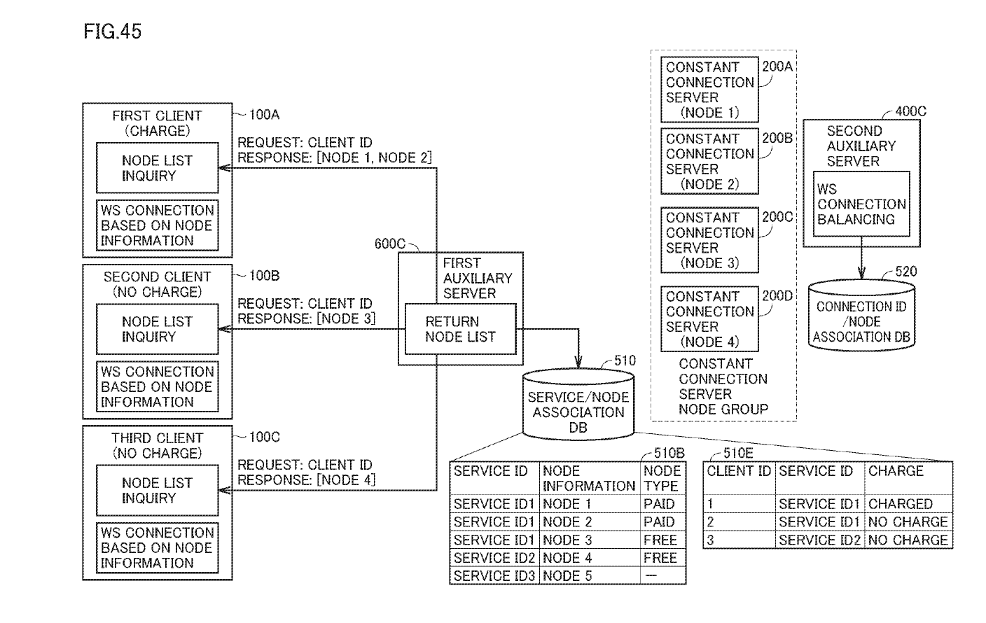

The following describes the service/node association DB 510 used in the network system 1 according to the present embodiment. FIG. 45 is a block diagram representing the overall functional configuration of the network system 1 according to Twenty-First Embodiment.

Referring to FIG. 45, the service/node association DB 510 contains the association 510B between the services provided by the application servers 300, information concerning and the nodes realized by the constant connection servers 200, and information indicative of whether the service is a paid service. The service/node association DB 510 also contains information for specifying clients, specifically the association 510E between client IDs, the services provided by the application server 300, and information indicative of the presence or absence of charging.

The information concerning nodes may be the addresses of the constant connection servers 200, or IDs specifying the constant connection servers 200. When the information concerning nodes is IDs specifying the constant connection servers 200, the service/node association DB 510 stores the association between the IDs specifying the constant connection servers 200, and the addresses of the constant connection servers 200.

In this way, the first auxiliary server 600C, in response to a request from the client 100, can create a list of nodes associated with the service to be used by the client 100. In the present embodiment, the first auxiliary server 600C extracts from the service/node association DB 510 a list of the addresses of the constant connection servers 200 associated with the service to be used by the client 100.

### <Functional Configuration of Network System 1 Concerning Opening of Constant Connection>

The following describes the overall functional configuration of the network system 1 concerning opening of a constant connection according to the present embodiment.

Referring to FIG. 45, the clients 100A to 100C each request the first auxiliary server 600C for a node list over the HTTP protocol. Specifically, the client 100A wishing to use a paid first service sends the client ID specifying the client to the first auxiliary server 600C.

The first auxiliary server 600C refers to the association 510E in the service/node association DB 510, and specifies the service ID associated with the client ID, and the presence or absence of charging. The first auxiliary server 600C refers to the association 510B in the service/node association DB 510, and creates a node list associated with the service ID and the presence or absence of charging. The node list contains the addresses of the first constant connection server 200A and the second constant connection server 200B associated with the paid first service. The first auxiliary server 600C sends the node list to the client 100A. For example, the first auxiliary server 600C sends the following data to the client 100A as the node list.

″handshakeUr1″: [″ws: / /example01.com: 18080/cpush-server/echo″,
″ws: / /example02.com: 18080/cpush-server/echo″]

The client 100A refers to the node list, and attempts to connect to the constant connection server 200A associated with the paid first service. The process of opening a constant connection is as described in Eighteenth Embodiment, and will not be described.

In the same fashion, the client 100B wishing to use a free first service sends the client ID to the first auxiliary server 600C. The first auxiliary server 600C refers to the association 510E in the service/node association DB 510, and specifies the service ID associated with the client ID, and the presence or absence of charging. The first auxiliary server 600C refers to the association 510B in the service/node association DB 510, and creates a node list associated with the service ID and the presence or absence of charging. The node list contains the address of the third constant connection server 200C associated with the free first service. The first auxiliary server 600C sends the node list to the client 100B. For example, the first auxiliary server 600C sends the following data to the client 100B as the node list.

″handshakeUr1″: [″ws:/ /example03.com: 18080/cpush-server/echo″]

The client 100B refers to the node list, and attempts to connect to the constant connection server 200C associated with the free first service. The process of opening a constant connection is as described in Eighteenth Embodiment, and will not be described.

In the same fashion, the client 100C wishing to use a free second service sends the client ID to the first auxiliary server 600C. The first auxiliary server 600C refers to the association 510E in the service/node association DB 510, and specifies the service ID associated with the client ID, and the presence or absence of charging. The first auxiliary server 600C refers to the association 510B in the service/node association DB 510, and creates a node list associated with the service ID and the presence or absence of charging. The node list contains the address of the fourth constant connection server 200 associated with the free second service. The first auxiliary server 600C sends the node list to the client 100C. For example, the first auxiliary server 600C sends the following data to the client 100C as the node list.

″handshakeUr1″: [″ws:/ /example04.com: 18080/cpush-server/echo″]

The client 100C refers to the node list, and attempts to connect to the constant connection server 200D associated with the free second service. The process of opening a constant connection is as described in Eighteenth Embodiment, and will not be described.

In this manner, the clients 100 each establish a constant connection with the constant connection server 200. The functions and the processes after the opening of the constant connection are as described in Eighteenth Embodiment, and will not be described.

In other words, the first service, the second service, and the third service of Twentieth Embodiment correspond to the paid first service, the free first service, and the free second service, respectively, of the present embodiment.

### Twenty-Second Embodiment

The following describes Twenty-Second Embodiment. In Eighteenth Embodiment, the association between service and node is changed according to the number of clients 100 that are in constant connections with the constant connection server 200. In the network system 1 according to the present embodiment, however, the association between service and node is changed according to the PUSH frequency of the constant connection server 200, as briefly mentioned in Eighteenth Embodiment.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the service/node association DB 510, the hardware configuration of the second auxiliary server 400C, the connection ID/node association DB 520, the hardware configuration of the monitoring server 800, the functional configuration of the network system 1 concerning a constant connection, the data exchange between devices concerning a constant connection, the node selection process by the client, the node list providing process by the first auxiliary server 600C, and the association changing process by the monitoring server 800. Accordingly, these will not be described in the present embodiment.

### <Functional Configuration of Network System 1 Concerning Service/Node Association Changes>

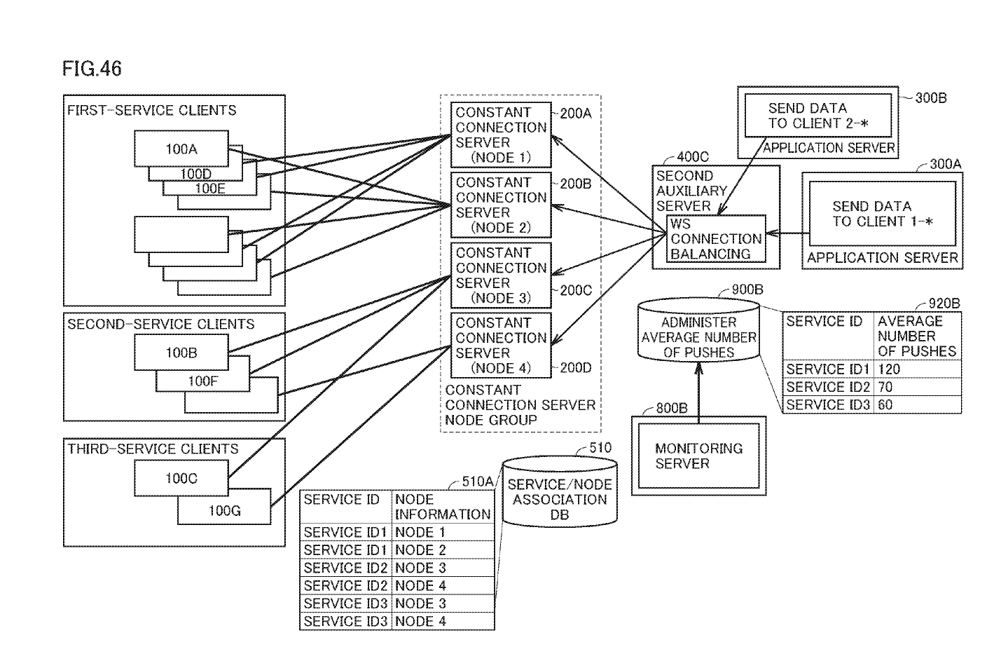

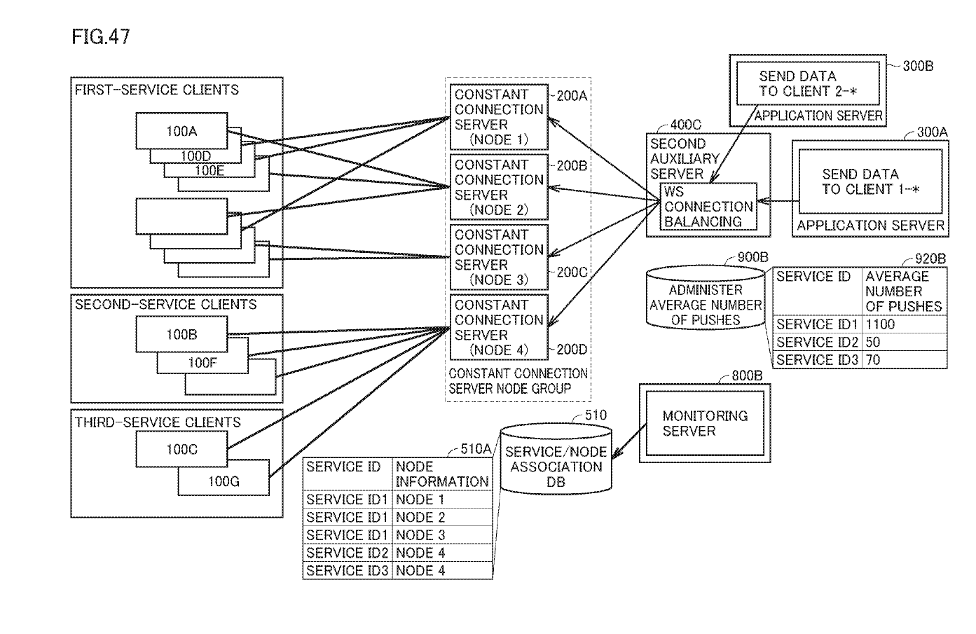

The following mainly describes the functional configuration of the network system 1 concerning service/node association changes according to the present embodiment. FIG. 46 is a first block diagram representing the overall functional configuration of the network system 1 according to Twenty-Second Embodiment. FIG. 47 is a second block diagram representing the overall functional configuration of the network system 1 according to Twenty-Second Embodiment.

Referring to FIG. 46, there are cases where the data PUSH frequency is high for the first constant connection server 200A and the second constant connection server 200B associated with a first service, and is low for the third constant connection server 200C and the fourth constant connection server 200D associated with a second service. This may be due to large numbers of clients 100 being in constant connections per constant connection server 200 associated with the first service, and fewer clients 100 being in constant connections per constant connection server 200 associated with the second service. Another possibility is that the first service may require a more frequent data PUSH, whereas the second service only occasionally requires it.

In the present embodiment, the network system 1 includes a monitoring DB 900B that stores the number of pushes per service ID per unit time. The monitoring server 800B according to the present embodiment refers to the number of pushes per service, and determines whether changes are required in the service/node association.

For example, the monitoring server 800B divides the number of pushes per service ID per unit time by the number of constant connection servers 200 associated with the service. The monitoring server 800B then updates the service/node association DB 510 so that more constant connection servers 200 become associated with the service that is more frequently pushed to a single constant connection server 200 per unit time, and fewer constant connection servers 200 become associated with the service that is less frequently pushed to a single constant connection server 200 per unit time. Specifically, as shown in FIG. 47, the monitoring server 800B increases the number of constant connection servers 200 associated with the first service for which the PUSH frequency is high, and decreases the number of constant connection servers 200 associated with the second service for which the PUSH frequency is low.

The monitoring server 800B may put into sleep or turn off any of the constant connection servers 200 associated with the service that is less frequently pushed to a single constant connection server 200 per unit time, as will be described later. In this way, the running cost of the network system 1 can be reduced.

### Twenty-Third Embodiment

In the foregoing Twenty-Second Embodiment, the association between service and node is changed according to the PUSH frequency of each constant connection server 200. However, in the present embodiment, the association between service and node may be changed according to the transmitted data volume from each constant connection server 200 over the WebSocket protocol, instead of the PUSH frequency, as briefly mentioned in Eighteenth Embodiment.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the service/node association DB 510, the hardware configuration of the second auxiliary server 400C, the connection ID/node association DB 520, the hardware configuration of the monitoring server 800, the functional configuration of the network system 1 concerning a constant connection, the data exchange between devices concerning a constant connection, the node selection process by the client, the node list providing process by the first auxiliary server 600C, and the association changing process by the monitoring server 800. Accordingly, these will not be described in the present embodiment.

### <Functional Configuration of Network System 1 Concerning Service/Node Association Changes>

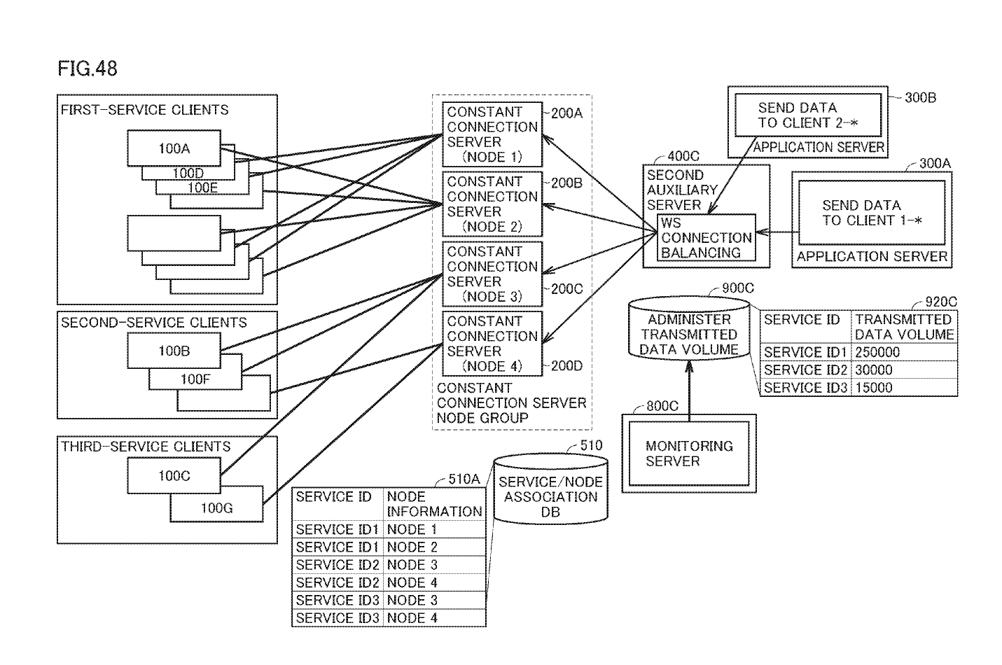

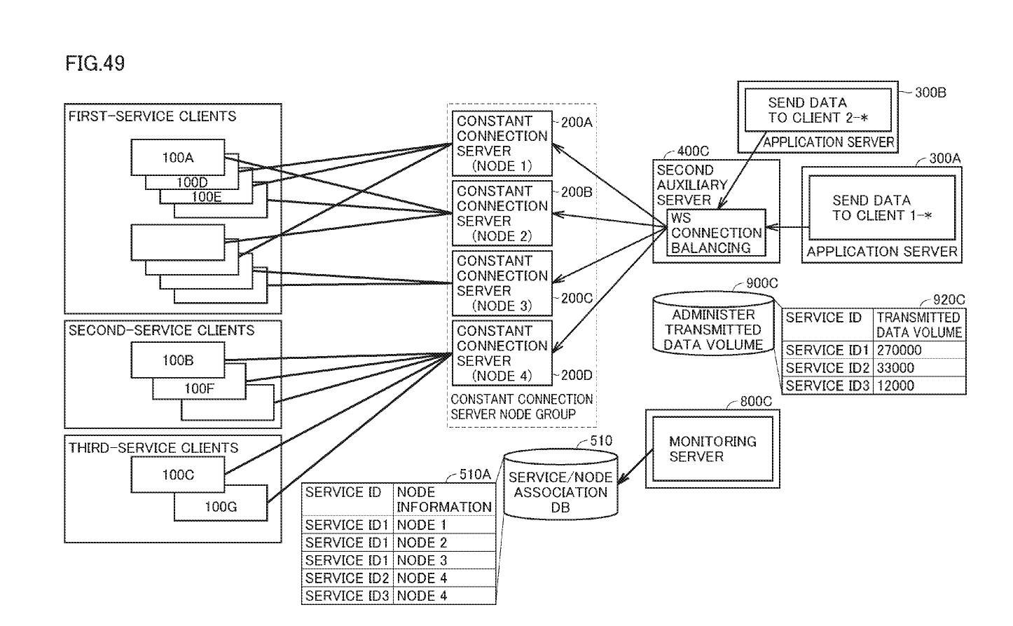

The following mainly describes the functional configuration of the network system 1 concerning service/node association changes according to the present embodiment. FIG. 48 is a first block diagram representing the overall functional configuration of the network system 1 according to Twenty-Third Embodiment. FIG. 49 is a second block diagram representing the overall functional configuration of the network system 1 according to Twenty-Third Embodiment.

Referring to FIG. 48, there are cases where the transmitted data volume is larger for the data from the first constant connection server 200A and the second constant connection server 200B associated with the first service, and is smaller for the data from the third constant connection server 200C and the fourth constant connection server 200D associated with the second service. This may be due to large numbers of clients 100 being in constant connections per constant connection server 200 associated with the first service, and fewer clients 100 being in constant connections per constant connection server 200 associated with the second service. Another possibility is that the first service may require a more frequent data PUSH, whereas the second service only occasionally requires it. It may also be that the first service requires pushing large data, whereas the second service requires pushing only small data.

In the present embodiment, the network system 1 includes a monitoring DB 900C that stores the transmitted data volume per service ID per unit time. The monitoring server 800C according to the present embodiment refers to the transmitted data volume per service, and determines whether changes are needed in the service/node association.

For example, the monitoring server 800C divides the transmitted data volume per service ID per unit time by the number of constant connection servers 200 associated with the service. The monitoring server 800C then updates the service/node association DB 510 so that more constant connection servers 200 become associated with the service that involves a large transmitted data volume from a single constant connection server 200 per unit time, and fewer constant connection servers 200 become associated with the service that involves a small transmitted data volume from a single constant connection server 200 per unit time. Specifically, as shown in FIG. 49, the monitoring server 800C increases the number of constant connection servers 200 associated with the first service involving a large transmitted data volume, and decreases the number of constant connection servers 200 associated with the second service involving a small transmitted data volume.

The monitoring server 800C may put into sleep or turn off any of the constant connection servers 200 associated with the service that involves a less transmitted data volume from a single constant connection server 200 per unit time, as will be described later. In this way, the running cost of the network system 1 can be reduced.

### Twenty-Fourth Embodiment

In the foregoing Twenty-Third Embodiment, the association between service and node is changed according to the transmitted data volume of each constant connection server 200. However, in the present embodiment, the association between service and node may be changed according to the load on each constant connection server 200, instead of the PUSH frequency, as briefly mentioned in Eighteenth Embodiment.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the service/node association DB 510, the hardware configuration of the second auxiliary server 400C, the connection ID/node association DB 520, the hardware configuration of the monitoring server 800, the functional configuration of the network system 1 concerning a constant connection, the data exchange between devices concerning a constant connection, the node selection process by the client, the node list providing process by the first auxiliary server 600C, and the association changing process by the monitoring server 800. Accordingly, these will not be described in the present embodiment.

### <Functional Configuration of Network System 1 Concerning Service/Node Association Changes>

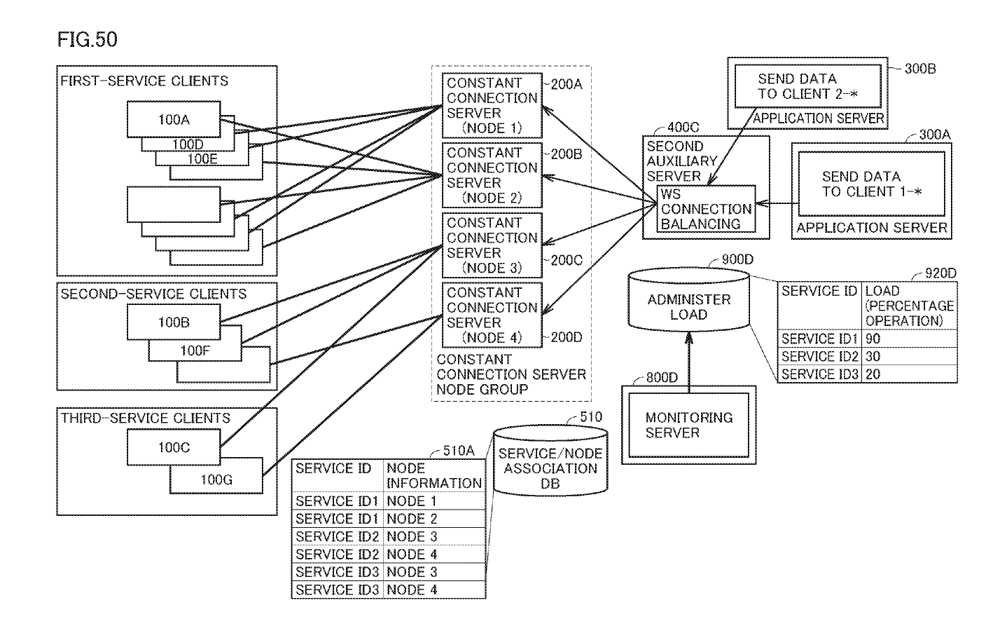

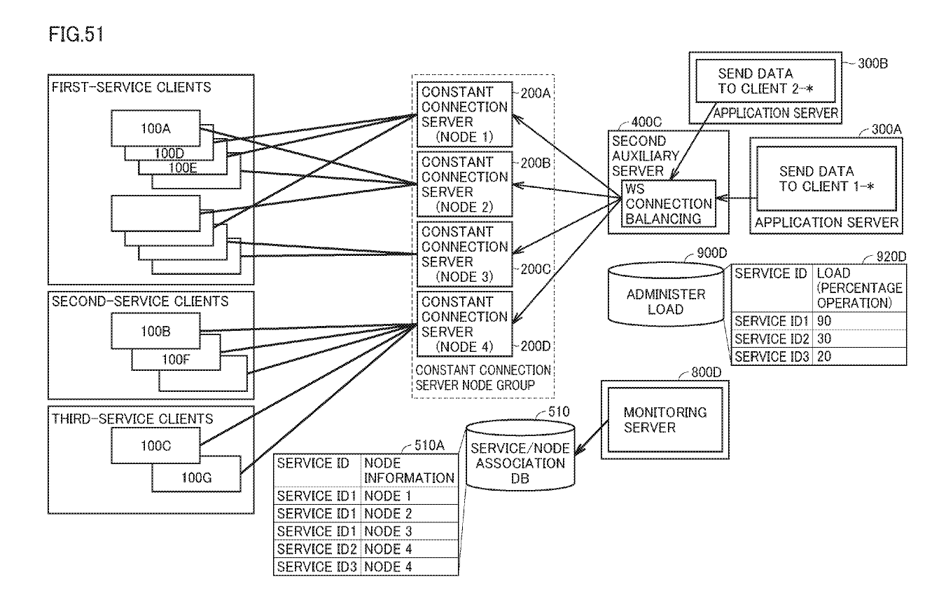

The following mainly describes the functional configuration of the network system 1 concerning service/node association changes according to the present embodiment. FIG. 50 is a first block diagram representing the overall functional configuration of the network system 1 according to Twenty-Fourth Embodiment. FIG. 51 is a second block diagram representing the overall functional configuration of the network system 1 according to Twenty-Fourth Embodiment.

Referring to FIG. 50, there are cases where larger loads are placed on the first constant connection server 200A and the second constant connection server 200B associated with the first service, and smaller loads are placed on the third constant connection server 200C and the fourth constant connection server 200D associated with the second service. This may be due to large numbers of clients 100 being in constant connections per constant connection server 200 associated with the first service, and fewer clients 100 being in constant connections per constant connection server 200 associated with the second service. Another possibility is that the first service may require a more frequent data PUSH, whereas the second service only occasionally requires it. It may also be that the first service requires pushing large data, whereas the second service requires pushing only small data.

In the present embodiment, the network system 1 includes a monitoring DB 900D that stores the load per service ID. The monitoring server 800D according to the present embodiment refers to the load per service, and determines whether changes are needed in the service/node association.

For example, the monitoring server 800D divides the load per service ID by the number of constant connection servers 200 associated with the service. The monitoring server 800D then updates the service/node association DB 510 so that more constant connection servers 200 become associated with the service that puts a large load on a single constant connection server 200, and fewer constant connection servers 200 become associated with the service that puts a small load on a single constant connection server 200. Specifically, as shown in FIG. 51, the monitoring server 800D increases the number of constant connection servers 200 associated with the first service involving a large load, and decreases the number of constant connection servers 200 associated with the second service involving a small load.

The monitoring server 800D may put into sleep or turn off any of the constant connection servers 200 associated with the service that involves a small load, as will be described later. In this way, the running cost of the network system 1 can be reduced.

### Twenty-Fifth Embodiment

In the foregoing Eighteenth to Twenty-Fourth Embodiments, the combinations of services and constant connection servers are changed. However, in the present embodiment, the total number of operating constant connection servers 200 may be changed according to the situation, as briefly mentioned in Eighteenth Embodiment. Specifically, some of the constant connection servers 200 may be put to sleep or turned off when there is only small data traffic over a constant connection.

The present embodiment does not differ from Eighteenth Embodiment with regard to the overall configuration of the network system, the hardware configuration of the client 100, the hardware configuration of the constant connection server 200, the hardware configuration of the application server 300, the hardware configuration of the first auxiliary server 600C, the service/node association DB 510, the hardware configuration of the second auxiliary server 400C, the connection ID/node association DB 520, the hardware configuration of the monitoring server 800, the functional configuration of the network system 1 concerning a constant connection, the data exchange between devices concerning a constant connection, the node selection process by the client, the node list providing process by the first auxiliary server 600C, and the association changing process by the monitoring server 800. Accordingly, these will not be described in the present embodiment.

### <Functional Configuration of Network System 1 Concerning Service/Node Association Changes>

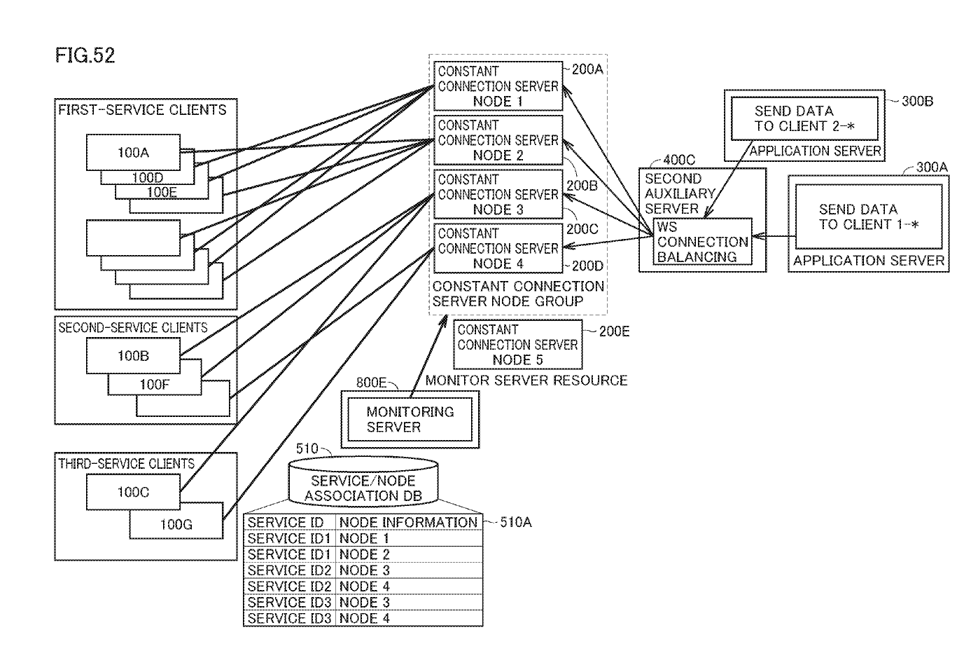

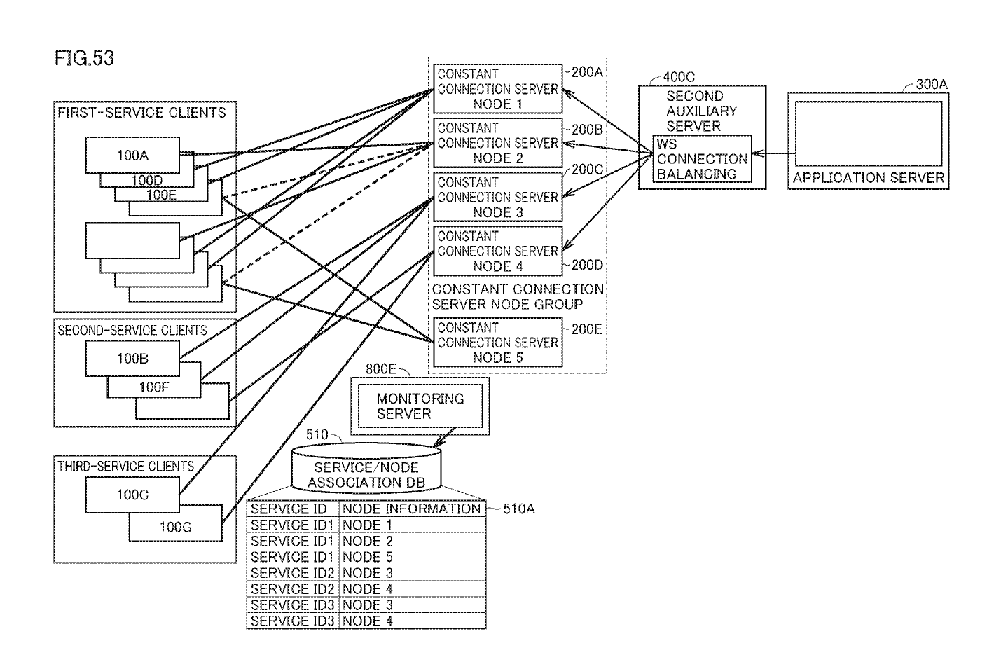

The following mainly describes the functional configuration of the network system 1 concerning service/node association changes according to the present embodiment. FIG. 52 is a first block diagram representing the overall functional configuration of the network system 1 according to Twenty-Fifth Embodiment. FIG. 53 is a second block diagram representing the overall functional configuration of the network system 1 according to Twenty-Fifth Embodiment.

Referring to FIG. 52, the constant connection server 200E, one of the five constant connection servers 200A, 200B, 200C, 200D, and 200E, is sleeping. Specifically, the remaining constant connection servers 200A, 200B, 200C, and 200D can sufficiently serve the constant connection process for the three services. For example, the number of clients 100 connected to each of the constant connection servers 200A, 200B, 200C, and 200D does not exceed 1,000.

The monitoring server 800D monitors the number of clients 100 that are in constant connections per constant connection server 200, the PUSH frequency per constant connection server 200, the transmitted data volume per constant connection server 200, or the load per constant connection server 200. The monitoring server 800D activates the fifth constant connection server 200E from the standby mode when the number of clients 100 that are in constant connections per constant connection server 200, the PUSH frequency per constant connection server 200, the transmitted data volume per constant connection server 200, or the load per constant connection server 200 exceeds the predetermined value.

At the same time, as shown in FIG. 53, the monitoring server 800D associates the node of the activated fifth constant connection server 200E with the service associated with the constant connection server 200 for which the number of clients 100 in constant connections has exceeded the predetermined value in the service/node association DB 510. Alternatively, the monitoring server 800D associates the node of the activated fifth constant connection server 200E with the service associated with the constant connection server 200 for which the PUSH frequency has exceeded the predetermined value in the service/node association DB 510. Alternatively, the monitoring server 800D associates the node of the activated fifth constant connection server 200E with the service associated with the constant connection server 200 for which the transmitted data volume has exceeded the predetermined value in the service/node association DB 510. Alternatively, the monitoring server 800D associates the node of the activated fifth constant connection server 200E with the service associated with the constant connection server 200 for which the load has exceeded the predetermined value in the service/node association DB 510. In this way, any client 100 subsequently attempting to use the service makes a constant connection with the fifth constant connection server 200E.

The fifth constant connection server 200 may be on hot standby or cold standby. In the present embodiment, the monitoring server 800D simply updates the service/node association when adding the fifth constant connection server 200 to the constant connection server node group. However, the monitoring server 800D may change the address of the constant connection server 200 in the DNS (Domain Name System) server while updating the service/node association when adding the fifth constant connection server 200 to the constant connection server node group.

On the other hand, the monitoring server 800E puts into sleep or turns off the constant connection server 200 (for example, the fifth constant connection server 200E) associated with an unpopular service when the number of clients 100 that are in constant connections per constant connection server 200, the PUSH frequency per constant connection server 200, the transmitted data volume per constant connection server 200, or the load per constant connection server 200 falls below the predetermined value.

As shown in FIG. 52, the monitoring server 800E deletes from the service/node association DB 510 the node/service record of the fifth constant connection server 200E that was put into sleep mode or turned off.

### Twenty-Sixth Embodiment

In the foregoing Nineteenth and Twenty-First Embodiments, the constant connection servers 200 are sorted according to the presence or absence of charging.

In the present embodiment, the constant connection servers 200 may be sorted so that high-spec constant connection servers 200 are associated with paid services, and normal constant connection servers 200 are associated with free services, in addition to be sorted on the basis of the presence or absence of charging. In this way, clients 100 using paid services can more smoothly send and receive data over constant connections.

### Twenty-Seventh Embodiment

In the foregoing Nineteenth and Twenty-First Embodiments, the constant connection servers 200 are sorted according to the presence or absence of charging.

In the present embodiment, the constant connection servers 200 may be sorted so that the upper limit of connectable clients per constant connection server 200 is low for paid services, and is high for free services, in addition to be sorted on the basis of the presence or absence or charging. Specifically, the monitoring server 800 increases the number of associated constant connection servers 200 well in advance as the number of connected clients per constant connection server 200 increases for paid services. For free services, on the other hand, the monitoring server 800 does not immediately increase the number of associated constant connection servers 200 even when the number of connected clients per constant connection server 200 increases.

Alternatively, the upper limit of connectable clients per constant connection server 200 may be set only for paid services, and not for free services.

### Twenty-Eighth Embodiment

In the foregoing Eighteenth to Twenty-Seventh Embodiments, the second auxiliary server 400C allocates data from the application server 300 to constant connection servers 200 by referring to the connection ID/node association DB 520 so that the data is allocated to constant connection servers 200 that are in constant connections with the client 100 requiring pushing of the data.

However, in the present embodiment, the second auxiliary server 400C allocates data from the application server 300 to constant connection servers 200 by referring to the service/node association DB 510 so that the data is allocated to any of the constant connection servers 200 associated with the application server 300. For example, the second auxiliary server 400C allocates data to a less loaded constant connection server 200 from among the constant connection servers 200 associated with the application server 300.

The CPU 210 of the constant connection server 200 then refers to the connection ID/node association DB 520, and forwards the data to a constant connection server 200 that is in a constant connection with the client 100 requiring pushing of the data, using the communication interface 260. Evidently, the CPU 210 of the constant connection server 200 directly pushes data to the client 100 it connects to over a constant connection, by using the communication interface 260 over the WebSocket protocol.

### Twenty-Ninth Embodiment

In the foregoing Eighteenth to Twenty-Eighth Embodiments, the first auxiliary server 600C, by using data from the client 100, creates a list of constant connection servers 200 associated with the service the client 100 wishes to use.

However, the first auxiliary server 600C may provide the client 100 with a list of the addresses of all the constant connection servers 200. For example, the first auxiliary server 600C sends association 510A (620B, 620C, 620D, 620E) to the client 100. The CPU 110 of the client 100 refers to the association 510A, and selects a constant connection server 200 associated with the service it wishes to use. Here, the CPU 110 may or may not create a node list. The CPU 110 makes a constant connection with the selected constant connection server 200 via the communication interface 160 over the WebSocket protocol.

### Thirtieth Embodiment

In the foregoing Eighteenth to Twenty-Ninth Embodiments, the first auxiliary server 600C represents a device separately provided from the constant connection servers 200 and the application servers 300.

However, the first auxiliary server 600C may be provided as the same device as any of the constant connection servers 200 or any of the application servers 300. Specifically, any of the constant connection servers 200, or any of the application servers 300 may also serve as the first auxiliary server 600C.

### Thirty-First Embodiment

In the foregoing Eighteenth to Thirtieth Embodiments, the monitoring server 800 represents a device separately provided from the constant connection servers 200, the application servers 300, and the first auxiliary server 600C.

However, the monitoring server 800 may be provided as the same device as any of the constant connection servers 200, any of the application servers 300, or the first auxiliary server 600C. Specifically, any of the constant connection servers 200, any of the application servers 300, or the first auxiliary server 600C may also serve as the monitoring server 800.

### Thirty-Second Embodiment

In the foregoing Eighteenth to Thirty-First Embodiments, the application server 300 provides a single service, and a single service is provided by a single application server 300.

However, a single service may be provided by more than one application server 300. In this case, the constant connection server 200 may be associated with the application server 300 or with the service, as in Eighteenth to Thirty-First Embodiments.

Conversely, the application server 300 may be associated with more than one service. In this case, the constant connection server 200 may be associated with the application server 300 or with the service, as in Eighteenth to Thirty-First Embodiments.

### Thirty-Third Embodiment

In the foregoing Eighteenth to Thirty-Second Embodiment, the client 100 opening a constant connection with the constant connection server 200 obtains a node list associated with the service from the first auxiliary server 600C, separately from the authentication information, as in step S009 of FIG. 34.

However, the client 100 opening a constant connection with the constant connection server 200 may obtain a node list associated with the service from the constant connection server 200 or the application server 300, separately from the authentication information (step S009 of FIG. 34). Specifically, the constant connection server 200 or the application server 300 may also serve as a part of the first auxiliary server 600C.

More specifically, the constant connection server 200 or the application server 300 upon receiving a node list request from the client 100 may serve to create a node list associated with the service, and to provide the node list to the client 100. Alternatively, in response to a node list request from the client 100, the first auxiliary server 600C may create a node list, and the constant connection server 200 or the application server 300 may obtain the node list from the first auxiliary server 600C, and provide the node list to the client 100.

### Thirty-Fourth Embodiment

In the foregoing Eighteenth to Thirty-Second Embodiments, the client 100 opening a constant connection with the constant connection server 200 obtains a node list associated with the service from the first auxiliary server 600C, separately from the authentication information, as in step S009 of FIG. 34.

However, when the client 100 opens a constant connection with the constant connection server 200, the application server 300 may send the client 100 a node list associated with the service, together with the authentication information (step S004 of FIG. 34). In this case, step S009 of FIG. 34 is not required.

More specifically, the application server 300 upon receiving an authentication information request from the client 100 may serve to create a node list associated with the service, and provide the node list to the client 100. Alternatively, in response to an authentication information request from the client 100, the first auxiliary server 600C may create a node list, and the constant connection server 200 or the application server 300 may serve to obtain the node list from the first auxiliary server 600C, and provide the node list to the client 100.

### Examples of Other Applications

As is evident, the present invention also can be achieved by supplying a program to a system or a device. The advantages of the present invention also can be obtained with a computer (or a CPU or an MPU) in a system or a device upon the computer reading and executing the program code stored in the supplied storage medium (or memory) storing software programs intended to realize the present invention.

In this case, the program code itself read from the storage medium realizes the functions of the embodiments above, and the storage medium storing the program code constitutes the present invention.

Evidently, the functions of the embodiments above can be realized not only by a computer reading and executing such program code, but by some or all of the actual processes performed by the OS (operating system) or the like running on a computer under the instructions of the program code.

The functions of the embodiments above also can be realized by some or all of the actual processes performed by the CPU or the like of an expansion board or expansion unit under the instructions of the program code read from a storage medium and written into other storage medium provided in the expansion board inserted into a computer or the expansion unit connected to a computer.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the scope of the claims set forth below.

What is claimed is:

1. A network system comprising:
a plurality of constant connection servers; and
an electronic device capable of making a constant connection with at least one of the plurality of constant connection servers,
wherein the electronic device obtains from any of the plurality of constant connection servers information concerning at least one of the plurality of constant connection servers, and opens a constant connection with any of the plurality of constant connection servers on the basis of the information.

2. The network system according to claim 1, wherein any one of the plurality of constant connection servers obtains a list of the plurality of constant connection servers.

3. The network system according to claim 2,
wherein said any one of the plurality of constant connection servers sends the list as the information, and
wherein the electronic device selects one of the plurality of constant connection servers on the basis of the list.

4. The network system according to claim 2,
wherein said any one of the plurality of constant connection servers selects one of the plurality of constant connection servers on the basis of the list, and sends information specifying said one of the plurality of constant connection servers to the electronic device as the information.

5. The network system according to claim 2,
wherein said any one of the plurality of constant connection servers obtains the list in response to a request from the electronic device.

6. The network system according to claim 2,
wherein said any one of the plurality of constant connection servers obtains the list on a regular basis.

7. The network system according to claim 2,
wherein the list obtained by said any one of the plurality of constant connection servers is a list of operating constant connection servers.

8. The network system according to claim 2,
wherein said any one of the plurality of constant connection servers obtains the list by creating a list in which the plurality of constant connection servers is sorted on the basis of the number of connected electronic devices.

9. The network system according to claim 2,
wherein said any one of the plurality of constant connection servers obtains the list by creating a list in which the plurality of constant connection servers is sorted on the basis of loads.

10. A constant connection method comprising:
sending, by any of a plurality of constant connection servers, information concerning the plurality of constant connection servers to an electronic device; and
opening, by the electronic device, a constant connection with any of the plurality of constant connection servers on the basis of the information.

11. An electronic device comprising:
a communication interface provided to constantly connect to any of a plurality of constant connection servers; and
a processor that, by using the communication interface, obtains information concerning the plurality of constant connection servers from any of the plurality of constant connection servers, and opens a constant connection with any of the plurality of constant connection servers on the basis of the information.

12. A server comprising:
a communication interface provided to communicate with an electronic device;
a memory that stores information concerning a plurality of constant connection servers; and
a processor that, by using the communication interface, pushes the information concerning the plurality of constant connection servers to the electronic device in response to a request from the electronic device.

13. A network system comprising:
an electronic device;
a plurality of constant connection servers capable of making a constant connection with the electronic device;
an application server that sends and receives information to and from the electronic device via any of the plurality of constant connection servers; and
a load balancing server that allocates data from the application server to the plurality of constant connection servers,
wherein the plurality of constant connection servers each forward the data to a different one of the plurality of constant connection servers that is in a constant connection with the electronic device designated as a recipient of the data.

14. The network system according to claim 13, further comprising:
a database that stores associations of constant connections between the plurality of constant connection servers and a plurality of electronic devices,
wherein the plurality of constant connection servers with the allocated data each refer to the database, and specifies a different one of the plurality of constant connection servers that is in a constant connection with the electronic device designated as a recipient of the data.

15. The network system according to claim 13,
wherein the plurality of constant connection servers each store associations of constant connections between the plurality of constant connection servers and a plurality of electronic devices, and
wherein the plurality of constant connection servers with the allocated data each refer to the associations of constant connections, and specifies a different one of the plurality of constant connection servers that is in a constant connection with the electronic device designated as a recipient of the data.

16. A constant connection method comprising:
sending data, by an application server, to a load balancing server;
allocating the data, by the load balancing server, to any of the plurality of constant connection servers; and
forwarding the data, by said any of the plurality of constant connection servers, to a different one of the plurality of constant connection servers that is in a constant connection with an electronic device designated as a recipient of the data.

17. A server comprising:
a communication interface provided to constantly connect to an electronic device; and
a processor that, by using the communication interface, receives load balanced data, and forwards the data to a different one of the plurality of constant connection servers that is in a constant connection with an electronic device designated as a recipient of the data.

18. A network system comprising:
an electronic device; and
a constant connection server capable of making a constant connection with the electronic device,
wherein the constant connection server sends information containing a reconnection interval concerning the constant connection server to the electronic device, and
wherein the electronic device waits for a time period as determined from the reconnection interval, and repeats a process of making a constant connection until a constant connection with the constant connection server succeeds.

19. The network system according to claim 18,
wherein the constant connection server creates awaiting time within the reconnection interval for the electronic device, and sends the waiting time to the electronic device, and
wherein the electronic device performs the process of making a constant connection after the waiting time upon being disconnected from the constant connection with the constant connection server.

20. The network system according to claim 18,
wherein the electronic device creates a waiting time within the reconnection interval, and performs the process of making a constant connection after the waiting time upon being disconnected from the constant connection with the constant connection server.

21. The network system according to claim 19, wherein the waiting time is created on the basis of the frequency of data transmission and reception in the constant connection between the electronic device and the constant connection server.

22. The network system according to claim 18, wherein the constant connection server determines the reconnection interval on the basis of the number of electronic devices that are in constant connections with the constant connection server, and the number of electronic devices that are reconnectable to a single constant connection server per second.

23. The network system according to claim 18,
wherein the constant connection server comprises a plurality of constant connection servers capable of making a constant connection with the electronic device,
wherein at least one of the plurality of constant connection servers sends information concerning the plurality of constant connection servers to the electronic device, and
wherein the electronic device attempts to make a constant connection with the plurality of constant connection servers in turn on the basis of the information until a constant connection with any of the plurality of constant connection servers succeeds.

24. The network system according to claim 23,
wherein said at least one of the plurality of constant connection servers determines the reconnection interval on the basis of the number of electronic devices being connected to the plurality of constant connection servers, the number of electronic devices that are reconnectable to a single constant connection server per second, and the number of operating constant connection servers.

25. The network system according to claim 18, wherein the electronic device repeats the process of making a constant connection at the reconnection interval until a constant connection with the constant connection server succeeds.

26. The network system according to claim 18, wherein the constant connection server sends information containing the reconnection interval to the electronic device via a different server.

27. The network system according to claim 18,
wherein the electronic device immediately starts the process of making a constant connection without waiting upon being determined as being disconnected from the constant connection for reasons related to the electronic device, and
wherein the electronic device starts the process of making a constant connection after waiting for a time period as determined from the reconnection interval upon being determined as being disconnected from the constant connection for reasons unrelated to the electronic device.

28. A constant connection method for a network system that includes an electronic device, and a constant connection server capable of making a constant connection with the electronic device,
the method comprising:
sending, by the constant connection server, information containing a reconnection interval to the electronic device;
terminating a constant connection between the electronic device and the constant connection server; and
repeating, by the electronic device, a process of making a constant connection by using the information, after waiting for a time period as determined from the reconnection interval, until a constant connection with the constant connection server succeeds.

29. An electronic device comprising:
a communication interface capable of making constant connections with constant connection servers; and
a processor that repeats a process of making a constant connection until a constant connection with any of the constant connection servers succeeds, the processor repeating the process by using information concerning the constant connection servers after waiting for a time period as determined from a reconnection interval provided by any of the constant connection servers.

30. The electronic device according to claim 29,
wherein the processor immediately starts the process of making a constant connection without waiting upon being determined as being disconnected from the constant connection for reasons related to the electronic device, and
wherein the processor starts the process of making a constant connection after waiting for a time period as determined from the reconnection interval upon being determined as being disconnected from the constant connection for reasons unrelated to the electronic device.

31. A constant connection server comprising:
a communication interface capable of making a constant connection with an electronic device; and
a processor that sends information containing a reconnection interval concerning the constant connection server to the electronic device via the communication interface.

32. A network system comprising:
a plurality of constant connection servers;
a client that uses a service via any of the plurality of constant connection servers; and
a server capable of communicating with the client,
wherein the server sends a list concerning at least one of the plurality of constant connection servers to the client in response to a request from the client, and
wherein the client on the basis of the list opens a constant connection with any of the plurality of constant connection servers associated with the service.

33. The network system according to claim 32,
wherein the request contains service information for specifying the service, and
wherein the list sent by the server is a list concerning at least one constant connection server associated with the service, the list being created by the server on the basis of the service information.

34. The network system according to claim 32,
wherein the request contains client information for specifying the client, and
wherein the server specifies the service associated with the client information, and creates as the list a list concerning at least one constant connection server associated with the service.

35. The network system according to claim 32, wherein the server or any of the other servers changes the service to be allocated to the plurality of constant connection servers, the service being changed on the basis of the number of clients being in constant connections with each of the plurality of constant connection servers.

36. The network system according to claim 32, wherein the server or any of the other servers changes the service to be allocated to the plurality of constant connection servers, the service being changed on the basis of the frequency of a data push from each of the plurality of constant connection servers.

37. The network system according to claim 32, wherein the server or any of the other servers changes the service to be allocated to the plurality of constant connection servers, the service being changed on the basis of a data volume from each of the plurality of constant connection servers.

38. The network system according to claim 32, wherein the server or any of the other servers changes the service to be allocated to the plurality of constant connection servers, the service being changed on the basis of a load on each of the plurality of constant connection servers.

39. The network system according to claim 32,
wherein the plurality of constant connection servers includes an operating constant connection server and a non-operating constant connection server, and
wherein the server or any of the other servers switches an operating state and a non-operating state of the plurality of constant connection servers on the basis of a predetermined condition.

40. The network system according to claim 32, wherein the server is any of the plurality of constant connection servers.

41. A constant connection method comprising:
sending, by a client, a request for using a service to a server;
sending, by the server, a list concerning at least one of a plurality of constant connection servers to the client in response to the request from the client; and
opening, by the client, a constant connection with any of the plurality of constant connection servers associated with the service on the basis of the list.

42. A server comprising:
a communication interface provided to communicate with a client; and
a processor that via the communication interface receives a request from the client, and sends the client a list concerning at least one constant connection server associated with a service to be used by the client.

43. An electronic device comprising:
a communication interface provided to communicate with a server; and
a processor that via the communication interface receives from the server a list concerning at least one constant connection server, and opens a constant connection with a constant connection server associated with a service, the processor opening the constant connection on the basis of the list.
